(19) United States
(12) Patent Application Publication
(10) Pub. No.: US 2006/0008750 A1
(43) Pub. Date: Jan. 12, 2006

(54) Silver halide color photographic material

(75) Inventor: Toshiya Konda, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/170,592

(22) Filed: Jun. 29, 2005

(30) Foreign Application Priority Data
Jul. 5, 2004 (JP) JP2004-197823

(51) Int. Cl. G03C 1/46

(52) U.S. Cl. 430/502

(57) ABSTRACT

A silver halide color photographic material containing on a support a yellow image forming layer, a magenta image forming layer and a cyan image forming layer, each containing a light-sensitive silver halide, wherein each of the yellow, magenta and cyan image forming layers meets the following requirement: Δ Log E(=Log Ed−Log Ea)≦0.15, the definitions of Δ Log E being defined in the specification, and wherein at least one of the image forming layers contains a first silver halide emulsion having a chloride content of not less than 90 mol %, an iodide content of 0 to 2.0 mol % and a bromide content of 0.1 to 10 mol %, and at least one image forming layer which is different from the layer containing the first silver halide emulsion contains a second silver halide emulsion having a smaller average grain size and a higher bromide content than the first silver halide emulsion.

This application is based on Japanese Patent Application No. 2004-197823 filed on Jul. 5, 2004 in Japanese Patent Office, the entire content of which is hereby incorporated by reference.

### TECHNICAL FIELD

The present invention relates to a novel silver halide color photographic light-sensitive material used for preparation of color prints through exposure based on digital information and development.

### BACKGROUND

In recent years, opportunities of handling images as digital data have rapidly increased, along with enhancement of operation capacity and progress in network technology. Image information obtained by digital cameras or image information which has been digitized from photographic film or prints using a scanner can be readily edited or added with characters or illustrations on a computer. Examples of hard copy material used for preparation of a hard copy based on such digitized image information include a sublimation type thermal print, melt type thermal print, ink-jet print, electrostatic transfer type print, thermo-autochrome print and silver halide color photographic material. Of these, silver halide color photographic material (hereinafter, also referred to as photographic material) has greatly superior characteristics such as high sensitivity, superior tone, superior image lasting quality and lower cost, compared to other print material and therefore, is broadly employed for preparation of high quality hard copy prints.

Digitized image information can be readily edited on a computer, leading to increased opportunities of handling images comprised of a mixture of images based on photography data of people, landscapes, still-life and the like (hereinafter, also denoted as scenic images) and character images (specifically, thin small black text). Accordingly, reproduction of natural scenic images and character reproduction without blurring are simultaneously required in image output based on digital data.

Recent enhancement in resolution of image input devices such as digital still cameras and film scanners is remarkable and studies for enhancing resolution of output devices (digital exposure device) have been made to perform image output making use of high quality image data. Recently, various digital exposure devices are produced and commercially available. Further, a number of new digital image exposure devices have been developed along with the progress in exposure light sources and control devices. Of these digital image exposure devices, devices employing a light source exhibiting a sharp light source wavelength distribution, such as laser or LED are being in the main trend.

Although the spread of various digital image exposure devices has launched a variety of imaging devices on the market, the kind of lasers and LED installed therein has not been unified, so that exposure devices are different in exposure wavelength or exposure time. Accordingly, the digital exposure time, which markedly differs from the analog exposure time in the conventional negative-through system, ranges from 10⁻⁷ sec. to 10⁻² sec, by a factor of 10,000 to 100,000, which requires further enhanced latitude for exposure time. Moreover, digital exposure machines inherently are easily influenced by heat so that further enhanced resistance to temperature and humidity at the time of exposure are desired, as compared to image formation using conventional analog exposure devices. Along with popularization of mini-labs, there are photo-shops providing service in which the time from receiving an order from a customer to finishing prints is 35 min. or less. Therefore, shortening the processing time and providing beautiful digital images in a still shorter time have been desired by the market. Further, techniques for achieving suitability for digital exposure have problems in stability in the process of manufacturing silver halide color photographic materials or problems such that process stability is lowered under rapid processing conditions.

To overcome the foregoing problems, there have been made various proposals controlling constitution or characteristic values of silver halide color photographic material, for example, there was proposed a silver halide color photographic material exhibiting superior suitability for an exposure time or an environment at the time of exposure (as disclosed, for example, in Patent document 1). Accordingly, the method described in Patent document 1, high quality images were always stably obtained with respect to variation in exposure time or variation in environments such as temperature or humidity at the time of exposure. From the subsequent study thereof, however, it was proved that there were problems in stability in process variation and long-term storage stability. Further, when silver halide color photographic material is stored over a long period of time, an increase of fogging and resultant deterioration of the white-background, caused by natural radiation have recently become problems.

To overcome the foregoing problems, there was proposed a silver halide color photographic material in which the use of a high chloride silver halide emulsion, incorporation of an iodide to a blue-sensitive layer and optimization of the grain size difference of the respective image forming layers or the silver coverage improved storage stability, process stability and white-background stability (as disclosed, for example, in Patent document 2). There was also proposed the use of plural high chloride silver halide emulsions in which the sensitivity difference of the respective silver halide emulsions and the content of a metal complex compound were controlled to enhance rapid processability (as disclosed, for example, in Patent document 3). Further, a silver halide color photographic material was proposed, in which the chloride, iodide and bromide content of silver halide emulsions used in the respective image forming layers containing a high chloride silver halide emulsion were specified to improve rapid processability and digital suitability (as disclosed, for example, in Patent document 4). Furthermore, there was proposed a method in which silver halide color photographic material controlling the effective tone range (VE) and using a high chloride silver halide emulsion-achieved improvement of image reproducibility and latent image stability (as disclosed, for example, in Patent document 5).

However, any one of the foregoing methods disclosed does not teach or suggest with respect to improvement of resistance to natural radiation or storage stability. Moreover, further enhancement of process stability in response to the recent trend in rapid processing in a short time.
Patent document 1: JP-A No. 2003-207874
   (hereinafter, the term, JP-A refer to Japanese Patent Application Publication)
Patent document 2: JP-A No. 2004-118097
Patent document 3: JP-A No. 2004-37549
Patent document 4: JP-A No. 2003-295371
Patent document 5: JP-A No. 2003-202647

### SUMMARY

The present invention has come into being in light of the foregoing problems and it is an object to provide a silver halide color photographic material exhibiting digital exposure suitability and analog exposure suitability, and achieving improvements in resistance to natural radiation, storage stability and process stability.

The foregoing object can be achieved by the following constitution.
(1) A silver halide color photographic material comprising on a support at least a yellow image forming layer, at least a magenta image forming layer and at least a cyan image forming layer, each of which contains a light-sensitive silver halide, wherein a difference between a logarithmic exposure amount (Log Ed) giving a maximum point gamma value (γmd) of the respective color images obtained when exposed so that an exposure time is 10⁻⁶ sec per pixel and then processed, and a logarithmic exposure amount (Log Ea) giving a maximum point gamma value (γma) of the respective color images when exposed so that an exposure time is 0.5 sec per pixel and then processed, Δ Log E(Log Ed−Log Ea) is not more than 0.15,
   and wherein at least one of the yellow image forming layer, the magenta image forming layer and the cyan image forming layer contains at least two silver halide emulsions having a chloride content of not less than 90 mol %, an iodide content of 0 to 2.0 mol % and a bromide content of 0.1 to 10 mol % and differing in average grain size, and an iodide content of a silver halide emulsion having a largest average grain size being higher than that of a silver halide emulsion having a smallest average grain size.
(2) A silver halide color photographic material comprising on a support a yellow image forming layer, a magenta image forming layer and a cyan image forming layer, each containing a light-sensitive silver halide,
   wherein each of the yellow, magenta and cyan image forming layers meets the following requirement:
      Δ Log E(=Log Ed−Log Ea)≦0.15
   wherein Δ Log E is a difference between a logarithmic exposure amount (Log Ed) giving a maximum point gamma value (γmd) when exposed so that an exposure time is 10⁻⁶ sec per pixel and then processed and a logarithmic exposure amount (Log Ea) giving a maximum point gamma value (γma) when exposed so that an exposure time is 0.5 sec per pixel and then processed,
   and wherein at least one of the yellow image forming layer, the magenta image forming layer and the cyan image forming layer contains a first silver halide emulsion having a chloride content of not less than 90 mol %, an iodide content of 0 to 2.0 mol % and a bromide content of 0.1 to 10 mol %, and at least one image forming layer which is different from the layer containing the first silver halide emulsion contains a second silver halide emulsion having a smaller average grain size and a higher bromide content than the first silver halide emulsion.
(3) A silver halide color photographic material comprising on a support a yellow image forming layer, a magenta image forming layer and a cyan image forming layer, each containing a light-sensitive silver halide,
   wherein when the photographic material is exposed to light so that an exposure time per pixel is 10⁻¹⁰ to 10⁻³ sec., each of the yellow, magenta cyan image forming layers after being processed meets the following requirements:
      0.77≦VE≦0.96
      0≦ΔVE≦0.10
   wherein VE represents an effective tone range and ΔVE represents a difference between the maximum value of effective tone ranges and the minimum value thereof,
   and wherein at least one of the yellow image forming layer, the magenta image forming layer and the cyan image forming layer contains at least two silver halide emulsions having a chloride content of not less than 90 mol %, an iodide content of 0 to 2.0 mol % and a bromide content of 0.1 to 10 mol % and differing in average grain size, and an iodide content of a silver halide emulsion having a largest average grain size being higher than that of a silver halide emulsion having a smallest average grain size.
(4) A silver halide color photographic material comprising on a support a yellow image forming layer, a magenta image forming layer and a cyan image forming layer, each containing a light-sensitive silver halide,
   wherein when the photographic material is exposed to light so that an exposure time per pixel is 10⁻¹⁰ to 10⁻³ sec., each of the yellow, magenta cyan image forming layers after being processed meets the following requirements:
      0.77≦VE≦0.96
      0≦ΔVE≦0.10
   wherein VE represents an effective tone range and ΔVE represents a difference between the maximum value of effective tone ranges and the minimum value thereof,
   and wherein at least one of the yellow image forming layer, the magenta image forming layer and the cyan image forming layer contains a first silver halide emulsion having a chloride content of not less than 90 mol %, an iodide content of 0 to 2.0 mol % and a bromide content of 0.1 to 10 mol %, and at least one image forming layer which is different from the layer containing the first silver halide emulsion contains a second silver halide emulsion having a smaller average grain size and a higher bromide content than the first silver halide emulsion.

The invention can provide a silver halide color photographic material exhibiting digital exposure suitability and analog exposure suitability, and achieving improvements in resistance to natural radiation, storage stability and process stability.

### DESCRIPTION OF THE PREFERRED EMBODIMENT

In what follows, preferred embodiments of the invention will be described in some detail.

In one aspect, a silver halide color photographic material (hereinafter, also denoted simply as a photographic material) of the invention is characterized in that the silver halide color photographic material comprises a support having thereon a yellow image forming layer, a magenta image forming layer and a cyan image forming layer, each containing light-sensitive silver halide, wherein a difference between a logarithmic exposure amount giving the maximum point gamma value (γmd) when exposed so that the exposure time is 10⁻⁶ sec per pixel (which is also denoted simply as Log Ed) and then processed, and a logarithmic exposure amount giving the maximum point gamma value (γma) when exposed so that the exposure time is 0.5 sec per pixel (which is also denoted simply as Log Ea) and then processed, Δ Log E (which is also denoted as Log Ed−Log Ea) is not more than 0.15.

First, there will be described the difference (Δ Log E) of logarithmic exposure giving the maximum point gamma values The difference Δ Log E being not more than 0.15 means that when each of the color image forming layers of the photographic material is exposed for 10⁻⁶ sec. or 0.5 sec. and then process, and obtained characteristic curves are allowed to be overlapped at the point of a density of 0.8, the difference between positions corresponding exposures giving the maximum point gamma on both characteristic curves (Δ Log E) is not more than 0.1.

The exposure time of 10⁻⁶ sec. was selected to evaluate a high illumination exposure aptitude of digital exposure, and the exposure time of 0.5 sec. was selected to evaluate a low illumination exposure aptitude of analogue exposure.

The point gamma of this invention, as described in T. H. James, The Theory of the Photographic Process, 4th edition, page 502, is defined as follows:
point gamma=dD/d Log E
where D is density and E is exposure; that is, the point gamma is a differential value at an arbitrary point on a characteristic curve comprised of an ordinate of density (D) and abscissa of exposure (Log E).

It was found by the inventors of this application that when characteristic curves were superposed at a density point of 0.8, the Δ Log E was specifically important to beautifully represent character images and scenic images. It was further found that a ΔLog E of 0.15 or less resulted in superior reproduction of character quality and a scenic image even when exposed at 10⁻⁶ sec. or 0.5 sec., and that of 0.10 or less (specifically preferably, 0.07 or less) resulted in character images without causing bleeding.

In another aspect, a silver halide color photographic material of the invention is characterized in that the silver halide color photographic material comprises a support having thereon a yellow image forming layer, a magenta image forming layer and a cyan image forming layer, each comprising light sensitive silver halide, wherein when the photographic material is exposed to light for not less than 10⁻¹⁰ and not more than 10⁻³ sec. per pixel and processed, an effective tone range (which is also denoted simply as VE) of a color image obtained in each of the foregoing color image forming layers is from 0.77 to 0.96; and a difference between a maximum value of effective tone range values of the respective color image forming layers and a minimum value thereof (which is also denoted simply as AVE) is not less than 0 and not more than 0.10.

In cases when image information is digitized, an original image is divided into squares and image information is usually digitized for every square. In this invention, when the original image information is divided into squares, the minimum unit thereof is referred to as one pixel. Accordingly, the exposure time per pixel can be supposed to be the time during which an intensity or the irradiation time of a light beam is controlled based on the digital data for one pixel.

In this invention, the effective tone range (also denoted simply as VE) is defined as an exposure region in which a point gamma is not less than 1.0 when outputted as a gray scale. As a result of study by the inventors of this application, it was proved that this exposure region greatly affects print image quality at the time digital exposure was made. Specifically in cases when an interval between exposure and processing (i.e., a time after completion of exposure and before start of processing) is varied, effects on blurring of character images and occurrence of scanning exposure streaks were proved to be marked.

One feature of the invention is that the effective tone ranges (VE) of the respective color image forming layers are each not less than 0.77 and not more than 0.96, preferably not less than 0.82 and not more than 0.96, and more preferably not less than 0.84 and not more than 0.96.

Another feature is that the difference (ΔVE) between the maximum value of effective tone range values of the respective color image forming layers and the minimum value thereof is not less than 0 and not more than 0.10. It is assumed that a less value of ΔVE maintain relatively superior balance of yellow, magenta and cyan images, whereby blurring of character images and occurrence of scanning exposure streaks of a solid image are reduced.

Effects aimed in this invention can be achieved by meeting requirements of this invention under the exposure condition of the exposure time per pixel being 10⁻¹⁰ to 10⁻³ sec. In order to assure the effects of the invention, it is preferred to make evaluation according to the following procedure. Thus, using a laser scanning exposure apparatus which has been adjusted so that overlap of light beam rasters falls within the range of 5 to 30%, a 1 cm square patch is exposed onto a photographic material with varying the exposure amount (i.e., the photographic material is exposed with varying the exposure amount so as to give 1 cm square patches having different gray densities). The thus exposed photographic material is processed using the following color developer (CDC-1) at a temperature of 37±0.5° C. for a period of 45 sec. (which is followed by conventional bleach-fixing and stabilization). Gray patches of the thus processed photographic material are measured with respect to reflection density to prepare a characteristic curve comprised of an ordinate of reflection density (D) and an abscissa of logarithmic exposure (Log E). Differential value of density vs. exposure for each step is calculated on the characteristic curve to determine a point gamma value. In this invention, the time after completion of exposure and before start of development is one hour.

Color developing agent

| | | |
|---|---|---|
| Water | 800 | ml |
| Triethylenediamine | 2 | g |
| Diethylene glycol | 10 | g |
| Potassium bromide | 0.02 | g |
| Potassium chloride | 4.5 | g |
| Potassium sulfite | 0.25 | g |
| N-ethyl-N-(β-methanesulfonamidoethyl)- | 4.0 | g |
| 3-methyl-4-aminoaniline sulfate | | |
| N,N-diethylhydroxylamine | 5.6 | g |
| Triethanolamine | 10.0 | g |
| Sodium diethylenetriaminepentaacetate | 2.0 | g |
| Potassium carbonate | 30 | g |

Water was added to make the total amount of 1 liter and the pH is adjusted to 10.1 with sulfuric acid or potassium hydroxide.

In this invention, the diameter of a light beam (beam diameter) is to be the width of one raster. The beam diameter is defined as the diameter of a circle formed of points corresponding to the maximum value of light beam intensity (center of the light beam), multiplied by e⁻², which can be determined using, for example, a beam monitor having the combination of a slit and a power-meter.

In this invention are obtained prints exhibiting enhanced character reproduction and exhibiting reduced scanning unevenness in scenic images even when exposed in various digital exposure apparatuses having different exposure light sources and exposure systems, and are stably obtained prints exhibiting little variation in density even when the interval between exposure and development is varied. However, the mechanism thereof is not clearly understood but it is supposed to be due to following factors. Thus, a silver halide color photographic material is exposed to form a latent image in the vicinity of a sensitivity speck of light sensitive silver halide, which is further developed to obtain print images. However, sensitivity specks formed mainly by chemical sensitization and latent images formed by exposure to light respectively are not uniform, and the sensitivity specks and the latent images respectively exist in various states, and having a distribution. It is supposed that such a distribution is basically reflected in a characteristic curve and it is therefore supposed that most photographic materials differing in characteristic curve form are different in distribution of sensitivity specks or latent images. It is assumed that when exposed to light at a high intensity for a short period, sensitivity specks which are easily affected by exposure intensity or time exist. Accordingly, it is supposed that in cases where respective parameters are designed so as to fall within the range of this invention, the proportion of sensitivity specks which are easily affected becomes less, leading to enhanced stability of print reproduction even when exposed to different light sources or in different exposure systems. Furthermore, it is assumed that when exposed to light at a high intensity for a short period, latent images which are easily variable by aging after exposure exist, accordingly, it is supposed that in cases where respective parameters are designed so as to fall within the range of this invention, the proportion of latent images which are easily variable becomes less, leading to enhanced stability of print reproduction even when varying in interval between exposure and development.

A silver halide color photographic material of the invention is exposed, for example, at a exposure time of 10⁻⁶ sec. per pixel, based on digital image information to form an image. In cases when image information is digitized, an original image is divided into squares and image information is usually digitized for every square. In the invention, when the original image information is divided into squares, the minimum unit thereof is referred to as one pixel. Accordingly, the exposure time per pixel can be supposed to be the time during which an intensity or the irradiation time of a light beam is controlled based on the digital data for one pixel. The exposure time per pixel is preferably not more than 10⁻³ sec. and not less than 10⁻⁶ sec. Advantageous effects of the invention can be achieved by meeting the requirements of the invention under the exposure condition falling the foregoing exposure time range.

In the invention, formation of one color image is performed preferably by an independent single exposure. The image formation by an independent single exposure means, in other words, an exposure system in which plural exposures are simultaneously conducted to form a single color image and it is also an exposure system in which a light beam exposing data of one pixel onto a silver halide color photographic material does not simultaneously exist in plural portions.

In general, scanning exposure with light beams is conducted by a combination of linear exposures with a light beam (i.e., raster exposure or main scanning) and shifting photographic material in the direction perpendicular to the linear exposure (i.e., sub-scanning). There may be employed, for example, a system, in which a photographic material is fixed onto the exterior or interior surface of a cylindrical drum (drum system), and the main scanning is performed by rotating the drum under an irradiating light beam and the sub-scanning is concurrently performed by shifting the light source perpendicular to the rotating direction of the drum; and a system, in which a light beam is irradiated onto a polygon mirror and the reflected beam is allowed to scan horizontally to the rotating direction of the polygonal mirror (main scanning) and the photographic material is concurrently allowed to move vertically to the rotating direction of the polygon mirror to perform the sub-scanning (a polygon system). In the drum system, the main scanning speed can be controlled by adjusting the diameter or the rotating speed of the drum and the sub-scanning speed can be controlled by adjusting the shift speed of the light source. In the polygon system, the main scanning speed can be controlled by adjusting the size, number of faces or rotating speed of the polygon mirror and the sub-scanning can be controlled by adjusting the transport speed of the photographic material.

The light beam overlap between rasters can optimally be controlled by adjusting timing of the main scanning speed and the sub-scanning speed. In cases when an exposure head having arrayed light sources is employed, overlap between rasters can be controlled by optimally adjusting spacing between the light sources.

As light sources usable in the invention are employed those known in the art, including a light emission diode (LED), a gas laser, a semiconductor laser (LD), a combination of an LD or solid laser using LD as an exciting light source, and secondary harmonic generator element (so-called SHG element), organic or inorganic EL elements, and commonly known vacuum fluorescent display tube. There are also preferably employed a combination of a halogen lamp and a PLZT element, DMD element or shutter element such as liquid crystal and a combination of a color filter.

Means for satisfying the requirement as defined above are not specifically limited and include, for example, appropriate control of characteristics of light-sensitive silver halide contained in photographic material and optimal control of the kind or the addition amount of various photographic additives such as light-sensitive silver halide, couplers or inhibitors, which can be employed singly or in combination to achieve the invention.

Subsequently, there will be described silver halide emulsions relating to the invention.

In one aspect, the silver halide color photographic material of the invention is characterized in that at least one of a yellow image forming layer, a magenta image forming layer and a cyan image forming layer includes at least two silver halide emulsions, each of which contains silver halide grains having a chloride content of not less than 90 mol %, an iodide content of 0 to 2.0 mol % and a bromide content of 0.1 to 10 mol % and which are different in average grain size.

Silver halide grains of the silver halide emulsion have a chloride content of not more than 90 mol %, preferably not more than 93 mol %, and more preferably not more than 95 mol %. The iodide content is from 0 to 2.0 mol %, preferably from 0.05 to 2 mol %, and more preferably from 0.05 to 1.0 mol %; the bromide content is from 0.1 to 10 mol %, and preferably from 2 to 8 mol %.

Further, at least two silver halide emulsions each having the foregoing halide composition and different average grain sizes are included, in which the iodide content of a silver halide emulsion the largest average grain size is higher than that of a silver halide emulsion the smallest average grain size. Thus, when the iodide content of a silver halide emulsion the largest average grain size is denoted as I₁ (mol %) and the iodide content of a silver halide emulsion the smallest average grain size is denoted as I₂ (mol %), the requirement of I₁>I₂ is satisfied, and I₂/I₁ is preferably in the range of from 0 to 0.8 and more preferably from 0.1 to 0.6.

In the invention, at least one layer (which is denoted as image forming layer 1) of a yellow image forming layer, a magenta image forming layer and a cyan image forming layer contains at least a silver halide emulsion (which is denoted as silver halide emulsion A) including silver halide grains having a chloride content of not less than 90 mol %, an iodide content of 0 to 2.0 mol % and a bromide content of 0.1 to 10 mol %, and at least an image forming layer (which is denoted as image forming layer 2) which is different from the foregoing image forming layer 1 contains a silver halide emulsion (which is denoted as silver halide emulsion B) having a smaller average grain size and a higher bromide content than the silver halide emulsion A. Thus, when the average grain size of the silver halide emulsion A contained in the image forming layer 1 is denoted as R₁ (μm) and that of the silver halide emulsion B contained in the image forming layer 2 is denoted as R₂ (μM), the requirement of R₁>R₂ is satisfied and R₁/R₂ is preferably from 1.01 to 4.0, and more preferably, from 1.30 to 3.00. Further, when the bromide content of the silver halide emulsion A contained in the image forming layer 1 is denoted as Br₁ (mol %) and that of the silver halide emulsion B contained in the image forming layer 2 is denoted as Br₂ (mol %), the requirement of Br₁<Br₂ is satisfied, and Br₁/Br₂ is preferably from 0.2 to 0.9, and more preferably from 0.5 to 0.8.

The maximum point γ value or the effective tone range (VE) falling within the range of specific values, as defined in the invention, and combinations of the halide composition and the average grain size of the silver halide emulsion used in an image forming layer, and of the number of silver halide emulsions can result in silver halide color photographic material exhibiting digital exposure suitability and analog exposure suitability, and achieving improvements in resistance to natural radiation, storage stability and process stability.

There will be further described silver halide emulsions relating to the invention.

The silver halide grains relating to this invention preferably have at least one iodide-localized silver halide phase in the interior of the grains in terms of minimizing a decrease of contrast in the high density region of a characteristic curve obtained when exposed to light at a high intensity for a short time. In the invention, the interior of the grains refers to a silver halide phase, except for the grain surface. The iodide-localized silver halide phase (hereinafter, also denoted as iodide-localized phase) is a silver halide phase having at least two times the average iodide content of the grains, preferably at least three times the average iodide content, and more preferably at least 5 times the average iodide content.

The iodide-localized phase is located in a portion external to 60% (preferably 70%, and more preferably 80%) of the grain volume within the grain.

In one preferred embodiment, the iodide-localized phase exists in the form of a layer in the interior of the grain (which is hereinafter also called iodide-localized layer) and the iodide-localized layer preferably composed of at least two layers, in which the main layer is introduced according to the conditions described above and at least one layer (hereinafter, called a sub-layer) having an iodide content less than the maximum iodide content is introduced closer to the grain surface than the main layer. Iodide contents of the main layer and sub-layer can be chosen in accordance with the objective. Preferably, the main layer has an iodide content as high as possible and the sub-layer has an iodide content lower than the main layer from the viewpoint of latent image stability.

In another preferred embodiment, the iodide-localized phase, which exists in the vicinity of corners or edges of the grain can be used in combination with the foregoing iodide-localized phase.

A silver halide emulsion comprising silver halide grains having a high bromide portion within the grain is also preferred in this invention. The high bromide portion may be formed by an epitaxial junction or by forming a core/shell structure. Alternatively, there may exist regions partially differing in bromide composition without forming a complete layer. The bromide composition may be continuously varied or discontinuously varied, and silver halide grains having a bromide-localized phase in the vicinity of corners of the grain are preferred. The expression bromide-localized phase herein means a silver halide phase having a relatively high bromide content. Thus, the bromide-localized phase has a bromide content of at least two times the average bromide content of the grains, preferably at least three times and more preferably at least 5 times the average bromide content.

The bromide-localized phase preferably contains a Group 8 metal compound, as described later. The Group 8 metal compound is preferably an iridium complex compound.

In the silver halide emulsion relating to the invention, the coefficient of variation of iodide contents among silver halide grains is preferably less than 40%, more preferably less than 30%, and still more preferably less than 20%; and the coefficient of variation of bromide contents among silver halide grains is preferably less than 3b %, and more preferably less than 20%.

The bromide content and iodide content of silver halide grains can be determined in the EPMA method (Electron Probe Micro Analyzer method). Thus, silver halide grains are dispersed so as to not be in contact with each other to prepare a sample. The sample is irradiated with an electron beam, while cooling at a temperature of not more than −100° C. using liquid nitrogen, and the characteristic X-ray intensities of silver, bromine and iodine, radiated from a single silver halide grain are measured to determine iodide and bromide contents of the grain.

According to the method described above, the bromide contents are determined for at least 300 silver halide grains and the averaged value thereof is defined as an average bromide content, and the coefficient of variation of bromide contents among grains is calculated, based on the following equation:
coefficient of variation of bromide contents among grains=[(standard deviation of bromide contents of silver halide grains)/(average bromide content)]×100(%).

Similarly to the above, the iodide contents are determined for at least 300 silver halide grains and the averaged value thereof is defined as an average iodide content, and the coefficient of variation of iodide contents among grains is calculated, based on the following equation:
coefficient of variation of iodide contents among grains=[(standard deviation of iodide contents of silver halide grains)/(average iodide content)]×100(%).

There can be used various iodine compounds to allow silver iodide to be contained in silver halide grains. Examples thereof include the use of an aqueous iodide salt solution, such as an aqueous potassium iodide solution, the use of a polyiodide compound, as described in S. Nakahara “Mukikagobutsu•Sakutai Jiten” (Dictionary of Inorganic Compound and Complex, page 944, published by Kodan-sha) and the use of fine iodide-containing silver halide grains or iodide ion-releasing agents, as disclosed in JP-A No. 2-68538. The use of an aqueous iodide salt solution, fine iodide-containing silver halide grains or iodide ion-releasing agents is preferred, the use of iodide ion-releasing agents is more preferred, and the use of iodide ion-releasing compounds described in JP-A No. 11-271912 is specifically preferred. The iodide content of silver halide grains and the iodide content of an iodide-localized phase can arbitrarily be controlled by adjusting the concentration or the quantity of an iodide containing solution.

There can also be used various bromide compounds to allow silver bromide to be contained in silver halide grains. Examples thereof include the use of an aqueous bromide salt solution, such as an aqueous potassium bromide solution, the use of bromide-containing silver halide fine-grains or bromide ion-releasing agents, as disclosed in JP-A No. 2-68538. Of these, use of an aqueous bromide salt solution, fine bromide-containing silver halide grains or bromide ion-releasing agents is preferred, the use of bromide ion-releasing agents is more preferred. The bromide content of silver halide grains and the bromide content of a bromide-localized phase can arbitrarily be controlled by adjusting the concentration or the quantity of an bromide containing solution.

When allowing silver iodide and/or silver bromide to be contained in a silver halide phase by supplying silver halide fine-grains, the silver halide fine-grains preferably have an average grain size of not more than 0.05 μm, more preferably from 0.001 to 0.03 μm, and still more preferably from 0.001 to 0.02 μm. The silver halide fine-grains are prepared preferably using a low molecular weight gelatin having an average molecular weight of 40,000 or less, more preferably from 5,000 to 25,000, and still more preferably from 5,000 to 15,000. The silver halide fine-grains are prepared preferably at a temperature of not more than 40° C., more preferably not more than 30° C., and still more preferably from 5 to 20° C. The silver halide fine-grains can be prepared by commonly known methods and apparatuses and the use of a continuous nucleation apparatus described in JP-A No. 2000-112049 is specifically preferred.

Silver halide grains of the silver halide emulsion of the invention preferably occlude, in the interior of the grains, a compound represented by the following formula (S): 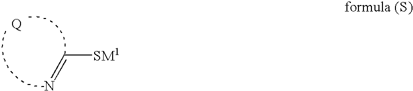
wherein Q is an atomic group necessary to form a 5- or 6-membered nitrogen-containing ring; M¹ is a hydrogen atom, an alkali metal or a group forming a monovalent cation (or a monovalent cation group).

The compound of formula (S) is preferably a compound represented by the following formula (S-2): 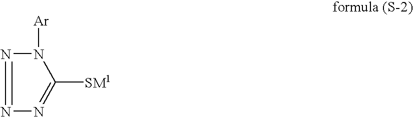
wherein Ar is a group represent by the following formula: 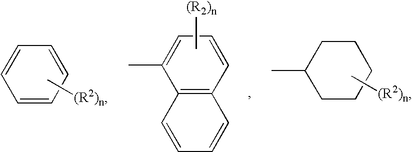
wherein R² is an alkyl group, an alkoxy group, a carboxy group or its salt, a sulfo group or its salt, a hydroxy group, an amino group, an acylamino group, a carbamoyl group or a sulfonamido group; n is an integer of 0 to 2; M¹ is the same as defined in the foregoing formula (S).

In the foregoing, the interior of the grains refers to a silver halide phase except the surface of the silver halide grains.

In the formula (S), examples of the 5-membered ring containing Q include an imidazole ring, tetrazole ring, thiazole ring, oxazole ring, selenazole ring, benzimiazole ring, naphthoimidazole ring, benzothiazole ring, naphthothiazole ring, benzoselenazole ring, naphthoselenazole ring, and benzoxazole ring. Examples of the 6-membered ring containing Q include a pyridine ring, pyrimidine ring and quinoline ring. The 5-membered or 6-membered ring may be substituted.

Alkali metals represented by M¹ include, for example, sodium atom and potassium atom. Monovalent cation groups represented by M¹ include, for example: NH₄, N(CH₃)₄, N(C₄H₉)₄, N(CH₃)₃C₁₆H₃₃, N(CH₃)₃CH₂C₆H₅.

The mercapto compound represented by the foregoing formula (S) or (S-2) is preferably mercapto compounds represented by the following formula (S-1), (S-3) or (S-4): 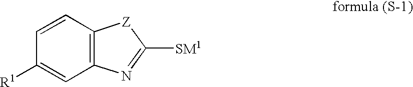
wherein R¹ is a hydrogen atom, an alkyl group, an alkoxy group, an aryl group, a halogen atom, a carboxyl group or its salt, a sulfo group or its salt or an amino group; Z is —NH—, —O— or —S—: and M¹ is the same as defined in the foregoing formula (S)

In the foregoing formulas (S-1) and (S-2), the alkyl group represented by R¹ and R² includes, for example, methyl, ethyl and butyl; the alkoxy group includes methoxy and ethoxy, salts of the carboxy or sulfo group includes sodium and ammonium salts. In formula (S-1), the aryl group represented by R¹ includes, for example, phenyl and naphthyl, and the halogen atom includes, for example, chlorine atom and bromine atom. In formula (S-2), the acylamino group represented by R² includes, for example, methylcarbonylamino and benzoylamino; the carbamoyl group includes, for example, ethylcarbamoyl and phenylcarbamoyl; and the sulfonamido group includes, for example, methylsulfonamido and phenylsulfonamido. The foregoing alkyl, alkoxy, aryl, amino, acylamino, carbamoyl and sulfonamido groups may be substituted with substituents. 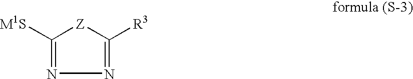
wherein Z is —NR³—, an oxygen atom or a sulfur atom; R³ is a hydrogen atom, alkyl group, aryl group, alkenyl group, cycloalkyl group, —SR³¹, —NR³²(R³³), —NHCOR³⁴, —NHSO₂R³⁵ or a heterocyclic group, in which R³¹ is a hydrogen atom, alkyl group, alkenyl group, cycloalkyl group, aryl group-COR³⁴, or —SO₂R³⁵, R³² and R³³ are each a hydrogen atom, alkyl group or aryl group, R³⁴ and R³⁵ are each an alkyl group or aryl group; M¹ is the same as defined in formula (S).

In the foregoing formula (S-3), the alkyl group represented by R³, R³¹, R³², R³³, R³⁴ and R³⁵ includes, for example, methyl, benzyl, ethyl and propyl; and the aryl group includes, for example, phenyl and naphthyl. The alkenyl group represented by R³ and R³¹ includes, for example, propenyl; the cycloalkyl group includes, for example, cyclohexyl. The heterocyclic group represented by R³ includes, for example, furyl and pyridinyl. The foregoing alkyl or aryl group represented by R³, R³¹, R³², R³³, R³⁴ and R³⁵, the alkenyl or cycloalkyl group represented by R³ and R³¹ and the heterocyclic group represented by R³ each may be substituted with substituents. 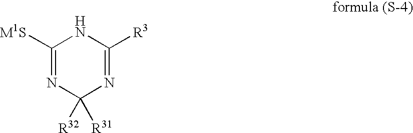
wherein R³ and M¹ are each the same as defined in the foregoing formula (S-3); R³¹ and R³² are each the same as defined in the foregoing formula (S-3).

Specific examples of the compound represented by formula (S) are shown below but are by no means limited to these.

| | |
|---|---|
| | S-1-1 |
| 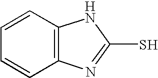 | |
| | S-1-2 |
| 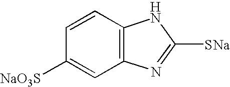 | |
| | S-1-3 |
| 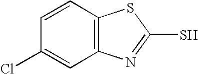 | |
| | S-1-4 |
| 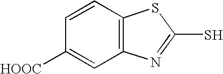 | |
| | S-1-5 |
| 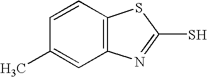 | |
| | S-1-6 |
| 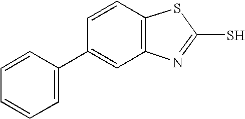 | |
| | S-1-7 |
| 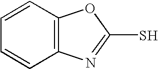 | |
| | S-1-8 |
| 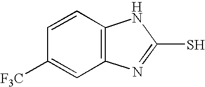 | |
| | S-2-1 |
| 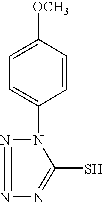 | |
| | S-2-2 |
| 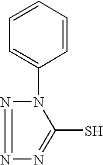 | |
| | S-2-3 |
| 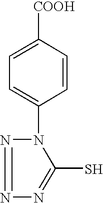 | |
| | S-2-4 |
| 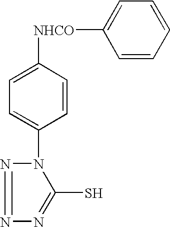 | |
| | S-2-5 |
| 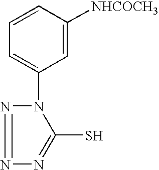 | |
| | S-2-6 |
| 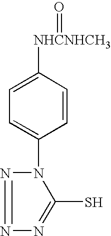 | |
| | S-2-7 |
| 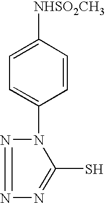 | |
| | S-2-8 |
| 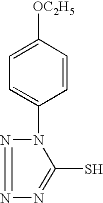 | |

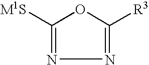

| Compound | R³ | M¹ |
|---|---|---|
| S-3-1 | —C₂H₅ | —H |
| S-3-2 | —CH₂—CH═CH₂ | —H |
| S-3-3 | —CH═CH—CH₂—CH₃ | —H |
| S-3-4 | —C₇H₁₅ | —H |
| S-3-5 | —C₉H₁₉ | —Na |
| S-3-6 | 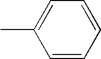 | —H |
| S-3-7 | —C₄H₉(t) | —H |
| S-3-8 | 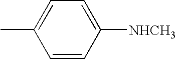 | —H |
| S-3-9 | 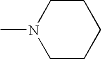 | —H |
| S-3-10 | 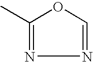 | —H |
| S-3-11 | 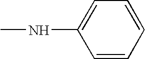 | —H |
| S-3-12 | 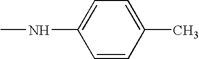 | —H |
| S-3-13 | —NHCOCH₃ | —H |
| S-3-14 | 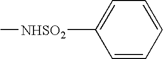 | —H |
| S-3-15 | —N(CH₃)₂ | —H |
| S-3-16 | 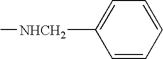 | —H |
| S-3-17 | 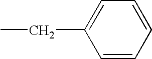 | —H |
| S-3-18 | —S—CH₃ | —H |
| S-3-19 | 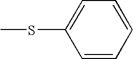 | —H |
| S-3-20 | —SH | —H |
| S-3-21 | —H | —H |
| S-3-22 | —C₂H₅ | —H |
| S-3-23 | —C₄H₉(t) | —H |
| S-3-24 | —C₆H₁₃ | —H |
| S-3-25 | 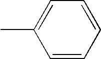 | —H |
| S-3-26 | 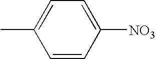 | —H |
| S-3-27 | 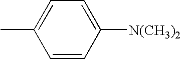 | —H |
| S-3-28 | 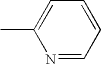 | —H |
| S-3-29 | 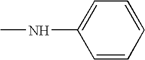 | —H |
| S-3-30 | —NH—N(CH₃)₂ | —H |
| S-3-31 | —CH₂CH═CH₂ | —H |
| S-3-32 | —SH | —H |
| S-3-33 | —NHCOC₂H₅ | —H |

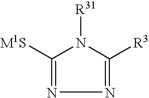

| Compound | R³ | R³¹ | M¹ |
|---|---|---|---|
| S-3-34 | —C₂H₅ | —H | —H |
| S-3-35 | —CH₃ | —CH₃ | —H |
| S-3-36 | —CH₃ | 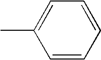 | —H |
| S-3-37 | —NHCOCH₃ | —CH₃ | —H |
| S-3-38 | 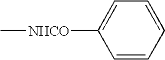 | 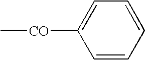 | —H |
| S-3-39 | —NHCOCH₃ | —COCH₃ | —H |
| S-3-40 | —NHCOCH₃ | 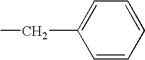 | —H |
| S-3-41 | —NHCOC₂H₅ | 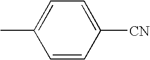 | Na |
| S-3-42 | 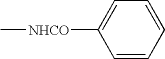 | 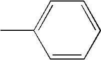 | H |
| S-3-43 | —NHSO₂CH₃ | —H | H |
| S-3-44 | 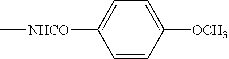 | —CH₃ | Na |
| S-3-45 | 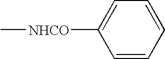 | —CH₂CH═CH₂ | H |
| S-3-46 | 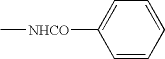 | 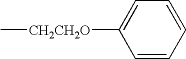 | —H |

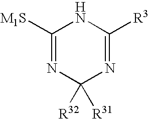

| Compound | R³ | R³¹ | R³² | M¹ |
|---|---|---|---|---|
| S-4-1 | —C₂H₅ | —CH₃ | —CH₃ | —H |
| S-4-2 | 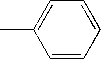 | —CH₃ | —CH₃ | —H |
| S-4-3 | —NH₂ | —H | 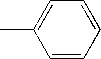 | —H |
| S-4-4 | 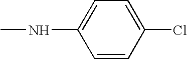 | —H | —C₄H₉ | —H |
| S-4-5 | —NHCOCH₃ | —CH₃ | —CH₃ | —H |
| S-4-6 | 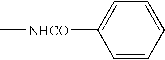 | —CH₃ | —CH₃ | —H |
| S-4-7 | 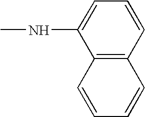 | —CH₃ | —C₃H₇(i) | —H |

S-4-8

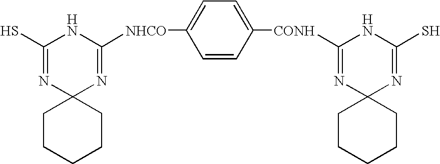

The compounds represented by formula (S) include compounds described, for example, in JP-B No. 40-28496, JP-A 50-89034; J. Chem. Soc. 49, 1748 (1927), ibid 4237 (1952); J. Org. Chem. 39, 2469 (1965); U.S. Pat. No. 2,824,001; J. Chem. Soc. 1723 (1951); JP-A No. 56-111846; U.S. Pat. Nos. 1,275,701, 3,266,897, 2,403,927, and can be synthesized in accordance with the synthesis described in the foregoing literature.

The compound of formula (S) is occluded in the interior of the grains, preferably in an amount of 1×10⁻⁸ to 10⁻¹ mol/mol.AgX, and more preferably 1×10⁻⁷ to 1×10⁻² mol/mol.AgX.

There may be any number of regions differing in concentration of compound of formula (S) in the interior of the grains and the concentration is not specifically limited so long as intended grains are formed. It is preferred that at least two silver halide phases differing in concentration of compound of formula (S) are in the interior of the grains, and it is more preferred that a silver halide phase having a less concentration of compound of formula (S) than a silver halide phase having a maximum concentration of compound (S) is external to the silver halide phase having a maximum concentration of compound of formula (S). In one preferred embodiment of this invention, for example, the outermost region (shell portion) within the grain has a concentration of compound of formula (S) less than the internal region (core portion). The shell portion refers to the final region in the course of grain formation through grain growth and the outermost region of the grain including the grain surface. The average concentration of compound of formula (S) in the shell portion is preferably less than 1.5×10⁻⁴ mol per mol of silver halide. The concentration of compound of formula (S) may be 0 and is preferably from 0.1 to 1×10⁻⁴ mol, and more preferably from 0.1 to 5×10⁻⁵ mol per mol of silver halide. The concentration of compound of formula (S) in the core portion is not specifically limited insofar as it is less than the shell portion, and preferably from 0.5 to 3×10⁻⁴ mol per mol of silver halide.

There may be occluded plural compounds of formula (S) in combination and plural silver halide phases, or the core portion and the shell portion are different in the kind or combination thereof. The compound of formula (S) may be allowed to be present in a grain forming system using any method and preferably to be contained in a halide solution. In the silver halide grains relating to this invention, the volume of a shell portion is preferably not more than 50%, and more preferably not more than 30% of the grain volume. In one preferred embodiment, the shell portion accounts for not more than 10% of the grain volume and is located in a sub-surface region near the grain surface.

The compound of formula (S) is included not only in the interior of the grains but also may be added at any time selected from the period from completion of silver halide grain formation to before start of chemical sensitization, the time of starting chemical sensitization, the period during chemical sensitization, the time of completion of chemical sensitization and the period after completion of chemical sensitization and before coating.

Silver halide grains of the invention preferably are regular crystal grains having dislocation lines in the fringe portion of the grains. Thus, silver halide grains having dislocation lines in the fringe portion preferably account for at least 50% by number of total silver halide grains, more preferably at least 70% and still more preferably at least 80% by number.

When a cubic grain relating to the invention is projected from the direction vertical to (100) face of the grain, the fringe portion is a region of from the edge of the projection to a length of 20% of the grain diameter in the inner direction vertical to the edge, inclusive of the edge.

In the silver halide emulsion of the invention, preferably, silver halide grains having at least 5 dislocation lines in the fringe portion account for at least 50% by number of total silver halide grains; more preferably, silver halide grains having at least 10 dislocation lines in the fringe portion account for at least 50% by number of total silver halide grains; and still more preferably silver halide grains having at least 20 dislocation lines in the fringe portion account for at least 50% by number of total silver halide grains. The silver halide grains each may contain dislocation lines in a portion other than the fringe portion.

The dislocation lines in silver halide grains can be directly observed by means of transmission electron microscopy at a low temperature, for example, in accordance with methods described in J. F. Hamilton, Phot. Sci. Eng. 11 (1967) 57 and T. Shiozawa, Journal of the Society of Photographic Science and Technology of Japan, 35. (1972) 213. Silver halide grains are taken out from an emulsion while making sure not to exert any pressure that might cause dislocation in the grains, and they are then placed on a mesh for electron microscopy. The sample is then observed by transmission electron microscopy, while being cooled to prevent the grain from being damaged by the electron beam. Since electron beam penetration is hampered as the grain thickness increases, sharper observations are obtained when using an electron microscope of higher voltage (e.g., at a voltage 200 kV or more for a 0.25 μm thick grain). It is preferred to employ an electron microscope having a still higher acceleration voltage for further thicker grains.

When transmission observation by an electron beam is difficult due to grain thickness, a silver halide grain may be sliced parallel to a (100) face at not more than 0.25 μm thick, while paying close attention so as not to apply pressure to the extent of causing dislocation and the presence/absence of dislocation line can be confirmed by observation of the slice.

In the silver halide grains of this invention, the coefficient of variation of the number of dislocation lines per grain among grains preferably is not more than 30% and more preferably not more than 20%. The coefficient of variation of the number of dislocation lines can be determined by observation of dislocation lines of at least 300 silver halide grains, based on the following equation:
K (%)=(σ/α)×100
where K is the coefficient of variation among grains with respect to the number of dislocation lines per grain, σ is the standard deviation of dislocation lines and α is the average value of dislocation lines per grain.

Dislocation lines can be introduced into silver halide grains by employing an operation of formation of an iodide-localized phase and/or a bromide-localized phase by the use of the various iodine compounds and/or bromides described above. Examples thereof include the use of an aqueous iodide salt solution, such as an aqueous potassium iodide solution, the use of a polyiodide compound, as described in S. Nakahara “Mukikagobutsu•Sakutai Jiten” (Dictionary of Inorganic Compound and Complex, page 944, published by Kodan-sha) and the use of iodide-containing silver halide fine-grains or iodide ion-releasing agents, as disclosed in JP-A No. 2-68538. The use of iodide ion-releasing agents and/or bromide ion-releasing agents is preferred, the use of iodide ion-releasing agents is more preferred, and the use of iodide ion-releasing compounds and/or bromide ion-releasing compounds described in JP-A Nos. 11-271912 and 2000-250164 is specifically preferred.

The number of dislocation lines within the grain and the region forming dislocation lines can be optimally controlled by optimum selection of the addition amount of the foregoing iodide ion-releasing compounds and/or bromide ion-releasing compounds, the pH value causing iodide ion and/or bromide ion release, the inter-grain distance of silver halide grains, the growth temperature of silver halide grains and the rate of releasing iodide ions and/or bromide ions.

In the process of formation of silver halide grains, the iodide ion-releasing agent and/or bromide ion-releasing agent are added preferably within 50% to 98% of the final grain volume, and more preferably 70% to 95%. The iodide ion-releasing agent and/or bromide ion-releasing agent ate added preferably in an amount of 0.02 to 8 mol % based on silver halide, and more preferably 0.04 to 5 mol %.

The pH causing the iodide ion-releasing agent and/or bromide ion-releasing agent to release iodide ion and/or bromide ion is preferably from 5.0 to 12.0, and more preferably from 6.0 to 11.0. The temperature causing the iodide ion-releasing agent and/or bromide ion-releasing agent to release iodide ion and/or bromide ion is preferably from 10 to 80° C., and more preferably from 20 to 70° C. Preferably, concentration by ultrafiltration is conducted to optionally control the inter-grain distance at the time of causing the iodide ion-releasing agent and/or bromide ion-releasing agent to release iodide ion and/or bromide ion. At least two kinds of the iodide ion-releasing agent and/or bromide ion-releasing agent may be used in combination.

The silver halide grains may have any shape but preferably are cubic grains having a (100) face as the crystal surface. Further, octahedral, tetradecahedral, tetracosahedral or dodecahedral grains are also usable, which can be prepared according to methods described in U.S. Pat. Nos. 4,183,756 and 4,225,666; JP-A No. 55-26589 and JP-B No. 55-42737 (hereinafter, the term, JP-B refers to Japanese patent Publication); J. Photogr. Sci., 21, 39 (1973). Furthermore, there may be used grains having twin plane(s) or tabular grains other than cubic rains.

The silver halide grains of the invention are preferably composed of grains of a single form. Two or more kinds of monodisperse silver halide emulsions may be incorporated to a single layer.

Silver halide grains usable in the invention are not specifically limited with respect to grain size, but the grain size is preferably from 0.1 to 5.0 μm, and more preferably from 0.2 to 3.0 μm. Cubic grains of 0.1 to 1.2 μm (more preferably 0.15 to 1.0 μm) are preferred.

With respect to the grain size distribution, monodisperse silver halide grains exhibiting a coefficient of variation of grain size of not more than 0.22 (preferably not more than 0.15 and more preferably not more than 0.1) are preferred.
Coefficient of variation=S/R
where S is a standard deviation of grain size distribution, R is an average grain size. The grain size defined above is a diameter for a spherical silver halide grain and a diameter of a circle equivalent to the area of the projection a grain when the grain is cubic or in a shape other than sphere.

In one preferred embodiment of the invention, the silver halide color photographic material is comprised of a silver halide emulsion containing silver halide grains having a chloride content of at least 90 mol % and occluding, in the interior of the grains, at least one of a group 8 metal complex containing an aqua ligand and a group 8 metal complex containing an organic ligand.

The group 8 metal complex usable in this invention preferably is a metal complex of iridium, rhodium, osmium, ruthenium, cobalt or platinum. The metal complex may be a six-coordinate complex, five-coordinate complex, four-coordinate complex or two-coordinate complex, and a six-coordinate complex and a four-coordinate complex are preferred. Of the foregoing group 8 metal complexes containing an aqua ligand and/or an organic ligand or both of them, an iridium metal complex is preferred.

Any ligand is usable and examples of a ligand include carbonyl ligand, fulminate ligand, thiocyanate ligand, nitrosyl ligand, thionitrosyl ligand, cyano ligand, water ligand [in which water as a ligand is called an aqua (or aquo-) ligand], halogen ligand, ligands of ammonia, a hydroxide, nitrous acid, sulfurous acid and a peroxide and organic ligands. Of these, it is preferred to contain at least one ligand selected from nitrocyl ligand, thionitrocyl ligand, cyano ligand, aqua ligand, halogen ligand and an organic ligand. In this invention, the organic ligand refers to a compound containing at least one of H—C, C—C and C—N—H bonds and capable of being coordinated with a metal ion. Preferred organic ligands usable in this invention include a compound selected from pyridine, pyrazine, pyrimidine, pyrane, pyridazine, imidazole, thiazole, isothiazole, triazole, pyrazole, furan, furazane, oxazole, isooxazole, thiophene, phenthroline, bipyridine and ethylenediamine, their ions and compounds substituted with the foregoing compounds.

Preferred examples of a group 8 metal complex containing at least an aqua ligand and/or an organic ligand are shown below but are by no means limited to these. Any counter cation is usable, including potassium ion, calcium ion, sodium ion ammonium ion. Counter anions for the metal complex include nitrate ion, halide ion and perchlorate ion.
(A-1) K[IrBr₅(H₂O)]
(A-2) K₂[IrBr₅(H₂O)]
(A-3) K₃ [IrBr₅ (H₂O)]
(A-4) K₄[IrBr₅(H₂O)]
(A-5) K[IrBr₄(H₂O)₂]
(A-6) [IrBr₄(H₂O)₂]
(A-7) [IrBr₃(H₂O)₃]
(A-8) [IrBr₃(H₂O)₃]Br
(A-9) K[IrCl₅(H₂O)]
(A-10) K₂[IrCl₅(H₂O)]
(A-11) K₃[IrCl₅(H₂O)]
(A-12) K₄ [IrCl₅(H₂O)]
(A-13) K[IrCl₄(H₂O)₂]
(A-14) [IrCl₄(H₂O)₂]
(A-15) [IrCl₃(H₂O)₃]
(A-16) [IrBr₃(H₂O)₃]Cl
(A-17) [Ir(bipy)Cl₄]⁻
(A-18) [Ir (bipy)Br₄]⁻
(A-19) [Ir(bipy)₃]²⁺
(A-20) [Ir(py)₆]²⁺
(A-21) [Ir(phen)₃]²⁺
(A-22) [IrCl₂(bipy)₂]⁰
(A-23) [Ir(thia)₆]²⁺
(A-24) [IrCl₅(thia)]²⁻
(A-25) [IrCl₄(thia)₂]⁻
(A-26) [IrCl₅(5-methylthia)]²⁻
(A-27) [IrCl₄(5-methylthia)₂]¹⁻
(A-28) [IrBr₅(thia)]²⁻
(A-29) [IrBr₄ (thia)₂]¹⁻
(A-30) [IrBr₅(5-methylthia)]²⁻
(A-31) [IrBr₄(5-methylthia)₂]¹⁻
(A-32) [Ir(phen)(bipy)₃]²⁺
(A-33) [Ir(im)₆]²⁺
(A-34) [IrCl₅(im)]²⁻
(A-35) [IrCl₄(im)₂]¹⁻
(A-36) [IrBr₅(im)]²⁻
(A-37) [IrBr₄(im)₂]¹⁻
(A-38) [Ir(NCS)₂(bipy)₂]⁰
(A-39) [Ir(CN)₂(bipy)₂]⁰
(A-40) [IrCl₂(bipy)₃]⁰
(A-41) [IrCl₂(bipy)₂]⁰
(A-42) [Ir(phen)(bipy)₂]²⁺
(A-43) [Ir(NCS)₂(bipy)₂]⁰
(A-44) [Ir(NCS)₂(bipy)₂]⁰
(A-45) [Ir(bipy)₂(H₂O)(bipy′)₂]⁰
(A-46) [Ir(bipy)₂(OH)(bipy′)]⁺
(A-47) [Ir(bipy)Cl₄]²⁻
(A-48) [Ir(bipy)₃]³⁺
(A-49) [Ir(py)₆]⁺
(A-50) [Ir(phen)₃]³⁺
(A-51) [IrCl₂(bipy)₂]⁺
(A-52) [Ir(thia)₆]³⁺
(A-53) [Ir(phen)(bipy)₃]³⁺
(A-54) [Ir(im)₆]³⁺
(A-55) [Ir(NCS)₂(bipy)₂]⁺
(A-56) [Ir(CN)₂(bipy)₂]⁺
(A-57) [IrCl₂(bipy)₃]⁺
(A-58) [IrCl₂ (bipy)₂]⁺
(A-59) [Ir(phen)(bipy)₂]³⁺
(A-60) [Ir(NCS)₂(bipy)₂]⁺
(A-61) [Ir(NCS)₂(bipy)₂]⁺
(A-62) [Ir(bipy)₂(H₂O)(bipy)]³⁺
(A-63) [Ir(bipy)₂(OH)(bipy′)]²⁺

In the foregoing group 8 metal compounds or group 8 metal complexes, abbreviations are as follows:
bipy: bipyridine bidendate ligand
bipy′: bipyridine monodendate ligand
im: imidazole
py: pyridine
phen: phenthroline
thia: thiazole
5-methylthia: 5-methylthiazole.

Further to addition of at least a group 8 metal complex containing an aqua ligand and/or organic ligand in the preparation of silver halide grains, it is preferred to add a group 8 metal complex represented by the following formula:
Rₙ[MXₘY₆₋ₘ] formula (A)
wherein M is a metal selected from group 8 elements of the periodical table (preferably iron, cobalt, ruthenium, iridium, rhodium, osmium and platinum, and more preferably iron, ruthenium, iridium, rhodium, osmium); R is an alkali metal (preferably cesium, sodium and potassium); m is an integer of 0 to 6, and n is an integer of 0 to 4; X and Y are each a ligand, including carbonyl ligand, fulminate ligand, thiocyanate ligand, nitrosyl ligand, thionitrosyl ligand, cyano ligand, aqua ligand, halogen ligand, ligands of ammonia, a hydroxide, nitrous acid, sulfurous acid and a peroxide ligands.

Specific examples of the group 8 metal compound and group 8 metal complex are shown below but are by no means limited to these. Any counter cation is usable, including potassium ion, calcium ion, sodium ion ammonium ion. Counter anions for the metal complex include nitrate ion, halide ion and perchlorate ion.
E-1: K₂[IrCl₆]
E-2: K₃[IrCl₆]
E-3: K₂[Ir(CN)₆]
E-4: K₃[Ir(CN)₆]
E-5: K₂[Ir(NO)(CN)₅]
E-6: K₂[IrBr₆]
E-7: K₃[IrBr₆]
E-8: K₂[IrBr₄Cl₂]
E-9: K₃[IrBr₄Cl₂]
E-10: K₂[IrBr₃Cl₃]
E-11: K₃[IrBr₃Cl₃]
E-12: K₂[IrBr₅Cl]
E-13: K₃[IrBr₅Cl]
E-14: K₂[IrBr₅I]
E-15: K₃[IrBr₅I]
E-16: K₃[IrBr(CN)₅]
E-17: K₃[IrBr₂(CN)₄]
E-18: K₂[Ir(CN)₅(H₂O)]
E-19: K₃[Ir(CN)₅(H₂O)]
E-20: K[Ir(NO)Cl₅]
E-21: K[Ir(NS)Cl₅]
F-1: K₂[RuCl₆]
F-2: K₂[FeCl₆]
F-3: K₂[PtCl₆]
F-4: K₃[RhCl₆]
F-5: K₂[OsCl₆]
F-6: K₂[RuBr₆]
F-7: K₂[FeBr₆]
F-8: K₂[PtBr₆]
F-9: K₃[RhBr₆]
F-10: K₂[OsBr₆]
F-11: K₂[Pt(SCN)₄]
F-12: K₄ [Ru(CNO)₆]
F-13: K₄[Fe(CNO)₆]
F-14: K₂ [Pt(CNO)₄]
F-15: K₃[Co(NH₃)₆]
F-16: K₃ [Co(CNO)₆]
F-17: K₄[OS(CNO)₆]
F-18: Cs₂ [Os(NO)Cl₅]
F-19: K₂ [Ru(NO)Cl₅]
F-20: K₂ [Ru(CO)Cl₅]
F-21: Cs₂ [Os(CO)Cl₅]
F-22: K₂ [Fe(NO)Cl₅]
F-23: K₂ [Ru(NO)Br₅]
F-24: K₂ [Ru(NO)I₅]
F-25: K₂ [Ru(NS)Cl₅]
F-26: K₂[Os(NS)Cl₅]
F-27: K₂[Ru(NS)Br₅]
F-28: K₂ [Ru(NS)(SCN)₅]
F-29: K₂ [RuBr₆]
F-30: K₂ [FeBr₆]
F-31: K₄ [Fe(CN)₆]
F-32: K₃[Fe(CN)₆]
F-33: K₄[Ru(CN)₆]
F-34: K₄ [Os(CN)₆]
F-35: K₃[Rh(CN)₆]
F-36: K₄ [RuCl(CN)₅]
F-37: K₄ [OsBr(CN)₅]
F-38: K₄ [OsCl(CN)₅]
F-39: K₃ [RhF(CN)₅]
F-40: K₃[Fe(CO)(CN)₅]
F-41: K₄[RuF₂(CN)₄]
F-42: K₄[OsCl₂(CN)₄]
F-43: K₄[RhI₂(CN)₄]
F-44: K₄[Ru(CN)₅(OCN)]
F-45: K₄[Ru(CN)₅(N₃)₄]
F-46: K₄[Os(CN)₅(SCN)]
F-47: K₄[Rh(CN)₅(SeCN)]
F-48: K₄[RuF₂(CN)₄]
F-49: K₃[Fe(CN)₃Cl₃]
F-50: K₄[Os(CN)Cl₅]
F-51: K₃[Co(CN)₆]
F-52: K₂[RuBr(CN)₅]
F-53: K₂[Os(NS) (CN)₅]
F-54: K[Ru(NO)₂Cl₄]
F-55: K₄[Ru(CN)₅ (N₃)₄]
F-56: K₂[OS(NS)Cl(SCN)₄]
F-57: K₂[Ru(NS)(I)₅]
F-58: K₂[Os(NS)Cl₄(TeCN)₄]
F-59: K₂[Rh(NS)Cl₅]
F-60: K₂[Ru(NO)(CN)₅]
F-61: K[Rh(NO)₂Cl₄]
F-62: K₂[Rh(NO)Cl₅]

To allow the foregoing Group 8 metal compounds to be included, doping may be conducted during physical ripening of silver halide grains or in the course of forming silver halide grains (in general, during addition of water-soluble silver salt and alkali halide). Alternatively, forming silver halide grains is interrupted and doping is carried out, then, the grain formation is continued. Doping can also be conducted by performing nucleation, physical ripening or grain formation in the presence of a Group 8 metal compound.

The Group 8 metal compound is used in an amount of 1×10⁻⁹ to 1×10⁻² mol, preferably 1×10⁻⁹ to 1×10⁻³ mol, and more preferably 2×10⁻⁹ to 1×10⁻⁴ mol per mol of silver halide.

Commonly known methods of adding additives to a silver halide emulsion are applicable to allow the Group 8 metal compound to be included in silver halide grains, for example, the compound may be directly dispersed in an emulsion or incorporated through solution in solvents such as water, methanol and ethanol. A method of preparing a silver halide emulsion, in which fine silver halide grains including a Group 8 metal compound are added during grain formation can be referred to a method described in JP-A Nos. 11-212201 and 2000-89403.

It is preferred that the silver halide emulsion of this invention includes a gelatin which contains substantially no calcium ion. The gelatin which contains substantially no calcium ion is one having a calcium content of 100 ppm or less, preferably 50 ppm or less, and more preferably 30 ppm or less. A gelatin which contains substantially no calcium ion can be obtained by a cationic deionization process with ion-exchange resins. A gelatin which contains substantially no calcium ion is preferably used in at least one of the processes of silver halide grain formation, desalting, dispersion, and chemical sensitization and/or spectral sensitization, and more preferably prior to chemical sensitization and/or spectral sensitization. A gelatin which contains substantially no calcium ion preferably accounts for at least 10% by weight of the whole dispersing medium of a prepared silver halide emulsion, more preferably at least 30%, and still more preferably at least 50%.

A chemically modified gelatin of which amino group is substituted is preferably used in the preparation of a silver halide emulsion of this invention to perform the formation and/or desalting of silver halide grains. Examples of such a chemically modified gelatin include modified gelatins described in JP-A Nos. 5-72658, 9-197595 and 9-251193 in which an amino group of gelatin has been substituted. The use of a chemically modified gelatin in the process of grain formation and/or desalting is preferably in an amount of at least 10% by weight of the whole dispersing medium, more preferably at least 30%, and still more preferably at least 50%. The substitution ratio of an amino group is preferably at least 30%, more preferably at least 50%, and still more preferably at least 80%.

Preferably, a silver halide emulsion is desalted after completion of grain formation. Desalting is conducted in such a manner, for example, as described in RD 17643, sect. II. Specifically, to remove unwanted soluble salts from a precipitation product or a physically ripened emulsion, a noodle washing method may be used, or inorganic salts, anionic surfactants or anionic polymers [e.g., poly(styrene sulfonic acid)] are also usable, but a flocculation method using gelatin derivatives or chemically modified gelatin (e.g., acylated gelatin and carbamoylated gelatin) and a ultrafiltration method employing membrane separation are preferred. The ultrafiltration method employing membrane separation is referred to “Kagaku Kogaku Binran (Handbook of Chemical Engineering)” 5th ed., page 924-954; RD vol. 102, 10208 and vol. 131, 13122; JP-B Nos. 59-43727 and 62-27008; JP-A Nos. 6.2-113137, 57-209823, 59-43727, 61-219948, 62-23035, 63-40137, 63-40039, 3-140946, 2-172816, 2-172817 and 4-22942. Ultrafiltration is conducted preferably employing an apparatus or a method described in JP-A Nos. 11-339923 and 11-231448.

Dispersing medium used in the preparation of silver halide emulsions is a compound exhibiting a protective colloid property for silver halide grains. Preferably, the dispersing medium is allowed to exist in the nucleation and growth stages of silver halide grain formation. Preferred dispersing mediums usable in this invention include gelatin and hydrophilic colloids. Preferred examples of gelatin usable in this invention include an alkali process or acid process gelatin having a molecular weight of ca. 100,000, an oxidized gelatin, and enzymatic process gelatin described in Bull. Soc. Sci. Photo. Japan No. 16, page 30 (1966). A gelatin an average molecular weight of 10,000 to 50,000 is preferably used in the nucleation stage of silver halide grains. To reduce the average molecular weight, the use of a gelatin degradation enzyme or hydrogen peroxide degrade s gelatin. The use of a gelatin having a relatively low methionine content in the nucleation stage is preferred specifically in the preparation of silver halide grains. The methionine content is preferably not more than 50 mmol per unit weight (g) of dispersing medium, and more preferably not more than 20 μmol. The methionine content can be reduced by subjecting gelatin to an oxidation treatment by using hydrogen peroxide and the like.

Examples of a hydrophilic colloid include gelatin derivatives, a graft polymer of gelatin with other polymers, proteins such as albumin or casein; cellulose derivatives such as hydroxyethyl cellulose, carboxymethyl cellulose, cellulose sulfuric acid esters; saccharide derivatives such as sodium alginate and starch derivatives and synthetic hydrophilic polymeric materials of homopolymers such as polyvinyl alcohol and its partial acetal, poly-N-vinylpyrrolidone, polyacrylic acid, polymethacrylic acid, polyacrylamide, polyvinylimidazole, and polyvinylpyrazole and their copolymers. Examples of usable gelatin usable include an alkali process gelatin, acid process gelatin, an oxidized gelatin, and enzymatic process gelatin described in Bull. Soc. Sci. Photo. Japan No. 16, page 30 (1966). There are also usable hydrolytic products and enzymatic degradation products of gelatin.

There can be employed a variety of apparatuses and methods for preparing silver halide emulsions, which are generally known in the art. The silver halide can be prepared according to any of acidic precipitation, neutral precipitation and ammoniacal precipitation. Silver halide grains can formed through a single process, or through forming seed grains and growing them. A process for preparing seed grains and a growing process thereof may be the same with or different from each other. Normal precipitation, reverse precipitation, double jet precipitation or a combination thereof is applicable as a reaction mode of a silver salt and halide salt, and the double jet precipitation is preferred. As one mode of the double jet precipitation is applicable a pAg-controlled double jet method described in JP-A 54-48521.

There can be employed a apparatus for supplying a silver salt aqueous solution and a halide aqueous solution through an adding apparatus provided in a reaction mother liquor, as described in JP-A 57-92523 and 57-92524; an apparatus for adding silver salt and halide solutions with continuously varying the concentration thereof, as described in German Patent 2,921,164; and an apparatus for forming grains in which a reaction mother liquor is taken out from the reaction vessel and concentrated by ultra-filtration to keep constant the distance between silver halide grains.

Solvents for silver halide such as thioethers are optionally employed. A compound containing a mercapto group; nitrogen containing heterocyclic compound or a compound such as a sensitizing dye can also be added at the time of forming silver halide grains or after completion thereof.

Subsequently, there will be described other constituents of the silver halide color photographic material.

Silver halide emulsions relating to the invention are subjected preferably to selenium sensitization. Labile selenium compounds capable of forming silver selenide upon reaction with aqueous silver nitrate are preferably used as a selenium sensitizer. Examples thereof are described in U.S. Pat. Nos. 1,574,944, 1,602,592 and 1,623,499; JP-A Nos. 60-150046, 4-25832, 4-109240 and 4-147250.

Examples of useful selenium sensitizers include colloidal selenium, isoselenocyanates (e.g., allyl isoselenocyanate), selenoureas (e.g., N,N-dimethylselenourea, N,N,N′-triethylselenourea, N,N,N′,N′-tetramethylselenourea, N,N,N′-trimethyl-N′-heptafluoropropylselenourea, N,N′-dimethyl-N,N′-bis(carboxymethyl)selenourea, N,N,N′-trimethyl-N′-heptafluoropropylcarbonylselenourea, N,N,N′-trimethyl-N′-4-nitrophenylcarbonylselenourea), selenoketones (e.g., selenoacetone, selenoacetophenone), selenoamides (e.g., selenoacetoamide, N,N-dimethylselenobenzamide), selenocarboxylic acids and selenoesters (e.g., 2-selenopropionic acid, methyl-3-selenobutylate), selenophosphates (e.g., tri-p-triselenophosphate, pentafluorophenyl-diphenylselenophosphate), and selenides (e.g., dimethylselenide, tributylphosphine selenide, triphenylphosphine selenide, tri-p-tolylphosphine selenide, pentafluorophenyl-diphenylphosphine selenide, trifurylphosphine selenide, tripyridylphosphine selenide) Of these selenium sensitizers.

Specific examples of technique for using selenium sensitizers are described in U.S. Pat. Nos. 1,574,944, 1,602,592, 1,623,499, 3,297,466, 3,297,447, 3,320,069, 3,408,196, 3,408,197, 3,442,653, 3,420,670, and 3,591,385; French Patent Nos. 2,693,038 and 2,093,209; JP-B Nos. 52-34491, 52-34492, 53-295 and 57-22090; JP-A Nos. 59-180536, 59-185330, 59-181337, 59-187338, 59-192241, 60-150046, 60-151637, 61-246738, 3-4221, 3-24537, 3-111838, 3-116132, 3-148648, 3-237450, 4-16838, 4-25832, 4-32831, 4-33043, 4-96059, 4-109240, 4-140738, 4-140739, 4-147250, 4-184331, 4-190225, 4-191729, 4-195035, 5-11385, 5-40324, 5-24332, 5-24333, 5-303157, 5-306268, 6-306269, 6-27573, 6-75328, 6-175259, 6-208184, 6-208186, 6-317867, 7-92599, 7-98483, 7-104415, 7-140579, 7-301879, 7-301880, 8-114882, 9-19760, 9-138475, 9-166841, 9-138475, 9-189979, 10-10666 and 2001-343721; British Patent Nos. 255,846 and 861,984; and H. E. Spencer, Journal of Photographic Science, 31, 158-169 (1983).

A selenium sensitizer is added preferably in an amount of 1×10⁻⁹ to 1×10⁻⁵ mol per mol of silver halide, and more preferably 1×10⁻⁸ to 1×10⁻⁵ mol. Selenium sensitizers are added to a silver halide emulsion in such a manner that additives are usually incorporated to photographic emulsion. For example, a water-soluble compound is dissolved in water and a water-insoluble or sparingly water-soluble compound is dissolved in a water-miscible solvent exhibiting no adverse effect on photographic characteristics, such as alcohols, glycols, ketones, esters, and amides, and they are added in the form of solution.

The silver halide emulsion of the invention can employ the foregoing selenium sensitization and its combination with sensitization using gold compounds or sensitization using chalcogen sensitizers. Chalcogen sensitizers include sulfur sensitizers and tellurium sensitizers as well as selenium sensitizers, of which sulfur sensitizers are preferred.

Specific examples of preferred sulfur sensitizers include thiourea derivatives such as 1,3-diphenylthiourea, triethylthiourea and 1-ethyl-3-(2-thiazolyl)thiourea; rhodanine derivatives, dithiocarbamic acids, polysulfide organic compounds, thiosulfates, and simple substance of sulfur. Of simple substance of sulfur, rhombic α-sulfur is preferred. There are also usable sulfur sensitizers described in U.S. Pat. Nos. 1,574,944, 2,410,689, 2,278,947, 2,728,668, 3,501,313, and 3,656,955; West German Patent (OLS) No. 1,422,869; JP-A Nos. 56-24937 and 55-45016.

There may be simultaneously used noble metal salts such as gold, platinum, palladium and iridium described in Research Disclosure (hereinafter, also denoted simply as RD). Of these, the use of a gold sensitizer is specifically preferred. Examples of useful gold sensitizers include chloroauric acid, gold thiosulfate, gold thiocyanic acid and organic gold compounds described in U.S. Pat. Nos. 2,597,856 and 5,049,485; JP-B No. 44-15748 and JP-A Nos. 1-147537 and 4-70650. When performing sensitization by using a gold complex, ligands for gold, such as a thiosulfate, thiocyanate, and thioether are preferably used as an auxiliary agent and the use of a thiocyanate is specifically preferred.

As various chemical sensitizers as described above, inhibitors and oxidizing agents, there are preferably employed compounds and techniques described in JP-A No. 2001-318443; Japanese patent Application No. 2003-29472; JP-A Nos. 2004-37554, 2004-4144, 2004-4446, 2004-4452, 2004-4456, 2004-4458, 2004-4656, 2004-4672, 2003-307803, 2003-287841, 2003-287842, 2003-233146, 2003-172990, 2003-172991, 2003-113193, 2003-113194, 2003-114489, 2002-372765, 2002-296721, 2002-278011, 2002-268169, 2002-244241, 2002-250982, 2002-258427, 2002-268168, 2002-268170, 2000-193942, 2001-75214, 2001-75215, 2001-75216, 2001-75217, 2001-75218, 2001-100352, 2004-70363, 2004-67695, 2002-131858, and 2001-166412; European patent No. 109460 and 138852; U.S. Pat. Nos. 6,686,143 and 6,322,961.

The addition amount of a chalcogen sensitizer or a gold sensitizer, depending on the kind of a silver halide grain emulsion, the kind of a used compound and ripening conditions, is preferably 1×10⁻⁹ to 1×10⁻⁵ mol per mol of silver halide, and more preferably 1×10⁻⁸ to 1×10⁻⁵ mol. Various sensitizes described above may be added in accordance with properties of a sensitizer, for example, by solution in water or organic solvents such as methanol, by a mixture with a gelatin solution or by a method described in JP-A No. 4-140739, i.e., addition in the form of emulsified dispersion of a solution mixed with a polymer soluble in an organic solvent.

Reduction sensitizers may be further used and reducing compounds described in RD vol. 307, 307105 and JP-A No. 7-78685 are usable.

The silver halide emulsion contains one or more kinds of sensitizing dyes, singly or in combination thereof. Spectral sensitizing dyes for used in spectral sensitization for the blue-sensitive, green-sensitive and red-sensitive regions include, for example, those described in F. M. Harmer, Heterocyclic Compounds, Cyanine dyes and related compounds (John Wiley & Sons, New York, London, 1964).

There can be employed a variety of compounds known in the art, as spectral-sensitizing dyes. Compounds BS-1 to 8 described in JP-A 3-251840 at page 28 are preferably employed as a blue-sensitive sensitizing dye. Compounds GS-1 to 5 described in JP-A 3-251840 at page 28 are preferably employed as a green-sensitive sensitizing dye. Compounds RS-1 to 8 described in JP-A 3-251840 at page 29 are preferably employed as a red-sensitive sensitizing dye. In cases where exposed to infrared ray with a semiconductor laser, infrared-sensitive sensitizing dyes are employed. Compounds IRS-1 to 11 described in JP-A 4-285950 at pages 6-8 are preferably employed as a blue-sensitive sensitizing dye.

Supersensitizers SS-1 to SS-9 described in JP-A 4-285950 at pages 8-9 and compounds S-1 to S-17 described in JP-A 5-66515 at pages 5-17 are preferably included, in combination with these blue-sensitive, green-sensitive and red-sensitive sensitizing dyes. The sensitizing dye is added at any time during the course of silver halide grain formation to completion of chemical sensitization. The addition amount of a sensitizing dye is variable over a broad range and preferably from 0.5×10⁻⁶ to 1.0×10⁻² mol per mol of silver halide, and more preferably from 1.0×10⁻⁶ to 5.0×10⁻³ mol.

Sensitizing dyes are added to a silver halide emulsion in accordance with methods known I the art. For example, sensitizing dyes may be dispersed directly in the emulsion, or may be dissolved in water-soluble solvents such as pyridine, methyl alcohol, ethyl alcohol, methyl cellosolve, acetone, fluorinated alcohol, dimethylformamide or their mixture, or diluted with or dissolved in water, and the obtained solution is added to the emulsion. Ultrasonic vibration may be employed in the course of solution.

There are also employed a method in which a dye is dissolved in a volatile organic solvent and the obtained solution is dispersed in a hydrophilic colloid and the dispersion is added to the emulsion, as described in U.S. Pat. No. 3,469,987; and a method in which a water-insoluble dye is dispersed in a water-soluble solvent without being dissolved and the obtained dispersion is added to the emulsion, as described in JP-B No. 46-24185.

Dyes may be added to the emulsion in the form of a dispersion prepared by an acid-solution dispersion method. Addition to the emulsion can also achieved by methods described in U.S. Pat. Nos. 2,912,345, 3,342,605, 2,996,287 and 3,425,835.

Sensitizing dyes are added through solution in water-miscible organic solvents such as methanol, ethanol, fluorinated alcohol, acetone and dimethylformamide or water, or in the form of solid particle dispersion. Thus, a dye may be added at any time, for example, before or during formation of silver halide grains, at the time from completion of silver halide grain formation to the start of chemical sensitization, during chemical sensitization, or at the time of completion of chemical sensitization to coating. The dye may be separately added plural times.

A antifoggant or a stabilizer known in the art are incorporated into the photographic material, for the purpose of preventing fog produced during the process of preparing the photographic material, reducing variation of photographic performance during storage or preventing fog produced in development. Examples of preferred compounds for the purpose include compounds represented by formula (II) described in JP-A 2-146036 at page 7, lower column. Specific examples thereof include compounds (Iia-1) to (IIa-8) and (IIb-1) to (IIb-7) described therein (page 8), 1-(3-methoxyphenyl)-5-mercaptotetrazole and 1-(4-ethoxyphenyl)-5-mercaptotetrazole; compounds of formula (S), thiosulfonic acid compounds, disulfide compounds and polysulfide compounds described in JP-A No. 8-6201; compounds described in Japanese Patent Application Nos. 2003-29472, 2003-10482 and 2002-312557.

These compounds are added in the step of preparing a silver halide emulsion, the chemical sensitization step or during the course of from completion of chemical sensitization to preparation of a coating solution. In cases when chemical sensitization is undergone in the presence of these compounds, the amount thereof is preferably 1×10⁻⁸ to 1×10⁻¹ mole per mole of silver halide. Methods of adding additives to photographic emulsion of coating solution, as known in the art are applicable to addition of these compounds. Specifically, water-soluble compounds are added through solution in water or water-insoluble or hardly water-soluble compounds are dissolved in a water-miscible organic solvent, for example, solvents not adversely affecting photographic characteristics, such as alcohols, glycols, ketones, esters and amides, and the formed solution is added.

There are employed dyes having absorption at various wavelengths for anti-irradiation and anti-halation in the photographic material relating to the invention. A variety of dyes known in the art can be employed, including dyes having absorption in the visible range described in JP-A 3-251840 at page 30, AI-1 to 11, and JP-A No. 6-3770; infra-red absorbing dyes described in JP-A No. 1-280750 at page 2, left lower column, formula (I), (II) and (III). These dyes do not adversely affect photographic characteristics of a silver halide emulsion and there is no stain due to residual dyes. For the purpose of improving sharpness, the dye is preferably added in an amount that gives a reflection density at 680 nm of 0.7 to 3.0 and more preferably 0.8 to 3.0.

Fluorescent brightening agents are also incorporated into the photographic material to improve whiteness. Examples of preferred compounds include those represented by formula II described in JP-A No. 2-232652.

In cases when a silver halide photographic light sensitive material according to the invention is employed as a color photographic material, the photographic material comprises layer(s) containing silver halide emulsion(s) which are spectrally sensitized in the wavelength region of 400 to 900 nm, in combination with a yellow coupler, a magenta coupler and a cyan coupler. The silver halide emulsion contains one or more kinds of sensitizing dyes, singly or in combination thereof.

In the silver halide emulsions can be employed a variety of spectral-sensitizing dyes known in the art. Compounds BS-1 to 8 described in JP-A 3-251840 at page 28 are preferably employed as a blue-sensitive sensitizing dye. Compounds GS-1 to 5 described in JP-A 3-251840 at page 28 are preferably employed as a green-sensitive sensitizing dye. Compounds RS-1 to 8 described in JP-A 3-251840 at page 29 are preferably employed as a red-sensitive sensitizing dye. In cases where exposed to infrared ray with a semiconductor laser, infrared-sensitive sensitizing dyes are employed. Compounds IRS-1 to 11 described in JP-A 4-285950 at pages 6-8 are preferably employed as a blue-sensitive sensitizing dye. Supersensitizers SS-1 to SS-9 described in JP-A 4-285950 at pages 8-9 and compounds S-1 to S-17 described in JP-A 5-66515 at pages 5-17 are preferably included, in combination with these blue-sensitive, green-sensitive and red-sensitive sensitizing dyes.

The sensitizing dye is added at any time during the course of silver halide grain formation to completion of chemical sensitization. The sensitizing dye is incorporated through solution in water-miscible organic solvents such as methanol, ethanol, fluorinated alcohol, acetone and dimethylformamide or water, or in the form of solid particle dispersion.

As couplers used in silver halide photographic materials relating to the invention is usable any compound capable of forming a coupling product exhibiting an absorption maximum at the wavelength of 340 nm or longer, upon coupling with an oxidation product of a developing agent. Representative examples thereof include yellow dye forming couplers exhibiting an absorption maximum at the wavelength of 350 to 500 nm, magenta dye forming couplers exhibiting an absorption maximum at the wavelength of 500 to 600 nm and cyan dye forming couplers exhibiting an absorption maximum at the wavelength of 600 to 750 nm.

Examples of preferred cyan couplers include those which are represented by general formulas (C-I) and (C-II) described in JP-A 4-114154 at page 5, left lower column. Exemplary compounds described therein (page 5, right lower column to page 6, left lower column) are CC-1 to CC-9.

Examples of preferred magenta couplers include those which are represented by general formulas (M-I) and (M-II) described in JP-A No. 4-114154 at page 4, right upper column. Exemplary compounds described therein (page 4, left lower column to page 5, right upper column) are MC-1 to MC-11. Of these magenta couplers are preferred couplers represented by formula (M-I) described in ibid, page 4, right upper column; and couplers in which R_{M} in formula (M-I) is a tertiary alkyl group are specifically preferred. Further, couplers MC-8 to MC-11 are superior in color reproduction of blue to violet and red, and in representation of details.

Examples of preferred yellow couplers include those which are represented by general formula (Y-I) described in JP-A No. 4-114154 at page 3, right upper column. Exemplary compounds described therein (page 3, left lower column) are YC-1 to YC-9. Of these yellow couplers are preferred couplers in which RY1 in formula (Y-I) is an alkoxy group, are specifically preferred or couplers represented by formula [I] described in JP-A No. 6-673.88. Specifically preferred examples thereof include YC-8 and YC-9 described in JP-A No. 4-114154 at page 4, left lower column and Nos. (1) to (47) described in JP-A No. 6-67388 at pages 13-14. Still more preferred examples include compounds represented by formula [Y-1] described in JP-A No. 4-81847 at page 1 and pages 11-17.

When an oil-in-water type-emulsifying dispersion method is employed for adding couplers and other organic compounds used for the photographic material of the present invention, in a water-insoluble high boiling organic solvent, whose boiling point is 150° C. or more, a low boiling and/or a water-soluble organic solvent are combined if necessary and dissolved. In a hydrophilic binder such as an aqueous gelatin solution, the above-mentioned solutions are emulsified and dispersed by the use of a surfactant. As a dispersing means, a stirrer, a homogenizer, a colloidal mill, a flow jet mixer and a supersonic dispersing machine may be used. Preferred examples of the high boiling solvents include phthalic acid esters such as dioctyl phthalate, diisodecyl phthalate, and dibutyl phthalate; and phosphoric acid esters such as tricresyl phosphate and trioctyl phosphate. High boiling solvents having a dielectric constant of 3.5 to 7.0 are also preferred. These high boiling solvents may be used in combination. Instead of or in combination with the high boiling solvent is employed a water-insoluble and organic solvent-soluble polymeric compound, which is optionally dissolved in a low boiling and/or water-soluble organic solvent and dispersed in a hydrophilic binder such as aqueous gelatin using a surfactant and various dispersing means. In this case, examples of the water-insoluble and organic solvent-soluble polymeric compound include poly(N-t-butylacrylamide).

As a surfactant used for adjusting surface tension when dispersing or coating photographic additives, the preferable compounds are those containing a hydrophobic group having 8 through 30 carbon atoms and a sulfonic acid group or its salts in a molecule. Exemplary examples thereof include A-1 through A-11 described in JP-A No. 64-26854. In addition, surfactants, in which a fluorine atom is substituted to an alkyl group, are also preferably used. The dispersion is conventionally added to a coating solution containing a silver halide emulsion. The elapsed time from dispersion until addition to the coating solution and the time from addition to the coating solution until coating are preferably short. They are respectively preferably within 10 hours, more preferably within 3 hours and still more preferably within 20 minutes.

To each of the above-mentioned couplers, to prevent color fading of the formed dye image due to light, heat and humidity, an anti-fading agent may be added singly or in combination. The preferable compounds or a magenta dye are phenyl ether type compounds represented by Formulas I and II in JP-A No. 2-66541, phenol type compounds represented by Formula IIIB described in JP-A No. 3-174150, amine type compounds represented by Formula A described in JP-A No. 64-90445 and metallic complexes represented by Formulas XII, XIII, XIV and XV described in JP-A No. 62-182741. The preferable compounds to form a yellow dye and a cyan dye are compounds represented by Formula I described in JP-A No. 1-196049 and compounds represented by Formula II described in JP-A No. 5-11417.

A compound (d-11) described in JP-A No. 4-114154 at page 9, left lower column and a compound (A′-1) described in the same at page 10, left lower column are also employed for allowing the absorption wavelengths of a dye to shift. Besides can also be employed a compound capable of releasing a fluorescent dye described in U.S. Pat. No. 4,774,187.

It is preferable that a compound reacting with the oxidation product of a color developing agent be incorporated into a layer located between light-sensitive layers for preventing color staining and that the compound is added to the silver halide emulsion layer to decrease fogging. As a compound for such purposes, hydroquinone derivatives are preferable, and dialkylhydroquinone such as 2,5-di-t-octyl hydroquinone are more preferable. The specifically preferred compound is a compound represented by Formula II described in JP-A No. 4-133056, and compounds II-1 through II-14 described in the above-mentioned specification pp. 13 through 14 and compound 1 described on page 17.

In the photographic material according to the present invention, it is preferable that static fogging is prevented and light-durability of the dye image is improved by adding a UV absorber. The preferable UV absorbents are benzotriazoles. The specifically preferable compounds are those represented by Formula III-3 in JP-A No. 1-250944, those represented by Formula III described in JP-A No. 64-66646, UV-1L through UV-27L described in JP-A No. 63-187240, those represented by Formula I described in JP-A No. 4-1633 and those represented by Formulas (I) and (II) described in JP-A No. 5-165144.

In the photographic materials used in the invention is advantageously employed gelatin as a binder. Furthermore, there can be optionally employed other hydrophilic colloidal materials, such as gelatin derivatives, graft polymers of gelatin with other polymers, proteins other than gelatin, saccharide derivatives, cellulose derivatives and synthetic hydrophilic polymeric materials.

The total coating weight of gelatin of the constituent layers of the photographic material is preferably from 3 to 6 g/m², and more preferably from 3 to 5 g/m². The thickness of the overall constituent layers is preferably from 3 to 7.5 μm, and more preferably from 3 to 6.5 μm to satisfy progression of development, bleach-fixability and dye residue even when subjected to rapid processing. The dry layer thickness can be determined from the difference in thickness between before and after peeling a dry layer or by observation of the section using an optical microscope or an electron microscope. To achieve enhancements of progression of development and drying rate, the swollen layer thickness is preferably from 8 to 19 μm, and more preferably from 9 to 18 μm. The swollen layer thickness can be determined in such a manner that a dry photographic material is dipped into aqueous solution of 35° C. and after swelling equilibrium is reached, measurement is conducted by an intermittent method.

A vinylsulfone type hardening agent or a chlorotriazine type hardening agent is employed as a hardener of the binder, and compounds described in JP-A No. 61-249054 and 61-245153 are preferably employed. An antiseptic or antimold described in JP-A No. 3-157646 is preferably incorporated into a hydrophilic colloid layer to prevent the propagation of bacteria and mold which adversely affect photographic performance and storage stability of images. Lubricants or matting agents, as described in JP-A No. 6-118543 and 2-73250 are also preferably incorporated to improve surface-physical properties of raw or processed photographic materials.

A variety of supports are employed in the photographic material used in this invention, including paper coated with polyethylene or polyethylene terephthalate, paper support made from natural pulp or synthetic pulp, polyvinyl chloride sheet, polypropylene or polyethylene terephthalate supports which may contain a white pigment, and baryta paper. Of these supports a paper support coated, on both sides, with water-proof resin layer. As the water-proof resin are preferably employed polyethylene, ethylene terephthalate and a copolymer thereof.

Inorganic and/or organic white pigments are employed, and inorganic white pigments are preferably employed. Examples thereof include alkaline earth metal sulfates such as barium sulfate, alkaline earth metal carbonates such as calcium carbonate, silica such as fine powdery silicate and synthetic silicate, calcium silicate, alumina, alumina hydrate, titanium oxide, zinc oxide, talc, and clay. Preferred examples of white pigments include barium sulfate and titanium oxide. The amount of the white pigment to be added to the water-proof resin layer on the support surface is preferably not less than 13% by weight, and more preferably not less than 15% by weight to improve sharpness. The dispersion degree of a white pigment in the water-proof resin layer of paper support can be measured in accordance with the procedure described in JP-a 2-28640. In this case, the dispersion degree, which is represented by a coefficient of variation, is preferably not more than 0.20, and more preferably not more than 0.15.

Supports having a center face roughness (SRa) of 0.15 nm or less (preferably, 0.12 nm or less) are preferably employed in terms of glossiness. Trace amounts of a blueing agent or reddening agent such as ultramarine or oil-soluble dyes are incorporated in a water-proof resin layer containing a white pigment or hydrophilic layer(s) of a reflection support to adjust the balance of spectral reflection density in a white portion of processed materials and improve its whiteness.

The surface of the support may be optionally subjected to corona discharge, UV light exposure or flame treatment and further thereon, directly or through a sublayer (i.e., one or more sublayer for making improvements in surface properties of the support, such as adhesion property, antistatic property, dimensional stability, friction resistance, hardness, anti halation and/or other characteristics), are coated component layers of the photographic material relating to the invention. In coating of the photographic material, a thickening agent may be employed to enhance coatability of a coating solution. As a coating method are useful extrusion coating and curtain coating, in which two or more layers are simultaneously coated.

To form a photographic image using a photographic material of the invention, an image recorded on a negative film may be printed onto the photographic material through optical imaging. Alternatively, after converting an image to digital information, the image is formed on a CRT (cathode ray tube) and the formed image may be printed on the photographic material through optical imaging. Printing may be conducted by performing scanning, while varying the intensity of a laser light based on the image information.

It is preferred to apply the invention to a photographic material occluding no developing agent, specifically to apply a photographic material forming appreciative images. Examples thereof include color print paper, color reversal paper, positive image-forming photographic material, photographic materials used for displays and photographic materials used for color proofing. Application to a photographic material having a reflection support is specifically preferred.

A silver halide color photographic material is processed according to the following processing steps. Thus, the exposed photographic material is developed in a color development step (color developer solution), and then further processed via a bleaching step (bleaching solution) and fixing step, or a bleach-fixing step (bleach-fixer solution), and a stabilizing step (stabilizer solution) and dried. The photographic material can be continuously processed, while replenishing a color developer replenishing solution, a fixer replenishing solution, a bleach replenishing solution (or a bleach-fixer replenishing solution) and a stabilizer replenishing solution. There will be described below a color developer solution, a bleach solution, a bleach-fixer solution, a fixer solution, a stabilizer solution and a rinse solution.

Color developing agents usable in the invention are preferably a primary amine developing agents, and more preferably p-phenylenediamine derivatives. Representative examples thereof are shown below but are not limited to these examples:
1) N,N-diethyl-p-phenylendiamine,
2) 4-amino-3-methyl-N,N-diethylaniline,
3) 4-amino-N-(β-hydroxyethyl)-N-methylaniline,
4) 4-amino-N-ethyl-N-(β-hydroxyethyl)-aniline,
5) 4-amino-3-methyl-N-ethyl-N-(β-hydroxyethyl) aniline,
6) 4-amino-3-methyl-N-ethyl-N-(3-hydroxypropyl)aniline,
7) 4-amino-3-methyl-N-ethyl-N-(4-hydroxybutyl)aniline,
8) 4-amino-3-methyl-N-ethyl-N-(β-methanesulfoneamido-ethyl)aniline,
9) 4-amino-N,N-diethyl-3-(β-hydroxyethyl)aniline
10) 4-amino-3-methyl-N-ethyl-N-(β-methoxyethyl)aniline,
11) 4-amino-3-methyl-N-ethyl-N-(β-ethoxyethyl)-N-ethylaniline,
12) 4-amino-3-methyl-N-(3-carbamoylpropyl)-N-n-propylaniline
13) 4-amino-N-(4-carbamoylbutyl)-N-n-propyl-3-methylaniline
14) N-(4-amino-3-methylphenyl)-3-hydroxypyrrolidine
15) N-(4-amino-3-methylphenyl)-3-(hydroxymethyl)pyrrolidine
16) N-(4-amino-3-methylphenyl)-3-pyrrolidinecarboxamide.

Of the foregoing p-phenylenediamine derivatives, compounds 5), 6), 7), 8) and 12) are preferred and specifically, compounds 5) and 8) are more preferred. These p-phenylenediamine derivatives may be in the form of a salt such as a sulfate, hydrochloride, sulfite, naphthalenedisulfonate o p-toluenesulfonate or in the form of a free base (also called a free body). The aromatic primary amine developing agent described above is used preferably in an amount of from 2 to 200 mmol per liter of a working developer solution, more preferably from 6 to 100 mmol, and still more preferably from 10 to 40 mmol.

To reduce of disappearance of a developing agent due to oxidation, preservatives are employed in a developer solution. Representative preservatives are hydroxylamine derivatives. Examples of hydroxylamine derivatives include hydroxylamine salts such as hydroxylamine hydrochloride and hydroxylamine derivatives, as described in JP-A Nos. 1-97953, 1-186939, 1-186940 and 1-187557. Specifically, a hydroxylamine derivative represented by the following formula (A) is preferred: 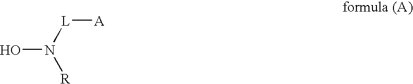
wherein L is an alkylene group which may be substituted; A is a carboxyl group, a sulfo group, a phosphono group, a phosphine group, a hydroxyl group, an amino group which may be substituted by an alkyl group, an ammonio group which may be substituted by an alkyl group, a carbamoyl group which may be substituted by an alkyl group, a sulfamoyl group which may be substituted by an alkyl group, an alkylsulfonyl group, a hydrogen atom, an alkoxyl group, or —O—(B—O)ₙ—R′; R and R′ are each a hydrogen atom or an alkyl group which may be substituted; B is an alkylene group which may be substituted; n is an integer of 1 to 4.

In the formula (A), L is preferably a straight or branched alkylene group having 1 to 10 carbon atoms, which may be substituted by a substituent, and more preferably an alkylene group having 1 to 5 carbon atoms. Specific examples of a preferred alkylene group include methylene, ethylene, trimethylene and propylene groups. Examples of a preferred substituent include a carboxyl group, a sulfo group, a phosphono group, a phosphine group, a hydroxyl group and an ammonio group which may be substituted by an alkyl group, and a carboxyl group, a sulfo group, a phosphine group and a hydroxyl group are preferred. A is a carboxyl group, a sulfo group, a phosphono group, a phosphine group, a hydroxyl group, or an amino, ammonio or carbamoyl or sulfamoyl group, each of which may be substituted by an alkyl group; of these, a carboxy group, a sulfo group, a hydroxyl group, a phosphono group and a carbamoyl group which may be substituted by an alkyl group are preferred examples. Preferred examples of -L-A include carboxy methyl, carboxymethyl, carboxypropyl, sulfoethyl, sulfopropyl, sulfobutyl, phosphonomethyl, phosphonoethyl and hydroxyethyl; and carboxy methyl, carboxymethyl, sulfoethyl, sulfopropyl, phosphonomethyl and phosphonoethyl are specifically preferred. R is preferably a hydrogen atom or a straight or branched alkyl group having 1 to 10 carbon atoms (more preferably 1 to 5 carbon atoms), which may be substituted by a substituent. Examples of such a substituent include a carboxyl group, a sulfo group, a phosphono group, a phosphine group, a hydroxy group, an amino, ammonio, carbamoyl or sulfamoyl group, each of which may be substituted by an alkyl group, an alkoxyl group and —O— (B—O)ₙ—R′. The foregoing B and R′ are the same as defined in the foregoing A. The substituent may be one or more. Preferred examples of R include hydrogen atom, carboxy methyl, carboxymethyl, carboxypropyl, sulfoethyl, sulfopropyl, sulfobutyl, phosphonomethyl, phosphonoethyl, and hydroxyethyl; and of these, hydrogen atom, carboxy methyl, carboxymethyl, sulfoethyl, sulfopropyl, phosphonomethyl and phosphonoethyl are specifically preferred. L and R may combine with each other to form a ring.

Specific examples of a compound of formula (A) are shown below but are not limited to these.

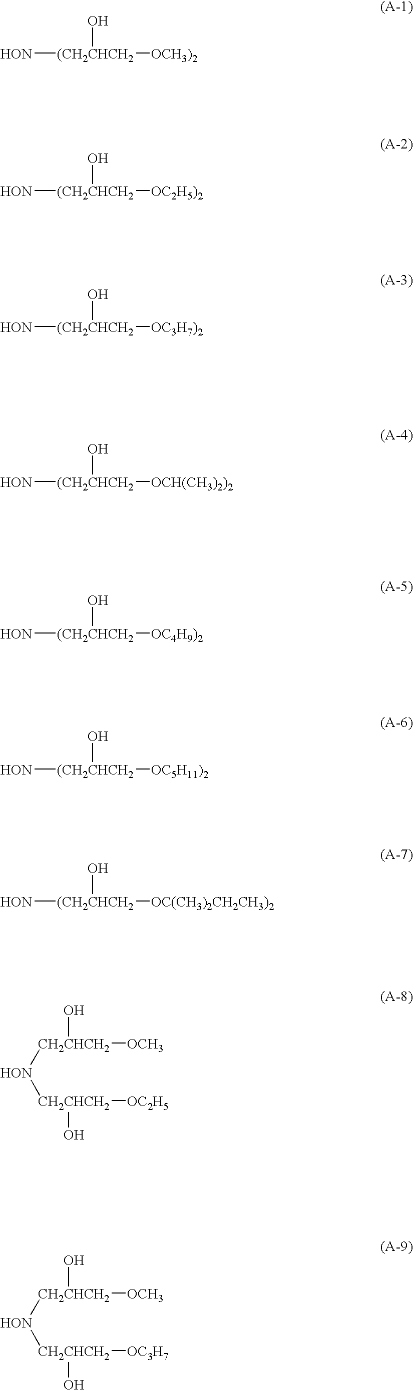

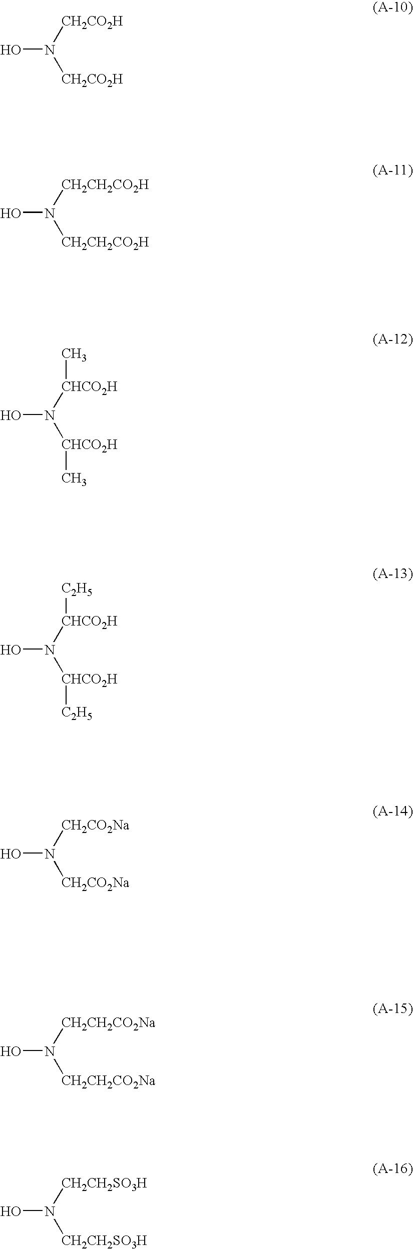

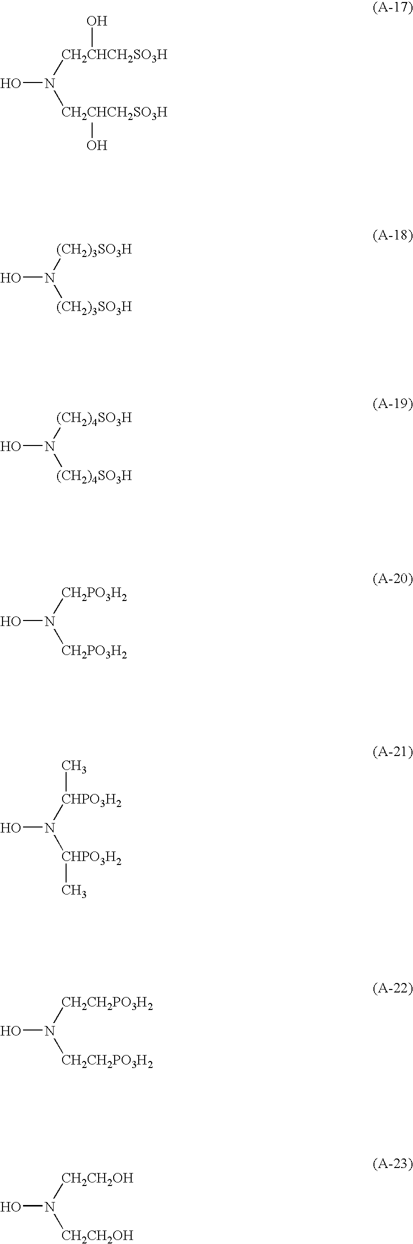

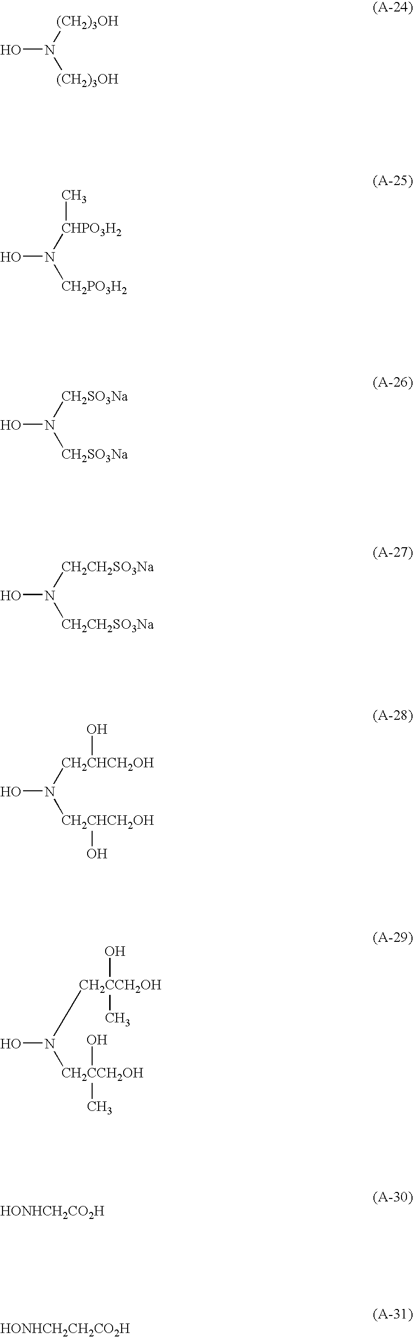

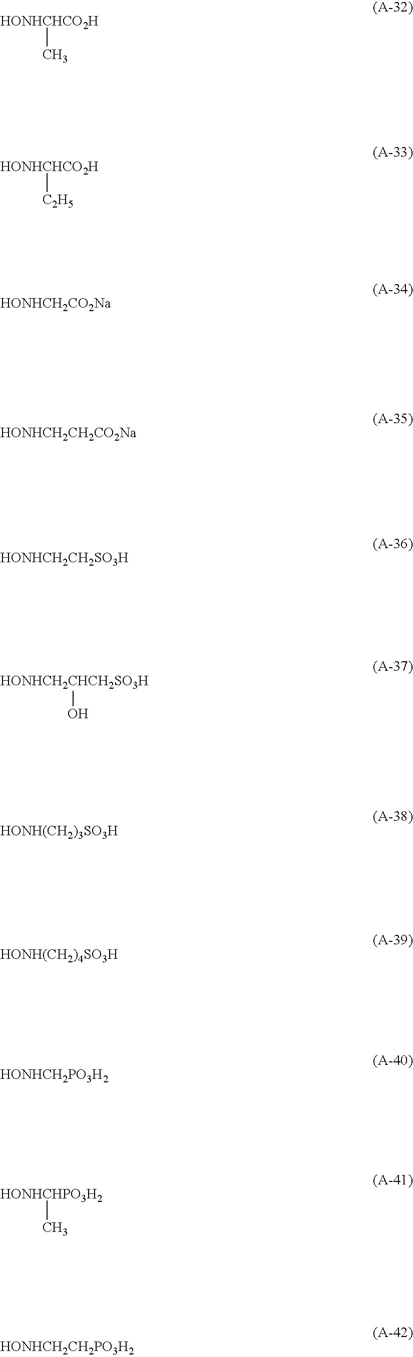

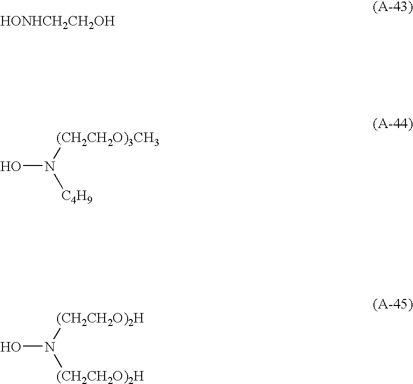

Sulfites are also preferably used as a preservative, and its concentration is preferably from 0.005 to 1.0 mol/l for a color developer solution used for color negative and from 0 to 0.1 mol/l for color developer solution used for color paper. Examples of a sulfite usable in embodiments of the invention include sodium sulfite, potassium sulfite and ammonium sulfite.

In addition to the foregoing preservatives, the other preservatives are usable, for example, hydroxamic acids, hydrazides, phenols, α-hydroxyketones, α-aminoketones, saccharides, monoamines, diamines, polyamines, quaternary ammonium salts, nitroxy radicals, alcohols, oximes, diamide compounds and condensed cyclic amines. These compounds are described in JP-A Nos. 63-4235, 63-30845, 63-21647, 63-44655, 63-53551, 63-43140, 63-56654, 63-58346, 63-43138, 63-146041, 63-44657, 63-44656; U.S. Pat. Nos. 3,615,503, 2,494,903; JP-A No. 52-143020; JP-B No. 48-30496 (hereinafter, the term, JP-B refers to Japanese Patent Publication).

Further, there may optionally be contained various kinds of metals described in JP-A Nos. 57-44148 and 57-53749, salicylic acids described in JP-A No. 59-180588, alkanolamines such triethanolamine and triisopropanolamine described in JP-A No. 54-3532, and aromatic polyhydroxy-compounds described in U.S. Pat. No. 3,746,544.

The pH of a color developer solution is preferably from 9.0 to 13.5, and more preferably from 9.5 to 12.0. An alkaline agents, buffers and optionally acids may be contained to maintain the pH value.

In the preparation of a color developer solution, the following buffering agents are used. Thus, examples of buffering agents usable in the invention include a carbonate, phosphate, borate, tetraborate, hydroxybenzoate, glycyl salt, N,N-dimetylglycine salt, leucine salt, norleucine salt, guanine slt, 3,4-dihydroxyphenylalanine salt, alanine salt, aminobutyric acid, 2-amino-2-methyl-1,3-propanediol salt, valine salt, proline salt, trishydroxyaminomethane salt, and lycine salt. Of the foregoing, a carbonate, phosphate, tetraborate, and hydroxybenzoate, which are superior as a buffer in the high pH region of 10.0 or more, are preferred in terms of no adverse effect on photographic performance (e.g., fogging) and low price.

Specific compounds as a buffering agent include, for example, sodium carbonate, potassium carbonate, sodium bicarbonate, potassium bicarbonate, trisodium phosphate, tripotassium phosphate, disodium phosphate, dipotassium phosphate, sodium borate, potassium borate, sodium tetraborate (borax), potassium tetraboarate, sodium o-hydroxybenzoate (sodium salicylate), potassium o-hydroxybenzoate, sodium 5-sulfo-2-hydroxybenzoate (sodium 5-sulfosalicylate), and potassium 5-sulfo-2-hydroxybenzoate (sodium 5-sulfosalicylate), but are not limited to the foregoing compounds. A buffering agent is contained preferably in an amount of from 0.01 to 2 mol per liter of a color developer solution, more preferably from 0.1 to 0.5 mol.

The color developer solution used in the invention may contain other ingredients, such as various kinds of chelating agents, which are usable for preventing precipitation of calcium or magnesium or enhancing stability of color developer solution. Examples of chelating agents include nitrilotriacetic acid, diethylenetriaminepentaacetic acid, ethylenediaminetetraacetic acid, N,N,N-trimethylenephosphonic acid, ethylenediamine-N,N,N′,N′-tetramethylenesulfonic acid, trans-siloxanediaminetetraacetic acid, 1,2-diaminopropanetetraacetic acid, glycol-ether-diaminetetraacetic acid, ethylenediamine-o-hydroxyphenylacetic acid, ethylenediamine-disuccinic acid (SS isomer), N-(2-carboxylateethyl)-L-asparagic acid, β-alaninediacetic acid, 2-phosphonobutane-1,2,4-tricarboxylic acid, 1-hydroxyethylidene-1,1-diphosphonic acid, 1-hydroxyethylidene-1,1-diphosphonic acid, N,N′-bis(2-hydroxybenzyl)ethylenediamine-N,N′-diacetic acid, and 1,2-dihydroxybenzene-4,6-disulfonic acid. These chelating agents may optionally be used in their combination. A chelating agent is used in an amount sufficient for sequestering metal ions contained in color developer solution, for example, 0.1 to 10 g per liter.

The developer solution used in the invention may contain a development accelerator. Examples of a development accelerator usable in the invention include thioether compounds described in JP-B Nos. 37-16088, 37-5987, 38-7826, 44-12380 and 45-9019, and U.S. Pat. No. 3,813,247; p-phenylenediamine type compounds described in JP-A No. 52-49829 and 50-15554; quaternary ammonium compounds described in JP-A No. 50-137726, JP-B No. 44-30074 and JP-A Nos. 56-156826 and 52-43429; amine compounds described in U.S. Pat. Nos. 2,494,903, 3,128,182, 4,230,796 and 3,253,919, JP-B No. 41-11431, and U.S. Pat. Nos. 2,482,546, 2,596,926 and 3,582,346; polyalkyleneoxide compounds described in JP-B Nos. 37-16088 and 42-25201, U.S. Pat. No. 3,128,183, JP-B Nos. 41-11431 and 42-23883, and U.S. Pat. No. 3,532,501; 1-phenyl-3-pyrazolidones and imidazoles. These compounds are contained preferably in an amount of from 0.001 to 0.2 mol per liter of color developer solution, and more preferably from 0.01 to 0.05 mol.

In addition to halide ions, any fog inhibitor may be added to the color developer solution. Examples of an organic fog inhibitor include nitrogen-containing heterocyclic compounds such as benzotriazole, 6-nitrobenzimidazole, 5-nitroisoindazole, 5-methylbenzotriazole, 5-nitrobenzotriazole, 2-thiazolyl-benzimidazole, 2-thiazolylmethyl-benzimidazole, indazole, hydroxyazaindolidine, and adenine.

The color developer solution may optionally contain a fluorescent brightener. Bis(triazinylamino)stilbenesulfonic acid compounds are preferred as a brightener. Commonly known or commercially available diaminostilbene type compounds are usable as a bis(triazinylamino)stilbenesulfonic acid compound. Commonly known bis(triazinylamino)stilbenesulfonic acid compounds, for example, compounds described in JP-A Nos. 6-329936, 7-140625 and 10-140849 are preferred. Commercially available compounds are described, for example, in “Senshoku Note” 9th edition (published by Shisen-sha) page 165-168, in which Blankophor BSU liq. and Hakkol BRK are preferred. Other examples of bis(triazinylamino)stilbenesulfonic acid compound include compounds I-1 to I-48 described in paragraph Nos. [0038] to [0049] of JP-A No. 2001-281823 and compounds II-1 to II-16 described in paragraph Nos. [0050] to [0052] of JP-A No. 2001-281823. The foregoing brighteners are contained preferably in an amount of from 0.1 mmol to 0.1 mol per liter of color developer solution.

A color developer solution for use in color paper preferably contains bromide ions at not more than 1.0×10⁻³ mol/l. The color developer solution for use in color paper preferably contains chloride ions at 3.5×10⁻³ to 1.5×10⁻¹ mol/l but since chloride ions are released to a developer solution as a bi-product of development, a replenisher solution may often contain no chloride ion.

The color developing temperature is preferably from 30° to 55° C., more preferably from 35° to 55° C., and still more preferably from 38° to 45° C. when used for color paper as a silver halide color photographic material. The color development time is preferably from 5 to 0.90 sec. and more preferably from 15 to 60 sec. The low replenishing rate is preferable, and is preferably from 15 to 600 ml per m² of photographic material, more preferably from 15 to 120 ml, and still more preferably from 30 to 60 ml. The color development time refers to the time from when a photographic material is placed into a color developer solution to when the photographic material is placed into the subsequent processing step (for example, bleach-fixing solution). When the photographic material is processed in an automatic processor, the color development time is the sum of the time during which the photographic material is dipped into a color developer solution (so-called solution time) and the time during which the photographic material leaves the color developer solution and is transported to the subsequent processing step (so-called cross-over time). The cross-over time is preferably not more than 10 sec. and more preferably not more than 5 sec.

Any bleaching agent is usable in a bleaching solution or bleach-fixing solution. Specifically, organic complex salts of iron (III), e.g., complex salts of aminopolycarboxylic acids such as ethylenediaminetetraacetic acid, diethylenetriaminepentaacetic acid, nitrilotriacetic acid, cyclohexanediaminetetraacetic acid and ethylenediaminedisuccinic acid, aminopolyphosphonic acids, phosphonocarboxylic acid and organic phosphonic acid; organic acids such as citric acid, tartaric acid and malic acid, persulfate salts and hydrogen peroxide are preferred. Of these, iron (III) complex salts of ethylenediaminetetraacetic acid, diethylenetriaminepentaacetic acid, cyclohexanediaminetetraacetic acid, 1,3-diaminopropanetetraacetic acid, ethylenediaminedisuccinic acid and methyliminodiacetic acid are preferred in terms of high bleaching power. These ferric ion complexes may be used in the form of a complex salt or a ferric ion complex may be formed in a solution by using a ferric salt such as ferric sulfate, ferric chloride, ferric nitrate, ferric sulfate ammonium or ferric phosphate, and a chelating agent such as an aminopolycarboxylic acid, an aminopolyphosphonic acid or phosphonocarboxylic acid. Of iron (III) complexes, an aminopolycarboxylic acid is preferred and its amount is preferably from 0.01 to 1.0 mol/l, and more preferably from 0.05 to 0.50 mol/l.

A bleaching solution or a bleach-fixing solution may contain various compounds as a bleach-accelerating agent. For example, compounds containing a mercapto group or a disulfide bond, as described in Research Disclosure 17129 (July, 1978), thiourea type compounds, and a halide such as iodide or bromide ion are preferred in terms of superior bleaching power.

A bleaching solution or a bleach-fixing solution may further contain a re-halogenating agent such as a bromide (e.g., potassium bromide), a chloride (e.g., potassium chloride) or a iodide (e.g., ammonium iodide). There may optionally be added at least one inorganic or organic acid or its alkali metal or ammonium salt which exhibits pH-buffering capability, such as borax, sodium metaborate, acetic acid, sodium acetate, sodium carbonate, potassium carbonate, citric acid, sodium citrate tartaric acid, succinic acid, maleic acid or glycolic acid; or a corrosion inhibitor such as ammonium nitrate or guanidine.

Fixing agents usable in a fixer solution or bleach-fixer solution include commonly known fixing agents, that is, water-soluble silver halide solvent for example, a thiosulfate such as sodium thiosulfate or ammonium thiosulfate, a thiocyanate such as sodium thiocyanate or ammonium thiocyanate, a thio-ether compound such as ethylenebisthioglycolic acid or 3,6-dithia-1,8-octanediol and thioureas, which are water-soluble silver halide solvents and can be used singly or in their combination. Of these, thiosulfates, specifically, ammonium thiosulfate is preferred. A fixing agent is used preferably in an amount of from 0.1 to 5.0 mol per liter of a fixer solution, and more preferably from 0.3 to 2.0 mol. The pH range of a bleach-fixer or fixer solution is preferably from 3 to 10, and more preferably from 5 to 9.

A bleaching solution, fixer solution or bleach-fixer solution may further contain various kinds of fluorescent brighteners, defoaming agents, surfactants, polyvinyl pyrrolidone or organic solvents such as methanol.

A bleaching solution, fixer solution or bleach-fixer solution usually contain a sulfite as a preservative such as sodium sulfite, potassium sulfite, ammonium sulfite, potassium hydrogensulfite, sodium hydrogensulfite, sodium metabisulfite, potassium metabisulfite or ammonium metabisulfite. Further, there may be added ascorbic acid, carbonyl bisulfite adduct or a carbonyl compound.

Furthermore, there may optionally be incorporated a buffering agent, a fluorescent brightener, a chelating agent, a defoaming agent or an antiseptic agent. The bleaching solution, fixer solution or bleach-fixer solution contains an ammonium cation preferably at a concentration of not more than 50 mol % in terms of workability and preferably at a concentration not less than 50 mol % in terms of processability.

The time for the bleach-fixing step applicable to silver halide color photographic materials relating to the invention is preferably not more than 90 sec., and more preferably not more than 45 sec. The time for the bleach-fixing step refers to the time of from the time when the photographic material is dipped into the first bath to the time when the photographic material comes out of the final bath in cases where this step is comprised of plural baths, and, in the case of a single bath, it is the time until when the photographic material is dipped into the following rinsing or stabilizing solution, in which a cross-over time is included. The cross-over time is preferably not more than 10 sec., and more preferably not more than 5 sec. The bleach-fixing temperature is preferably from 20° to 70° C., and more preferably from 25° to 50° C. The replenishing rate of the bleach-fixer solution is preferably not more than 200 ml/m², and more preferably from 20 to 100 ml/m².

The replenishing rate of a bleaching solution is preferably not more than 200 ml/m², and more preferably from 20 to 200 ml/m². The time for the bleaching step is preferably 15 sec. to 90 sec. in total. The time for the bleaching step refers to the time from when a photographic material is dipped into the first bath to when the photographic material comes out of the final bath in cases where the step is comprised of plural baths, and, in the case of a single bath, it is the time until when the photographic material is dipped into the following rinsing or stabilizing solution, in which a cross-over time is to be included. The cross-over time is preferably not more than 10 sec., and more preferably not more than 5 sec. The bleaching temperature is preferably from 25° to 50° C.

The time for the fixing step is preferably from 15 sec. to 90 sec. in total. The time for the fixing step refers to the time from when the photographic material is dipped into the first bath to when the photographic material comes out of the final bath in cases where the step is comprised of plural baths, and, in the case of a single bath, it is the time until when the photographic material is dipped into the following rinsing or stabilizing solution, in which a cross-over time is to be included. The cross-over time is preferably not more than 10 sec., and more preferably not more than 5 sec. The fixing temperature is preferably from 25° to 50° C.

Next, there will be described processing solution used in the rinsing or stabilizing step. A rinsing or stabilizing solution used in the invention contains constituents included in conventional stabilizing solutions, such as a chelating agent (e.g., ethylenediaminetetraacetic acid, diethylenetriaminepentaacetic acid, 1-hydroxyethylidene-1,1-diphosphonic acid), a buffer (e.g., potassium carbonate, borates, acetates, phosphates), a fungicide (e.g., Dearcide 702, produced by U.S. Dearborn Corp., p-chloro-m-cresol, benzoylisothiazoline-3-one), an antioxidant (e.g., ascorbic acid), and a water soluble metal salt (e.g., zinc salt, magnesium salt).

The rinsing or stabilizing solution may contain an arylsulfinic acid such as p-tolyenesulfinic acid or m-carboxybenzenesulfinic acid in terms of solution storage stability. It is preferred to contain a sulfite, a bisulfite or metabisulfite. Any organic or inorganic material capable of releasing a sulfite is usable but an inorganic salt is preferred. Preferred examples thereof include sodium sulfite, potassium sulfite, ammonium sulfite, ammonium bisulfite, potassium bisulfite, sodium bisulfite, sodium metabisulfite, potassium metabisulfite and ammonium metabisulfite. The foregoing salts are contained preferably in an amount of not less than 1×10⁻³ mol/l, and more preferably from 5×10³ mol/l 5×10² mol/l.

The pH of the stabilizing step is preferably from 4 to 10, and more preferably from 5 to 8. The stabilizing step may be set at any appropriate temperature, depending on the use or characteristics of silver halide color photographic material to be processed but is usually from 15° to 45° C., and preferably from 20° to 40° C. Any appropriate time for the stabilizing step may be set but a shorter time is desirable in terms of reduction of the processing time. The stabilizing time is preferably from 5 sec. to 1 min. 45 sec, and more preferably 10 sec. to 1 min. Specifically in the case of silver halide color photographic material being color print paper, the time needed for the stabilizing step is preferably from 8 to 26 sec. and in the case of negative film, it is preferably from 10 to 40 sec.

A low replenishing rate is more preferred in terms of lowered running cost, reduction of effluent and ease of handling. Specifically, the replenishing rate is preferably from 0.5 to 50 (more preferably from 3 to 40) times the carry-in amount from the preceding bath, per unit area of silver halide color photographic material. It is also preferably not more than 1 liter per m² of silver halide color photographic material, and more preferably not more than 500 ml. Replenishment may be carried out continuously or intermittently.

In the processing method relating to the invention, a stabilizing step using a stabilizing solution may be constituted of a single bath, or two or more baths and a cascaded countercurrent system which is constituted of at least two baths is preferred. The cascaded countercurrent system refers to a system in which, in the stabilizing bath divided into plural baths, stabilizing solution flows upstream of the transport direction of photographic material, while over-flowing into the respective divided baths along the transport route of the photographic material to perform stabilization.

As a processing apparatus used in the invention is applicable a roller transport type processor in which the photographic material is transported by being nipped by rollers and an endless belt type processor in which the photographic material is transported, while being fixed to a belt. Further thereto are also employed a method in which a processing solution supplied to a slit-formed processing bath and a photographic material is transported therethrough, a spraying method, a web processing method employing contact with a carrier impregnated with a processing solution and a method using viscous processing solution. A large amount of photographic materials is conventionally processed using an automatic processor. In such a case, a lower replenishing rate is preferred and an environmentally friendly processing embodiment is replenishment made in the form of a solid tablet, as described in KOKAI-GIHO (Disclosure of Techniques) 94-16935.

Photographic material used for print, relating to the invention exhibits markedly improved image quality when exposed through negative film having an area of 3 to 7 cm² per picture plane to form images. The negative film may be one having information recording ability.

### EXAMPLES

The present invention will be further described based on examples but are by no means limited to these examples.

### Example 1

### Preparation of Silver Halide Emulsion

Preparation of Silver Halide Emulsion (B-1)

To 1.5 liter of an aqueous 2% solution of deionized ossein gelatin (having a calcium content of 10 ppm), maintained at 40° C. were added solutions (A1) and (B1) for 15 min, while controlling the pAg and pH at 7.3 and 4.0, respectively with vigorously stirring using a stirring mixer described in JP-A No. 62-160128. Subsequently, solutions (A2) and (B2) were added for 80 min with controlling the pAg and pH at 8.0 and 5.5, respectively. Then, solutions (A3) and (B3) were added over 14 min. with controlling the pAg and pH at 8.0 and 5.5, respectively. The pAg was controlled in accordance with the method described in JP-A No. 59-45437 and the pH was controlled using aqueous sulfuric acid or sodium hydroxide solution.

Solution (A1)

| | | |
|---|---|---|
| Sodium chloride | 3.43 | g |
| Potassium bromide | 0.021 | g |
| Water to make | 200 | ml |

Solution (A2)

| | | |
|---|---|---|
| Sodium chloride | 72.0 | g |
| K₂[IrCl₆] | 2.8 × 10⁻⁸ | mol/mol AgX |
| K₂[IrBr₆] | 8.0 × 10⁻⁹ | mol/mol AgX |
| K₄[Fe(CN)₆] | 7.2 × 10⁻⁶ | mol/mol AgX |
| Potassium bromide | 0.44 | g |
| Water to make | 420 | ml |

Solution (A3)

| | | |
|---|---|---|
| Sodium chloride | 30.9 | g |
| Potassium bromide | 0.19 | g |
| Water to make | 180 | ml |

Solution (B1)

| | | |
|---|---|---|
| Silver nitrate | 10 | g |
| Water to make | 200 | ml |

Solution (B2)

| | | |
|---|---|---|
| Silver nitrate | 210 | g |
| Water to make | 420 | ml |

Solution (B3)

| | | |
|---|---|---|
| Silver nitrate | 90 | g |
| Water to make | 180 | ml |

After completing addition, an aqueous 15% solution containing 30 g of chemically modified gelatin (modification rate of 95%), in which an amino group of gelatin was phenylcarbamoylated, was added to perform desalting in accordance with the method described in JP-A No. 5-72658, and an aqueous gelatin solution was further added thereto to obtain silver halide emulsion (B-1) comprising monodisperse cubic grains having an average grain size of 0.58 μm.

Preparation of Silver Halide Emulsion (B-2)

Silver halide emulsion (B-2) was prepared similarly to the foregoing silver halide emulsion (B-1), provided that the following solution (D1) was further added at the time when 80% of the solution (B3) was added.

Solution (D1)

| | | |
|---|---|---|
| Potassium iodide | 0.06 | g |
| Water to make | 20 | ml |

Preparation of Silver Halide Emulsion (B-3)

Silver halide emulsion (B-3) was prepared similarly to the foregoing silver halide emulsion (B-1), provided that the following solution (D2) was further added at the time when 70% of the solution (B3) was added.

Solution (D2)

| | | |
|---|---|---|
| Potassium iodide | 0.12 | g |
| Water to make | 32 | ml |

Preparation of Silver Halide Emulsion (B-4)

Silver halide emulsion (B-4) was prepared similarly to the foregoing silver halide emulsion (B-1), provided that the following solution (D3) was further added at the time when 60% of the solution (B3) was added.

Solution (D3)

| | | |
|---|---|---|
| Potassium iodide | 0.30 | g |
| Water to make | 80 | ml |

Preparation of Silver Halide Emulsion (B-5)

Silver halide emulsion (B-5) was prepared similarly to the foregoing silver halide emulsion (B-4), provided that the solution (A2) was replaced by the following solution (A2a).

Solution (A2a)

| | | |
|---|---|---|
| Sodium chloride | 71.8 | g |
| K₂[IrCl₆] | 2.8 × 10⁻⁸ | mol/mol AgX |
| K₂[IrBr₆] | 8.0 × 10⁻⁹ | mol/mol AgX |
| K₄[Fe(CN)₆] | 7.2 × 10⁻⁶ | mol/mol AgX |
| Potassium bromide | 0.88 | g |
| Water to make | 420 | ml |

Preparation of Silver Halide Emulsion (B-6)

Silver halide emulsion (B-6) was prepared similarly to the foregoing silver halide emulsion (B-5), provided that the following solution (C1) was further added at the time when 30% of the solution (B3) was added.

Solution (C1)

| | | |
|---|---|---|
| Potassium bromide | 2.17 | g |
| Water to make | 182 | ml |

Preparation of Silver Halide Emulsion (B-7)

Silver halide emulsion (B-7) was prepared similarly to the foregoing silver halide emulsion (B-5), provided that the following solution (C2) was further added at the time when 30% of the solution (B3) was added.

Solution (C2)

| | | |
|---|---|---|
| Potassium bromide | 4.56 | g |
| Water to make | 380 | ml |

Preparation of Silver Halide Emulsion (B-8)

Silver halide emulsion (B-8) was prepared similarly to the foregoing silver halide emulsion (B-7), provided that the solution (A2a) was replaced by the following solution (A2b).

Solution (A2b)

| | | |
|---|---|---|
| Sodium chloride | 71.8 | g |
| K₂[IrCl₆] | 4.8 × 10⁻⁹ | mol/mol AgX |
| K₂[IrBr₆] | 3.6 × 10⁻⁹ | mol/mol AgX |
| K₂[IrCl₅(H₂O)] | 2.9 × 10⁻⁷ | mol/mol AgX |
| K₂[IrCl₅(thiazole)] | 1.6 × 10⁻⁸ | mol/mol AgX |
| K₄[Fe(CN)₆] | 8.0 × 10⁻⁶ | mol/mol AgX |
| Compound (S-2-5) | 2.0 × 10⁻⁵ | mol/mol AgX |
| Potassium bromide | 0.88 | g |
| Water to make | 420 | ml |

Preparation of Silver Halide Emulsion (BB-1)

Silver halide emulsion (BB-1) of an average grain size of 0.48 μm was prepared similarly to the foregoing silver halide emulsion (B-1), provided that the contents of K₂[IrCl₆], K₂[IrBr₆] and K₄[Fe(CN)₆] of solution (A2) were each increased by a factor of 1.8 and the addition times of solutions (A1), (A2), (A3), (B1), (B2) and (B3) were optimally varied.

Preparation of Silver Halide Emulsion (BB-2)

Silver halide emulsion (BB-2) was prepared similarly to the foregoing silver halide emulsion (BB-1), provided that the following solution (D4) was further added at the time when 70% of the solution (B3) was added.

Solution (D4)

| | | |
|---|---|---|
| Potassium iodide | 0.15 | g |
| Water to make | 40 | ml |

Preparation of Silver Halide Emulsion (BB-3)

Silver halide emulsion (BB-3) was prepared similarly to the foregoing silver halide emulsion (BB-1), provided that the following solution (D5) was further added at the time when 80% of the solution (B3) was added.

Solution (D5)

| | |
|---|---|
| Potassium iodide | 0.09 g |
| Water to make | 25 ml |

Preparation of Silver Halide Emulsion (BB-4)

Silver halide emulsion (BB-4) was prepared similarly to the foregoing silver halide emulsion (BB-1), provided that the following solution (C3) was further added at the time when 30% of the solution (B3) was added.

Solution (C3)

| | |
|---|---|
| Potassium bromide | 1.09 g |
| Water to make | 120 ml |

Preparation of Silver Halide Emulsion (BB-5)

Silver halide emulsion (BB-5) was prepared similarly to the foregoing silver halide emulsion (BB-4), provided that the foregoing solution (D5) was further added at the time when 80% of the solution (B3) was added.

Preparation of Silver Halide Emulsion (BB-6)

Silver halide emulsion (BB-6) was prepared similarly to the foregoing silver halide emulsion (BB-5), provided that the solution (C3) was replaced by the following solution (C4).

Solution (C4)

| | |
|---|---|
| Potassium bromide | 2.61 g |
| Water to make | 180 ml |

Preparation of Silver Halide Emulsion (BB-7)

Silver halide emulsion (BB-7) was prepared similarly to the foregoing silver halide emulsion (BB-5), provided that the solution (C3) was replaced by the following solution (C5).

Solution (C4)

| | |
|---|---|
| Potassium bromide | 4.78 g |
| Water to make | 260 ml |

Preparation of Silver Halide Emulsion (BB-8)

Silver halide emulsion (BB-8) was prepared similarly to the foregoing silver halide emulsion (BB-6), provided that the solution (A2) was replaced by the following solution (A2c).

Solution (A2c)

| | | |
|---|---|---|
| Sodium chloride | 72.0 | g |
| K₂[IrCl₆] | 8.6 × 10⁻⁹ | mol/mol AgX |
| K₂[IrBr₆] | 6.5 × 10⁻⁹ | mol/mol AgX |
| K₂[IrCl₅(H₂O)] | 5.2 × 10⁻⁷ | mol/mol AgX |
| K₂[IrCl₅(thiazole)] | 2.9 × 10⁻⁸ | mol/mol AgX |
| K₄[Fe(CN)₆] | 1.4 × 10⁻⁵ | mol/mol AgX |
| Compound (S-2-5) | 4.0 × 10⁻⁵ | mol/mol AgX |
| Potassium bromide | 0.44 | g |
| Water to make | 420 | ml |

Preparation of Silver Halide Emulsions (G-1) to (G-8)

Silver halide emulsions (G-1) to (G-8) of an average grain size of 0.50 μm were prepared similarly to the foregoing silver halide emulsions (B-1) to (B-8), provided that the contents of K₂[IrCl₆], K₂[IrBr₆], K₂[IrCl₅(H₂O)], K₂[IrCl₅(thiazole)] and K₄[Fe(CN)₆] of solutions (A2), (A2a) and (A2b) were each increased by a factor of 1.6, and the respective addition times of solutions (A1), (A2), (A2a), (A2b), (A3), (B1), (B2) and (B3) were optimally varied.

Preparation of Silver Halide Emulsions (GG-1) to (GG-8)

Silver halide emulsions (GG-1) to (GG-8) of an average grain size of 0.42 μm were prepared similarly to the foregoing silver halide emulsions (BB-1) to (BB-8), provided that the contents of K₂[IrCl₆], K₂[IrBr₆], K₂[IrCl₅(H₂O)], K₂[IrCl₅(thiazole)] and K₄[Fe(CN)₆] of solutions (A2) and (A2c) were each increased by a factor of 1.7, and the respective addition times of solutions (A1), (A2), (A2a), (A3), (B1), (B2) and (B3) were optimally varied.

Preparation of Silver Halide Emulsions (R-1) to (R-8)

Silver halide emulsions (R-1) to (R-8) of an average grain size of 0.45 μm were prepared similarly to the foregoing silver halide emulsions (B-1) to (B-8), provided that the contents of K₂[IrCl₆], K₂[IrBr₆], K₂[IrCl₅(H₂O)], K₂[IrCl₅(thiazole)] and K₄[Fe(CN)₆] of solutions (A2), (A2a) and (A2b) were each increased by a factor of 2.5, and the respective addition times of solutions (A1), (A2), (A2a), (A2b), (A3), (B1), (B2) and (B3) were optimally varied.

Preparation of Silver Halide Emulsions (RR-1) to (RR-8)

Silver halide emulsions (RR-1) to (RR-8) of an average grain size of 0.38 μm were prepared similarly to the foregoing silver halide emulsions (BB-1) to (BB-8), provided that the contents of K₂[IrCl₆], K₂[IrBr₆], K₂[IrCl₅(H₂O)], K₂[IrCl₅(thiazole)] and K₄[Fe(CN)₆] of solutions (A2) and (A2c) were each increased by a factor of 2.4, and the respective addition times of solutions (A1), (A2), (A2a), (A3), (B1), (B2) and (B3) were optimally varied.

The thus prepared silver halide emulsions (B-1) to (B-8), (BB-1) to (BB-8), (G-1) to (G-8), (GG-1) to (GG-8), (R-1) to (R-8), and (RR-1) to (RR-8) were each composed of cubic silver halide grains which accounted for 99% by number of total silver halide grains. Characteristics of the respective emulsions are shown in Table 1, in which the individual characteristic values were determined according to the methods described earlier.

Abbreviations of Table 1 are as follows:

*A: coefficient of variation of bromide contents among grains

*B: coefficient of variation of iodide contents among gtains

Characteristic:

1: including a lamellar iodide-containing layer in the interior of silver halide grains
2: including a lamellar bromide-localized layer and iodide-containing layer interior of silver halide grains

3: including a lamellar bromide-localised layer

TABLE 1

| Silver | Average | C.V.*¹ | | | | | | |
|---|---|---|---|---|---|---|---|---|
| Halide | Grain | of | | | | | | |
| Emulsion | Size | grain | Halide Composition (mol %) | | | | | |
| No. | (μm) | Size | Chloride | Bromide | Iodide | *A | *B | Characteristic |
| B-1 | 0.58 | 0.05 | 99.70 | 0.30 | 0 | 32 | — | — |
| B-2 | 0.58 | 0.05 | 99.68 | 0.30 | 0.02 | 32 | 18 | — |
| B-3 | 0.58 | 0.05 | 99.66 | 0.30 | 0.04 | 32 | 16 | 1 |
| B-4 | 0.58 | 0.05 | 99.60 | 0.30 | 0.10 | 32 | 16 | 1 |
| B-5 | 0.58 | 0.05 | 99.40 | 0.50 | 0.10 | 32 | 16 | 1 |
| B-6 | 0.58 | 0.05 | 98.40 | 1.50 | 0.10 | 19 | 16 | 2 |
| B-7 | 0.58 | 0.05 | 97.30 | 2.60 | 0.10 | 13 | 16 | 2 |
| B-8 | 0.58 | 0.05 | 97.30 | 2.60 | 0.10 | 13 | 16 | 2 |
| BB-1 | 0.48 | 0.05 | 99.70 | 0.30 | 0 | 34 | — | — |
| BB-2 | 0.48 | 0.05 | 99.65 | 0.30 | 0.05 | 34 | 17 | 1 |
| BB-3 | 0.48 | 0.05 | 99.67 | 0.30 | 0.03 | 34 | 18 | 1 |
| BB-4 | 0.48 | 0.05 | 99.20 | 0.80 | 0 | 28 | — | 3 |
| BB-5 | 0.48 | 0.05 | 99.17 | 0.80 | 0.03 | 28 | 18 | 2 |
| BB-6 | 0.48 | 0.05 | 98.47 | 1.50 | 0.03 | 19 | 18 | 2 |
| BB-7 | 0.48 | 0.05 | 97.47 | 2.50 | 0.03 | 13 | 17 | 2 |
| BB-8 | 0.48 | 0.05 | 97.47 | 2.50 | 0.03 | 13 | 17 | 2 |
| G-1 | 0.50 | 0.05 | 99.70 | 0.30 | 0 | 34 | — | — |
| G-2 | 0.50 | 0.05 | 99.68 | 0.30 | 0.02 | 32 | 18 | — |
| G-3 | 0.50 | 0.05 | 99.66 | 0.30 | 0.04 | 32 | 17 | 1 |
| G-4 | 0.50 | 0.05 | 99.60 | 0.30 | 0.10 | 32 | 15 | 1 |
| G-5 | 0.50 | 0.05 | 99.40 | 0.50 | 0.10 | 32 | 15 | 1 |
| G-6 | 0.50 | 0.05 | 98.40 | 1.50 | 0.10 | 18 | 15 | 2 |
| G-7 | 0.50 | 0.05 | 97.30 | 2.60 | 0.10 | 14 | 15 | 2 |
| G-8 | 0.50 | 0.05 | 97.30 | 2.60 | 0.10 | 14 | 15 | 2 |
| GG-1 | 0.42 | 0.06 | 99.70 | 0.30 | 0 | 34 | — | — |
| GG-2 | 0.42 | 0.06 | 99.65 | 0.30 | 0.05 | 34 | 18 | 1 |
| GG-3 | 0.42 | 0.06 | 99.67 | 0.30 | 0.03 | 34 | 17 | 1 |
| GG-4 | 0.42 | 0.06 | 99.20 | 0.80 | 0 | 34 | — | 3 |
| GG-5 | 0.42 | 0.06 | 99.17 | 0.80 | 0.03 | 34 | 14 | 2 |
| GG-6 | 0.42 | 0.06 | 98.47 | 1.50 | 0.03 | 18 | 14 | 2 |
| GG-7 | 0.42 | 0.06 | 97.47 | 2.50 | 0.03 | 14 | 14 | 2 |
| GG-8 | 0.42 | 0.06 | 97.47 | 2.50 | 0.03 | 14 | 14 | 2 |
| R-1 | 0.45 | 0.06 | 99.70 | 0.30 | 0 | 34 | — | — |
| R-2 | 0.45 | 0.06 | 99.68 | 0.30 | 0.02 | 34 | 19 | — |
| R-3 | 0.45 | 0.06 | 99.66 | 0.30 | 0.04 | 34 | 18 | 1 |
| R-4 | 0.45 | 0.06 | 99.60 | 0.30 | 0.10 | 34 | 15 | 1 |
| R-5 | 0.45 | 0.06 | 99.40 | 0.50 | 0.10 | 34 | 15 | 1 |
| R-6 | 0.45 | 0.06 | 98.40 | 1.50 | 0.10 | 18 | 15 | 2 |
| R-7 | 0.45 | 0.06 | 97.30 | 2.60 | 0.10 | 15 | 15 | 2 |
| R-8 | 0.45 | 0.06 | 97.30 | 2.60 | 0.10 | 15 | 15 | 2 |
| RR-1 | 0.38 | 0.06 | 99.70 | 0.30 | 0 | 35 | — | — |
| RR-2 | 0.38 | 0.06 | 99.65 | 0.30 | 0.05 | 33 | 18 | 1 |
| RR-3 | 0.38 | 0.06 | 99.67 | 0.30 | 0.03 | 33 | 18 | 1 |
| RR-4 | 0.38 | 0.06 | 99.20 | 0.80 | 0 | 33 | — | 3 |
| RR-5 | 0.38 | 0.06 | 99.17 | 0.80 | 0.03 | 33 | 15 | 2 |
| RR-6 | 0.38 | 0.06 | 98.47 | 1.50 | 0.03 | 18 | 15 | 2 |
| RR-7 | 0.38 | 0.06 | 97.47 | 2.50 | 0.03 | 16 | 16 | 2 |
| RR-8 | 0.38 | 0.06 | 97.47 | 2.50 | 0.03 | 16 | 16 | 2 |

*¹coefficient of variation

Preparation of Blue-sensitive Emulsions (B-1a)

To the foregoing silver halide emulsions (B-1), sensitizing dyes (BS-1) and (BS-2) were added at 60° C., a pH of 6.2 and a pAg of 7.5, subsequently, sodium thiosulfate and chloroauric acid were added to perform spectral sensitization and chemical sensitization. Following the addition of chemical sensitizers and when optimally ripened, compounds (S-2-5), (S-2-2) and (S-2-3) were successively added to stop ripening. Blue-sensitive silver halide emulsions (B-1a)was thus obtained.

| | |
|---|---|
| Sodium thiosulfate | 7.8 × 10⁻⁶ mol/mol AgX |
| Chloroauric acid | 2.3 × 10⁻⁵ mol/mol AgX |
| Compound S-2-5 | 2.0 × 10⁻⁴ mol/mol AgX |
| Compound S-2-2 | 2.0 × 10⁻⁴ mol/mol AgX |
| Compound S-2-3 | 2.0 × 10⁻⁴ mol/mol AgX |
| Sensitizing dye BS-1 | 6.2 × 10⁻⁴ mol/mol AgX |
| Sensitizing dye BS-2 | 1.6 × 10⁻⁴ mol/mol AgX |

Preparation of Blue-Sensitive Emulsion (B-1b)

Blue-sensitive emulsion (B-1b) was prepared similarly to the foregoing blue-sensitive silver halide emulsion (B-1a), except that the ripening temperature and the ripening pH were varied to 65° C. and 5.8, respectively.

Preparation of Blue-Sensitive Emulsions (B-2a) to (B-8a)

Blue-sensitive silver halide emulsions (B-2a) to (B-8a) were prepared similarly to the foregoing blue-sensitive silver halide emulsions (B-1b), except that each of the prepared silver halide emulsions (B-2) to (B-8) was used instead of the silver halide emulsion (B-1).

Preparation of Blue-Sensitive Emulsions (B-8b)

Blue-sensitive silver halide emulsion (B-8b) was prepared similarly to the foregoing blue-sensitive silver halide emulsion (B-8a), except that the addition amount of sodium thiosulfate was changed to 4.7×10⁻⁶ mol/mol AgX and after addition of sodium thiosulfate, 3.1×10⁻⁶ mol/mol AgX of trifurylphosphine selenide was added and then chloroauric acid was added to perform chemical sensitization.

Preparation of Blue-Sensitive Emulsions (BB-1a), (BB-1b), (BB-2a) to (BB-8a) and (BB-8b)

Blue-sensitive silver halide emulsions (BB-1a), (BB-1b), (BB-2a) to (BB-8a) and (BB-8b) were prepared similarly to the foregoing blue-sensitive silver halide emulsions (B-1a), (B-1b), (B-2a) to (B-8a) and (B-8b), except that silver halide emulsions (B-1) to (B-8) were replaced by silver halide emulsion (BB-1) to (BB-8), respectively, and taking into account the increase of a silver halide grain surface area per weight of silver along with change of the average silver halide grain size of from 0.58 μm to 0.48 μm, addition amounts of sodium thiosulfate, triphenylphosphine selenide, chloroauric acid, and sensitizing dyes (BS-1) and (BS-2) were each varied so that the addition amount per unit surface area remained the same.

Preparation of Green-Sensitive Emulsion (G-1a)

To the foregoing silver halide emulsions (G-1), sensitizing dye (GS-1) was added at 60° C., a pH of 6.2 and a pAg of 7.5 and subsequently, sodium thiosulfate and chloroauric acid were successively added to perform spectral sensitization and chemical sensitization. Following addition of the chemical sensitizers and when optimally ripened, compound (S-2-5) was added to stop ripening. Green-sensitive silver halide emulsions (G-1a) was thus obtained.

| | |
|---|---|
| Sensitizing dye GS-1 | 5.8 × 10⁻⁴ mol/mol AgX |
| Sodium thiosulfate | 6.1 × 10⁻⁶ mol/mol AgX |
| Chloroauric acid | 1.7 × 10⁻⁵ mol/mol AgX |
| Compound S-2-5 | 1.5 × 10⁻⁴ mol/mol AgX |

Preparation of Green-Sensitive Emulsion (G-1b)

Green-sensitive emulsion (G-1b) was prepared similarly to the foregoing green-sensitive silver halide emulsion (G-1a), except that the ripening temperature and the ripening pH were varied to 65° C. and 5.8, respectively.

Preparation of Green-Sensitive Emulsions (G-2a) to (G-8a)

Green-sensitive silver halide emulsions (G-2a) to (G-8a) were prepared similarly to the foregoing green-sensitive silver halide emulsions (G-1b), except that each of the prepared silver halide emulsions (G-2) to (G-8) was used instead of the silver halide emulsion (G-1).

Preparation of Green-Sensitive Emulsions (G-8b)

Green-sensitive silver halide emulsion (G-8b) was prepared similarly to the foregoing green-sensitive silver halide emulsion (G-8a), except that the addition amount of sodium thiosulfate was changed to 3.6×10⁻⁶ mol/mol AgX and after addition of sodium thiosulfate, 2.4×10⁻⁶ mol/mol AgX of trifurylphosphine selenide was added and then chloroauric acid was added to perform chemical sensitization.

Preparation of Green-Sensitive Emulsions (GG-1a), (GG-1b), (GG-2a) to (GG-8a) and (GG-8b)

Green-sensitive silver halide emulsions (GG-1a), (GG-1b), (GG-2a) to (GG-8a) and (GG-8b) were prepared similarly to the foregoing green-sensitive silver halide emulsions (G-1a), (G-1b), (G-2a) to (G-8a) and (G-8b), except that silver halide emulsions (G-1) to (G-8) were replaced by silver halide emulsion (GG-1) to (GG-8), respectively, and taking into account the increase of a silver halide grain surface area per weight of silver along with change of the average silver halide grain size of from 0.50 μm to 0.42 μm, addition amounts of sodium thiosulfate, triphenylphosphine selenide, chloroauric acid, and sensitizing dye (GS-1) were each varied so that the addition amount per unit surface area remained the same.

Preparation of Red-Sensitive Emulsions (R-1a)

To the foregoing silver halide emulsions (R-1), sensitizing dyes (RS-1) and (RS-2) were added at 60° C., a pH of 5.9 and a pAg of 7.1 and subsequently, sodium thiosulfate and chloroauric acid were added to perform spectral sensitization and chemical sensitization. Following the addition of chemical sensitizers and when optimally ripened, compound (S-2-5) was added to stop ripening. Red-sensitive silver halide emulsions (R-1a) was thus obtained.

| | |
|---|---|
| Sodium thiosulfate | 1.2 × 10⁻⁵ mol/mol AgX |
| Chloroauric acid | 1.5 × 10⁻⁵ mol/mol AgX |
| Compound S-2-5 | 1.2 × 10⁻⁴ mol/mol AgX |
| Sensitizing dye RS-1 | 1.0 × 10⁻⁴ mol/mol AgX |
| Sensitizing dye RS-2 | 1.0 × 10⁻⁴ mol/mol AgX |

Preparation of Red-Sensitive Emulsion (R-1b)

Red-sensitive emulsion (R-1b) was prepared similarly to the foregoing red-sensitive silver halide emulsion (R-1a), except that the ripening temperature and the ripening pH were varied to 65° C. and 5.0, respectively.

Preparation of Red-Sensitive Emulsions (R-2a) to (R-8a)

Red-sensitive silver halide emulsions (R-2a) to (R-8a) were prepared similarly to the foregoing red-sensitive silver halide emulsions (R-1b), except that each of the prepared silver halide emulsions (R-2) to (R-8) was used instead of the silver halide emulsion (R-1).

Preparation of Red-Sensitive Emulsions (R-8b)

Red-sensitive silver halide emulsion (R-8b) was prepared similarly to the foregoing red-sensitive silver halide emulsion (R-8a), except that the addition amount of sodium thiosulfate was changed to 7.2×10⁻⁶ mol/mol AgX and after addition of sodium thiosulfate, 4.8×10⁻⁶ mol/mol AgX of trifurylphosphine selenide was added and then chloroauric acid was added to perform chemical sensitization.

Preparation of Red-Sensitive Emulsions (RR-1a), (RR-1b), (RR-2a) to (RR-8a) and (RR-8b)

Red-sensitive silver halide emulsions (RR-1a), (RR-1b), (RR-2a) to (RR-8a) and (RR-8b) were prepared similarly to the foregoing red-sensitive silver halide emulsions (R-1a), (R-1b), (R-2a) to (R-8a) and (R-8b), except that silver halide emulsions (R-1) to (R-8) were replaced by silver halide emulsion (RR-1) to (RR-8), respectively, and taking into account the increase of a silver halide grain surface area per weight of silver along with change of the average silver halide grain size of from 0.45 μm to 0.38 μm, addition amounts of sodium thiosulfate, triphenylphosphine selenide, chloroauric acid, and sensitizing dye (RS-1) were each varied so that the addition amount per unit surface area remained the same.

When completing the preparation of the respective red-sensitive sensitive silver halide emulsions, SS-1 was further added in an amount of 2.0×10⁻³ mol/mol AgZ.

In the preparation of the foregoing light-sensitive silver halide emulsions, the interval of adding sensitizing dyes and chemical sensitizers and the chemical sensitization time were each optimally adjusted so that the obtained silver halide color photographic material exhibited a Δ Log E value, as shown in Table 4.

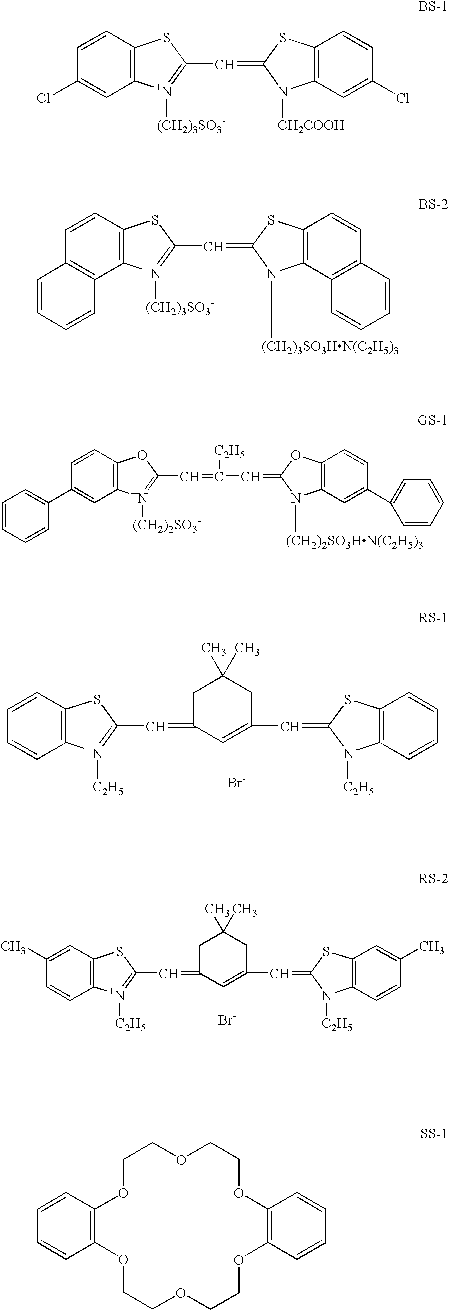

Preparation of Silver Halide Color Photographic Material

Preparation of Sample 101

There was prepared a paper support laminated, on the light-sensitive layer coating side of paper having a weight of 180 g/m², with high density polyethylene, provided that the light-sensitive layer side was laminated with polyethylene melt containing surface-treated anatase type titanium oxide in an amount of 15% by weight. This reflection support was subjected to corona discharge and provided with a gelatin sublayer, and further thereon, the following component layers, as shown below were provided to prepare a silver halide color photographic material sample 101.

Coating solutions were prepared as below, provided that silver halide emulsions used in the respective light-sensitive layers were as follows:

Emulsion of the 1st Layer (Blue-Sensitive Layer):
Emulsion (B-1a): Emulsion (BB-1a)=90:10,

Emulsion of the 3rd Layer (Green-Sensitive Layer):
Emulsion (G-1a): Emulsion (GG-1a)=5:95,

Emulsion of the 5th Layer (Red-Sensitive Layer):
Emulsion (R-1a): Emulsion (RR-1a)=33:67.

Additive 1 and hardeners (H-1) and (H-2) were incorporated in the course of the preparation of sample 101 incorporated. Surfactant (SU-2) was used in the preparation of the coupler dispersion of the individual layer, and surfactants (SU-1) and (SU-3) were used as a coating aid to adjust surface tension. Fungicide (F-1) was incorporated to the respective layers at a total amount of 0.04 g/m². The amount of silver halide emulsion was represented by equivalent converted to silver.

Additives used in sample 101 are shown below.

TABLE 2
Sol-1: tricresyl phosphate
Matting agent: SiO₂ (average particle size: 3.0 μm)

| Layer | Constitution | Amount (g/m²) |
|---|---|---|
| 7th Layer | Gelatin | 0.70 |
| (Protective layer) | Antistaining agent (HQ-1) | 0.003 |
| | Antistaining agent (HQ-2) | 0.02 |
| | High boiling solvent (Sol-1) | 0.01 |
| | Colloidal silica | 0.06 |
| | Matting agent | 0.003 |
| 6th Layer | Gelatin | 0.50 |
| (UV absorbing layer) | UV absorbent (UV-1) | 0.04 |
| | UV absorbent (UV-2) | 0.16 |
| | Antistaining agent (HQ-2) | 0.02 |
| | High boiling solvent (Sol-2) | 0.02 |
| | Blueing agent (WB-1) | 0.0001 |
| | Blueing agent (WB-2) | 0.001 |
| | Image stabilizer (Cpd-1) | 0.006 |
| | Polyvinylpyrrolidone | 0.01 |
| 5th Layer | Gelatin | 1.00 |
| (Red-sensitive layer) | Red-sensitive emulsion (R-1a) | 0.05 |
| | Red-sensitive emulsion (RR-1a) | 0.10 |
| | Cyan coupler (C-1) | 0.20 |
| | Cyan coupler (C-2) | 0.05 |
| | Antistaining agent (HQ-1) | 0.003 |
| | Image stabilizer (Cpd-2) | 0.05 |
| | Image stabilizer (Cpd-3) | 0.01 |
| | High boiling solvent (Sol-1) | 0.17 |
| 4th Layer | Gelatin | 1.10 |
| (UV absorbing layer) | UV absorbent (UV-1) | 0.09 |
| | UV absorbent (UV-2) | 0.35 |
| | Antistaining agent (HQ-2) | 0.05 |
| | High boiling solvent (Sol-2) | 0.06 |
| | Blueing agent (WB-1) | 0.0001 |
| | Blueing agent (WB-2) | 0.001 |
| | Image stabilizer (Cpd-1) | 0.013 |
| 3rd Layer | Gelatin | 1.30 |
| (Green-sensitive layer) | Green-sensitive Emulsion (G-1a) | 0.006 |
| | Green-sensitive Emulsion (GG-1a) | 0.11 |
| | Magenta coupler (M-1) | 0.13 |
| | Image stabilizer (Cpd-4) | 0.18 |
| | UV absorbent (UV-2) | 0.07 |
| | High boiling solvent (Sol-2) | 0.16 |
| 2nd layer | Gelatin | 1.00 |
| (Interlayer) | Antistaining agent (HQ-1) | 0.02 |
| | Antistaining agent (HQ-2) | 0.11 |
| | High boiling solvent (Sol-1) | 0.05 |
| | Brightener (W-1) | 0.07 |
| | Polyvinylpyrrolidone | 0.07 |
| 1st layer | Gelatin | 1.10 |
| (Blue-sensitive layer) | Blue-sensitive Emulsion (B-1a) | 0.21 |
| | Blue-sensitive Emulsion (BB-1a) | 0.02 |
| | Yellow coupler (Y-1) | 0.44 |
| | Antistaining agent (HQ-1) | 0.004 |
| | Image stabilizer (Cpd-1) | 0.006 |
| | Image stabilizer (Cpd-2) | 0.03 |
| | Image stabilizer (Cpd-5) | 0.13 |
| | High boiling solvent (Sol-1) | 0.14 |
| | High boiling solvent (Sol-2) | 0.02 |

Y-1

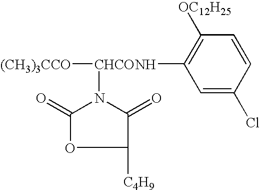

M-1

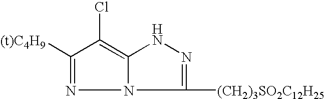

C-1

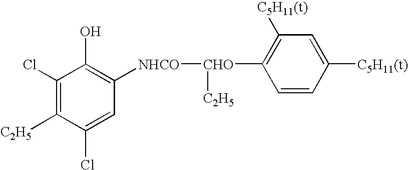

C-2

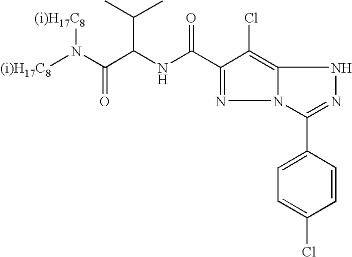

HQ-1

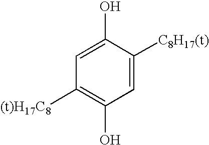

HQ-2

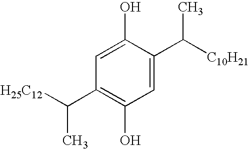

Sol-2
H₁₇C₈HC═CH(CH₂)₈OH
UV-1

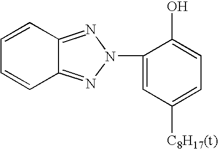

UV-2

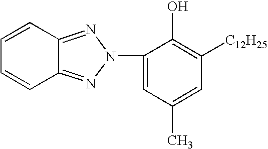

Cpd-1

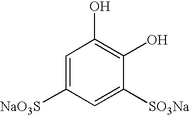

Cpd-2

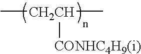

Cpd-3

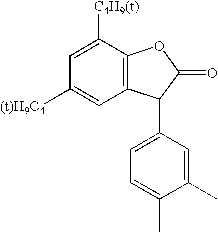

Cpd-4

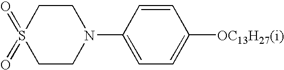

Cpd-5

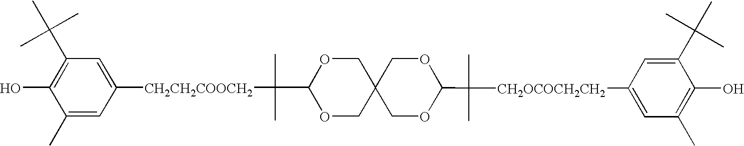

W-1

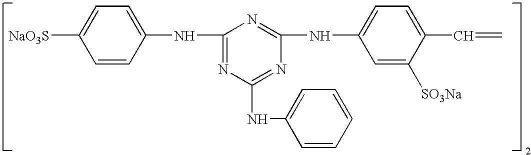

WB-1

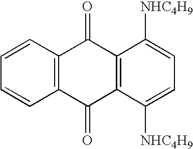

WB-2

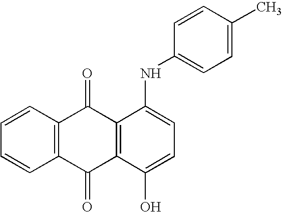

Al-1

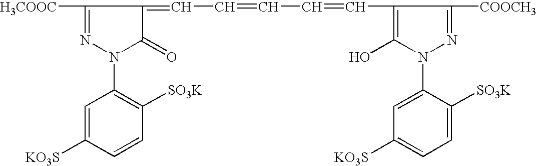

Al-2

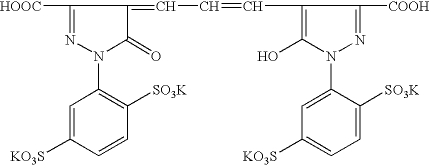

Al-3

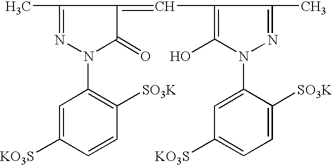

F-1

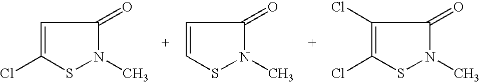

Mixture (molar ratio=50:46:4) 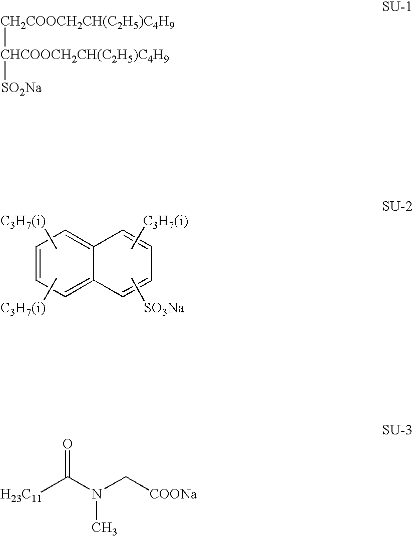
   Additive 1 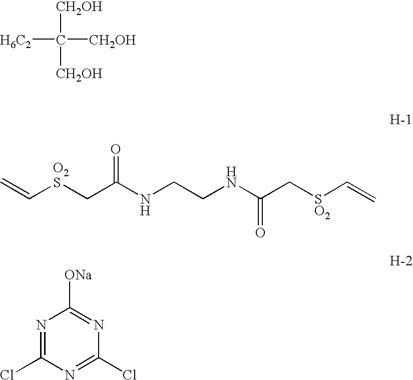
   Preparation of Samples 102 to 111

Samples 102 to 111 were prepared similarly to the foregoing sample 101, provided that the blue-sensitive silver halide emulsion of the 1st layer, the green-sensitive silver halide emulsion of the 3rd layer and the red-sensitive silver halide emulsion layer were each replaced by the combination of silver halide emulsions described in Table 4. The blending ratio of the light-sensitive silver halide emulsions was the same as that of sample 101.

### Evaluation of Characteristics

Determination of Point Gamma Difference Δ Log E

Evaluation A

The thus prepared samples were each exposed to light through an optical wedge for 0.5 sec using a light source of 54000 K and processed according to the following process 1. Using a densitometer PDA-65 (produced by Konica Minolta Photo Imaging, Inc.), the processed samples were measured with respect to reflection densities of the respective steps of a gray stepped image to prepare a characteristic curve comprising an abscissa of exposure (Log E) and an ordinate of reflection density (D). Subsequently, differential values of density versus exposure for the respective steps were calculated to determine the maximum point γ (γma) with respect to a magenta image.

Evaluation B

Similarly to the foregoing evaluation A, exposure, processing and densitometry were carried out, except that the exposure apparatus was replaced by a xenon flash sensitometer for high intensity exposure (SX-20 Type, available from YAMASHITA DENSO Co., Ltd.), in which exposure was optimally adjusted so as to give gray stepped images and conducted through an optical wedge for use in sensitometry, for 10⁻⁶ sec. Subsequently, differential values of density vs. exposure for the respective steps were calculated to determine the maximum point gamma γ (γma) with respect to the magenta image.

Determination of Δ Log E

There was determined the difference in exposure between exposures (Log Ed, Log Ea) exhibiting the maximum point gamma on the characteristic curves obtained in the foregoing evaluations A and B. Thus, when one of the characteristic curves was shifted parallel to the abscissa so that both curves were overlapped at the point of D=0.8, the difference Δ Log E(=Log Ed−Log Ea) was determined between the exposure providing the maximum point gamma on the characteristic curve obtained in evaluation A and the exposure (Log Ed) providing the maximum point gamma on the characteristic curve obtained in evaluation B.

Process 1

| Processsing step | Temperature | | Time | Repl. Amt.* |
|---|---|---|---|---|
| Color developing | 38.0 ± 0.3° | C. | 45 sec. | 80 ml |
| Bleach-fixing | 35.0 ± 0.5° | C. | 45 sec. | 120 ml |
| Stabilizing | 30-34° | C. | 60 sec. | 150 ml |
| Drying | 60-80° | C. | 30 sec. | |

*Replenishing amount

Color developer (Tank solution, Replenisher)

| | Tank soln. | | Replenisher | |
|---|---|---|---|---|
| Water | 800 | ml | 800 | ml |
| Triethylenediamine | 2 | g | 3 | g |
| Diethylene glycol | 10 | g | 10 | g |
| Potassium bromide | 0.01 | g | — | |
| Potassium chloride | 3.5 | g | — | |
| Potassium sulfite | 0.25 | g | 0.5 | g |
| N-ethyl-N(β-methanesulfonamidoethyl)- | 6.0 | g | 10.0 | g |
| 3-methyl-4-aminoaniline sulfate | | | | |
| N,N-diethylhydroxyamine | 6.8 | g | 6.0 | g |
| Triethanolamine | 10.0 | g | 10.0 | g |
| Sodium diethyltriaminepentaacetate | 2.0 | g | 2.0 | g |
| Brightener (4,4′-diaminostilbene- | 2.0 | g | 2.5 | g |
| disulfonate derivative) | | | | |
| Potassium carbonate | 30 | g | 30 | g |

Water is added to make 1 liter, and the pH of the tank solution and replenisher were respectively adjusted to 10.10 and 10.60 with sulfuric acid or potassium hydroxide.

Bleach-fixer (Tank solution, Replenisher)

| | | |
|---|---|---|
| Ammonium ferric diethylenetriamine- | 65 | g |
| pentaacetate dihydrate | | |
| diethylenetriaminepentaacetic acid | 3 | g |
| Ammonium thiosulfate (70% aqueous solution) | 100 | ml |
| 2-Amino-5-mercapto-1,3,4-thiadiazole | 2.0 | g |
| Ammonium sulfite (40% aqueous solution) | 27.5 | ml |

Water is added to make 1 liter, and the pH is adjusted to 5.0.

Stabilizer (Tank solution, Replenisher)

| | | |
|---|---|---|
| o-Phenylphenol | 1.0 | g |
| 5-Chloro-2-methyl-4-isothiazoline-3-one | 0.02 | g |
| 2-Methyl-4-isothiazoline-3-one | 0.02 | g |
| Diethylene glycol | 1.0 | g |
| Brightener (Chinopal SFP) | 2.0 | g |
| 1-Hydroxyethylidene-1,1-diphosphonic acid | 1.8 | g |
| Bismuth chloride (40% aqueous solution) | 0.65 | g |
| Magnesium sulfate heptahydrate | 0.2 | g |
| Polyvinyl pyrrolidine (PVP) | 1.0 | g |
| Ammonia water (25% aqueous | 2.5 | g |
| ammonium hydroxide solution) | | |
| Trisodium nitrilotriacetate | 1.5 | g |

Water is added to make 1 liter, and the pH is adjusted to 7.5 with sulfuric acid or potassium hydroxide.

Evaluation of Radiation Resistance

Two parts were prepared for samples 101 to 111, one of which was subjected to a natural radiation treatment (which was exposure to radiation equivalent to 300 mR, using Cs¹³⁷ as a radiation source). The thus treated samples were subjected to the foregoing process 1, together with the other part, as standard samples which were not subjected to the natural radiation treatment.

Subsequently, using a densitometer PDA-65 (produced by Konica Minolta Photo Imaging, Inc.), the minimum magenta reflection density (or magenta fog density) of the respective processed samples was measured through a green filter. There was determined the rate of density rise of the magenta fog density (D min 2) of the samples having been subjected to natural radiation versus the magenta fog density (D min 1) of a standard sample (which is expressed as D min 2/D min 1). The rate of density rise was represented by a relative value, based on the rate of density rise of sample 101 being 100.

Evaluation of Storage Stability

Two parts were prepared for samples 101 to 111, one of which was subjected to an accelerated aging treatment for 6 days at 55° C. and 40% RH, and the other part was not subjected to the accelerated aging treatment, as standard samples, each of which was subjected to evaluation A and process 1. Subsequently, characteristic curves of the thus processed samples were prepared similarly to the foregoing and the exposure amount necessary to give a density of the minimum density plus 1.0 was determined with respect to the magenta image density of the 3rd layer (green-sensitive layer). The reciprocal of this exposure amount was defined as sensitivity, and sensitivities of the acceleratingly aged samples were each represented by a relative value, based on the sensitivity of each of the standard samples being 100. Superior storage stability was indicated as sensitivity of an accelerated aged sample approached 100.

Evaluation of Process Stability

Samples 101 to 111 were subjected to exposure and process 1 in accordance with the foregoing evaluation B. Separately, samples 101 to 111 were exposed in accordance with the evaluation B and then processed according to the following process 2:

Process 2

| Processsing Step | Temperature | | Time | Repl. Amt.* |
|---|---|---|---|---|
| Color developing | 42.0 ± 0.3° | C. | 20 sec. | 80 ml |
| Bleach-fixing | 40.0 ± 0.5° | C. | 20 sec. | 120 ml |
| Stabilizing | 30-34° | C. | 20 sec. | 150 ml |
| Drying | 60-80° | C. | 30 sec. | |

*Replenishing amount

Processing solutions used in the respective processing steps of the process 2 were the same as those used in the process 1.

Subsequently, characteristic curves of the samples processed according to the processes 1 and 2 were prepared similarly to the foregoing and the exposure amount necessary to give a density of the minimum density plus 1.0 was determined with respect to the magenta image density of the 3rd layer (green-sensitive layer). The reciprocal of this exposure amount was defined as sensitivity, and sensitivities of samples processed in the process 2 were each represented by a relative value as a measure of process stability, based on the sensitivity of each of samples processed in the process 1 being 100. A sensitivity of a sample processed in the process 2 closer to 100 indicates superior storage stability.

The thus obtained results are shown in Table 4.

TABLE 4

| | Silver Halide Emulsion | | | | | | |
|---|---|---|---|---|---|---|---|
| | 1st Layer | 3rd Layer | 5th Layer | | | | |
| | (Blue- | (Green- | (Red- | Evaluation Result | | | |
| Sample | sensitive | sensitive | sensitive | | Radiation | Storage | Process |
| No. | Layer) | Layer) | Layer) | ΔLogE | Resistance | Stability | Stability |
| 101 | B-1a/BB-1a | G-1a/GG-1a | R-1a/RR-1a | 0.18 | 100 | 71 | 72 |
| 102 | B-1b/BB-1b | G-1b/GG-1b | R-1b/RR-1b | 0.14 | 97 | 71 | 74 |
| 103 | B-2a/BB-2a | G-2a/GG-2a | R-2a/RR-2a | 0.13 | 95 | 75 | 77 |
| 104 | B-1a/BB-3a | G-1a/GG-3a | R-1a/RR-3a | 0.13 | 96 | 74 | 78 |
| 105 | B-3a/BB-1a | G-3a/GG-1a | R-3a/RR-1a | 0.13 | 84 | 86 | 84 |
| 106 | B-4a/BB-4a | G-4a/GG-4a | R-4a/RR-4a | 0.07 | 79 | 89 | 88 |
| 107 | B-5a/BB-5a | G-5a/GG-5a | R-5a/RR-5a | 0.04 | 73 | 92 | 92 |
| 108 | B-6a/BB-6a | G-6a/GG-6a | R-6a/RR-6a | 0.04 | 73 | 93 | 94 |
| 109 | B-7a/BB-7a | G-7a/GG-7a | R-7a/RR-7a | 0.04 | 72 | 93 | 95 |
| 110 | B-8a/BB-8a | G-8a/GG-8a | R-8a/RR-8a | 0.04 | 70 | 94 | 95 |
| 111 | B-8b/BB-8b | G-8b/GG-8b | R-8b/RR-8b | 0.04 | 70 | 95 | 96 |

As apparent from the results shown in Table 4, it was proved that samples having constitution of silver halide emulsions relating to the invention and the characteristic value (Δ Log E) as defined in the invention exhibit superior radiation resistance and improved storage stability and process stability, as compared to comparative samples. As a result of evaluation of the blue-sensitive layer (yellow image) and the red-sensitive layer (cyan image), similar results were also obtained.

### Example 2

### Preparation of Silver Halide Emulsion

Preparation of Silver Halide Emulsion (B-11)

To 1.5 liter of an aqueous 2% solution of deionized ossein gelatin (having a calcium content of 10 ppm), maintained at 45° C. were added solutions (A11) and (B11) for 10 min, while controlling the pAg and pH at 7.3 and 5.8, respectively with vigorously stirring using a stirring mixer described in JP-A No. 62-160128. Subsequently, solutions (A12) and (B12) were added for 60 min with controlling the pAg and pH at 8.0 and 5.5, respectively. Then, solutions (A13) and (B13) were added over 18 min. with controlling the pAg and pH at 8.0 and 5.5, respectively. The pAg was controlled in accordance with the method described in JP-A No. 59-45437 and the pH was controlled using aqueous sulfuric acid or sodium hydroxide solution.

Solution (A11)

| | | |
|---|---|---|
| Sodium chloride | 3.43 | g |
| Potassium bromide | 0.021 | g |
| Water to make | 200 | ml |

Solution (A12)

| | | |
|---|---|---|
| Sodium chloride | 72.2 | g |
| K₂[IrCl₆] | 3.6 × 10⁻⁸ | mol/mol AgX |
| K₂[IrBr₆] | 1.0 × 10⁻⁸ | mol/mol AgX |
| K₄[Fe(CN)₆] | 9.4 × 10⁻⁶ | mol/mol AgX |
| Potassium bromide | 0.87 | g |
| Water to make | 420 | ml |

Solution (A13)

| | | |
|---|---|---|
| Sodium chloride | 30.9 | g |
| Potassium bromide | 0.19 | g |
| Water to make | 180 | ml |

Solution (B11)

| | | |
|---|---|---|
| Silver nitrate | 10 | g |
| Water to make | 200 | ml |

Solution (B12)

| | | |
|---|---|---|
| Silver nitrate | 210 | g |
| Water to make | 420 | ml |

Solution (B13)

| | | |
|---|---|---|
| Silver nitrate | 90 | g |
| Water to make | 180 | ml |

After completing addition, an aqueous 15% solution containing 30 g of chemically modified gelatin (modification rate of 95%), in which an amino group of gelatin was phenylcarbamoylated, was added to perform desalting in accordance with the method described in JP-A No. 5-72658, and an aqueous gelatin solution was further added thereto to obtain silver halide emulsion (B-11) comprising monodisperse cubic grains having an average grain size of 0.54 μm.

Preparation of Silver Halide Emulsion (B-12)

Silver halide emulsion (B-12) was prepared similarly to the foregoing silver halide emulsion (B-11), provided that the solution (A12) was replaced by the following solution (A12a) and the following solution (C11) was further added at the time when 20% of the solution (B13) was added.

Solution (A12a)

| | | |
|---|---|---|
| Sodium chloride | 72.2 | g |
| K₂[IrCl₆] | 5.8 × 10⁻⁹ | mol/mol AgX |
| K₂[IrBr₆] | 4.3 × 10⁻⁹ | mol/mol AgX |
| K₂[IrCl₅(H₂O)] | 3.8 × 10⁻⁷ | mol/mol AgX |
| K₂[IrCl₅(thiazole)] | 2.1 × 10⁻⁸ | mol/mol AgX |
| K₄[Fe(CN)₆] | 1.1 × 10⁻⁵ | mol/mol AgX |
| Compound (S-2-5) | 2.0 × 10⁻⁵ | mol/mol AgX |
| Potassium bromide | 0.87 | g |
| Water to make | 420 | ml |

Solution (C11)

| | | |
|---|---|---|
| Potassium bromide | 2.17 | g |
| Water to make | 182 | ml |

Preparation of Silver Halide Emulsion (B-13)

Silver halide emulsion (B-13) was prepared similarly to the foregoing silver halide emulsion (B-12), provided that the following solution (D11) was further added at the time when 60% of the solution (B13) was added.

Solution (D11)

| | | |
|---|---|---|
| Potassium iodide | 0.30 | g |
| Water to make | 80 | ml |

Preparation of Silver Halide Emulsion (BB-11)

Silver halide emulsion (BB-11) of an average grain size of 0.46 μm was prepared similarly to the foregoing silver halide emulsion (B-11), provided that the contents of K₂[IrCl₆], K₂[IrBr₆] and K₄[Fe(CN)₆] of solution (A12) were each increased by a factor of 1.7 and the respective addition times of solutions (A11), (A12), (A13), (B11), (B12) and (B13) were optimally varied.

Preparation of Silver Halide Emulsion (BB-12)

Silver halide emulsion (BB-12) was prepared similarly to the foregoing silver halide emulsion (BB-11), provided that the foregoing solution (C11) was further added at the time when 20% of the solution (B13) was added.

Preparation of Silver Halide Emulsion (BB-13)

Silver halide emulsion (BB-13) was prepared similarly to the foregoing silver halide emulsion (BB-11), provided that the solution (A12) was replaced by the following solution (A12b) and the following solution (C12) was further added at the time when 20% of the solution (B13) was added.

Solution (A12b)

| | | |
|---|---|---|
| Sodium chloride | 72.2 | g |
| K₂[IrCl₆] | 8.8 × 10⁻⁹ | mol/mol AgX |
| K₂[IrBr₆] | 6.3 × 10⁻⁹ | mol/mol AgX |
| K₂[IrCl₅(H₂O)] | 6.6 × 10⁻⁷ | mol/mol AgX |
| K₂[IrCl₅(thiazole)] | 3.6 × 10⁻⁸ | mol/mol AgX |
| K₄[Fe(CN)₆] | 1.8 × 10⁻⁵ | mol/mol AgX |
| Compound (S-2-5) | 4.0 × 10⁻⁵ | mol/mol AgX |
| Potassium bromide | 0.87 | g |
| Water to make | 420 | ml |

Solution (C12)

| | | |
|---|---|---|
| Potassium bromide | 3.26 | g |
| Water to make | 260 | ml |

Preparation of Silver Halide Emulsion (BB-14)

Silver halide emulsion (BB-14) was prepared similarly to the foregoing silver halide emulsion (BB-13), provided that the following solution (D12) was further added at the time when 60% of the solution (B13) was added.

Solution (D12)

| | | |
|---|---|---|
| Potassium iodide | 0.15 | g |
| Water to make | 80 | ml |

Preparation of Silver Halide Emulsion (G-11)

Silver halide emulsion (G-11) of an average grain size of 0.45 μm was prepared similarly to the foregoing silver halide emulsion (B-11), provided that the contents of K₂[IrCl₆], K₂[IrBr₆] and K₄[Fe(CN)₆] of solution (A12) were each increased by a factor of 1.9 and the respective addition times of solutions (A11), (A12), (A13), (B11), (B12) and (B13) were optimally varied.

Preparation of Silver Halide Emulsion (G-12)

Silver halide emulsion (G-12) was prepared similarly to the foregoing silver halide emulsion (G-11), provided that the foregoing solution (C13) was further added at the time when 20% of the solution (B13) was added.

Solution (C13)

| | | |
|---|---|---|
| Potassium bromide | 4.34 | g |
| Water to make | 320 | ml |

Preparation of Silver Halide Emulsion (G-13)

Silver halide emulsion (G-13) was prepared similarly to the foregoing silver halide emulsion (G-12), provided that the solution (A12) was replaced by the following solution (A12c).

Solution (A12c)

| | | |
|---|---|---|
| Sodium chloride | 72.2 | g |
| K₂[IrCl₆] | 9.8 × 10⁻⁹ | mol/mol AgX |
| K₂[IrBr₆] | 6.9 × 10⁻⁹ | mol/mol AgX |
| K₂[IrCl₅(H₂O)] | 7.3 × 10⁻⁷ | mol/mol AgX |
| K₂[IrCl₅(thiazole)] | 4.0 × 10⁻⁸ | mol/mol AgX |
| K₄[Fe(CN)₆] | 2.0 × 10⁻⁵ | mol/mol AgX |
| Compound (S-2-5) | 4.0 × 10⁻⁵ | mol/mol AgX |
| Potassium bromide | 0.87 | g |
| Water to make | 420 | ml |

Preparation of Silver Halide Emulsion (G-14)

Silver halide emulsion (G-14) was prepared similarly to the foregoing silver halide emulsion (G-13), provided that the foregoing solution (D12) was further added at the time when 60% of the solution (B13) was added.

Preparation of Silver Halide Emulsion (GG-11)

Silver halide emulsion (GG-11) of an average grain size of 0.40 μm was prepared similarly to the foregoing silver halide emulsion (B-11), provided that the contents of K₂[IrCl₆], K₂[IrBr₆] and K₄[Fe(CN)₆] of solution (A12) were each increased by a factor of 2.5 and the respective addition times of solutions (A11), (A12), (A13), (B11), (B12) and (B13) were optimally varied.

Preparation of Silver Halide Emulsion (GG-12)

Silver halide emulsion (GG-12) was prepared similarly to the foregoing silver halide emulsion (GG-11), provided that the foregoing solution (C14) was further added at the time when 20% of the solution (B13) was added.

Solution (C14)

| | |
|---|---|
| Potassium bromide | 5.43 g |
| Water to make | 350 ml |

Preparation of Silver Halide Emulsion (GG-13)

Silver halide emulsion (GG-13) was prepared similarly to the foregoing silver halide emulsion (GG-12), provided that the solution (A12) was replaced by the following solution (A12d).

Solution (A12d)

| | | |
|---|---|---|
| Sodium chloride | 72.2 | g |
| K₂[IrCl₆] | 1.2 × 10⁻⁸ | mol/mol AgX |
| K₂[IrBr₆] | 9.0 × 10⁻⁹ | mol/mol AgX |
| K₂[IrCl₅(H₂O)] | 9.5 × 10⁻⁷ | mol/mol AgX |
| K₂[IrCl₅(thiazole)] | 5.2 × 10⁻⁸ | mol/mol AgX |
| K₄[Fe(CN)₆] | 2.6 × 10⁻⁵ | mol/mol AgX |
| Compound (S-2-5) | 4.0 × 10⁻⁵ | mol/mol AgX |
| Potassium bromide | 0.87 | g |
| Water to make | 420 | ml |

Preparation of Silver Halide Emulsions (R-11) to (R-14)

Silver halide emulsions (R-11) to (R-14) of an average grain size of 0.38 μm were prepared similarly to the foregoing silver halide emulsions (G-11) to (G-14), respectively, provided that the contents of K₂[IrCl₆], K₂[IrBr₆] and K₄[Fe(CN)₆] of solutions (A12) and (A12c) were each increased by a factor of 1.5 and the respective addition times of solutions (A11), (A12), (A12c), (A13), (B11), (B12) and (B13) were optimally varied.

Preparation of Silver Halide Emulsion (RR-11)

Silver halide emulsion (RR-11) of an average grain size of 0.32 μm was prepared similarly to the foregoing silver halide emulsion (B-11), respectively, provided that the contents of K₂[IrCl₆], K₂[IrBr₆], K₂[IrCl₅(H₂O)], K₂[IrCl₅(thiazole)] and K₄[Fe(CN)₆] of solution (A12) were each increased by a factor of 4.5 and the respective addition times of solutions (A11), (A12), (A13), (B11), (B12) and (B13) were optimally varied.

Preparation of Silver Halide Emulsion (RR-12)

Silver halide emulsion (RR-12) was prepared similarly to the foregoing silver halide emulsion (RR-11), provided that the foregoing solution (C15) was further added at the time when 20% of the solution (B13) was added.

Solution (C15)

| | |
|---|---|
| Potassium bromide | 6.51 g |
| Water to make | 380 ml |

Preparation of Silver Halide Emulsion (RR-13)

Silver halide emulsion (RR-13) was prepared similarly to the foregoing silver halide emulsion (RR-12), provided that the solution (A12) was replaced by the following solution (A12e).

Solution (A12e)

| | | |
|---|---|---|
| Sodium chloride | 72.2 | g |
| K₂[IrCl₆] | 1.9 × 10⁻⁸ | mol/mol AgX |
| K₂[IrBr₆] | 1.7 × 10⁻⁸ | mol/mol AgX |
| K₂[IrCl₅(H₂O)] | 1.7 × 10⁻⁶ | mol/mol AgX |
| K₂[IrCl₅(thiazole)] | 9.4 × 10⁻⁸ | mol/mol AgX |
| K₄[Fe(CN)₆] | 4.7 × 10⁻⁵ | mol/mol AgX |
| Compound (S-2-5) | 4.0 × 10⁻⁵ | mol/mol AgX |
| Potassium bromide | 0.87 | g |
| Water to make | 420 | ml |

The thus prepared silver halide emulsions (B-11) to (B-13), (BB-11) to (BB-14), (G-11) to (G-14), (GG-11) to (GG-13), (R-11) to (R-14), and (RR-11) to (RR-13) were each composed of cubic silver halide grains which accounted for 99% by number of total silver halide grains. Characteristics of the respective emulsions are shown in Table 5, in which the respective abbreviations are the same as those of Table 1.

TABLE 5

| Silver | Average | C.V.*¹ | | | | | | |
|---|---|---|---|---|---|---|---|---|
| Halide | Grain | of | | | | | | |
| Emulsion | Size | Grain | Halide Composition (mol %) | | | | | |
| No. | (μm) | Size | Chloride | Bromide | Iodide | *A | *B | Characteristic |
| B-11 | 0.54 | 0.05 | 99.50 | 0.50 | 0 | 32 | — | — |
| B-12 | 0.54 | 0.05 | 98.50 | 1.50 | 0 | 19 | — | 3 |
| B-13 | 0.54 | 0.05 | 98.40 | 1.50 | 0.10 | 18 | 17 | 2 |
| BB-11 | 0.46 | 0.05 | 99.50 | 0.50 | 0 | 33 | — | — |
| BB-12 | 0.46 | 0.05 | 98.50 | 1.50 | 0 | 18 | — | 3 |
| BB-13 | 0.46 | 0.05 | 98.00 | 2.00 | 0 | 16 | — | 3 |
| BB-14 | 0.46 | 0.05 | 97.95 | 2.00 | 0.05 | 16 | 19 | 2 |
| G-11 | 0.45 | 0.05 | 99.50 | 0.50 | 0 | 33 | — | — |
| G-12 | 0.45 | 0.05 | 97.50 | 2.50 | 0 | 15 | — | 3 |
| G-13 | 0.45 | 0.05 | 97.50 | 2.50 | 0 | 15 | — | 3 |
| G-14 | 0.45 | 0.05 | 97.45 | 2.50 | 0.05 | 15 | 19 | 2 |
| GG-11 | 0.40 | 0.06 | 99.50 | 0.50 | 0 | 33 | — | — |
| GG-12 | 0.40 | 0.06 | 97.00 | 3.00 | 0 | 15 | — | 3 |
| GG-13 | 0.40 | 0.06 | 97.00 | 3.00 | 0 | 15 | — | 3 |
| R-11 | 0.38 | 0.06 | 99.50 | 0.50 | 0 | 33 | — | — |
| R-12 | 0.38 | 0.06 | 97.50 | 2.50 | 0 | 15 | — | 3 |
| R-13 | 0.38 | 0.06 | 97.50 | 2.50 | 0 | 15 | — | 3 |
| R-14 | 0.38 | 0.06 | 97.45 | 2.50 | 0.05 | 15 | 18 | 2 |
| RR-11 | 0.32 | 0.06 | 99.50 | 0.50 | 0 | 33 | — | — |
| RR-12 | 0.32 | 0.06 | 96.50 | 3.50 | 0 | 14 | — | 3 |
| RR-13 | 0.32 | 0.06 | 96.50 | 3.50 | 0 | 14 | — | 3 |

*¹coefficient of variation

Preparation of Blue-Sensitive Emulsion (B-11a)

Blue-sensitive silver halide emulsion (B-11a) was prepared similarly to the blue-sensitive silver halide emulsion (B-1a) of Example 1, except that silver halide emulsion (B-1) was replaced by silver halide emulsion (B-11), and taking into account the increase of a silver halide grain surface area per weight of silver along with change of the average silver halide grain size of from 0.58 μm to 0.54 μm, addition amounts of sodium thiosulfate, chloroauric acid, and sensitizing dyes (BS-1) and (BS-2) were each varied so that their addition amounts per unit surface area remained the same.

Preparation of Blue-Sensitive Emulsions (B-11b), (B-12a) and (B-13a)

Blue-sensitive silver halide emulsions (B-11b), (B-12a) and (B-13a) were prepared similarly to the blue-sensitive silver halide emulsion (B-1b) of Example 1, except that silver halide emulsion (B-1) was replaced by silver halide emulsion (B-11) (B-12) or (B-13), and taking into account the increase of a silver halide grain surface area per weight of silver along with change of the average silver halide grain size of from 0.58 μm to 0.54 μm, addition amounts of sodium thiosulfate, chloroauric acid, and sensitizing dyes (BS-1) and (BS-2) were each varied so that their addition amounts per unit surface area remained the same.

Preparation of Blue-Sensitive Emulsion (B-13b)

Blue-sensitive silver halide emulsion (B-13b) was prepared similarly to the blue-sensitive silver halide emulsion (B-8b) of Example 1, except that silver halide emulsion (B-8) was replaced by silver halide emulsion (B-13), and taking into account the increase of a silver halide grain surface area per weight of silver along with change of the average silver halide grain size of from 0.58 μm to 0.54 μm, addition amounts of sodium thiosulfate, triphenylphosphine selenide, chloroauric acid, and sensitizing dyes (BS-1) and (BS-2) were each varied so that their addition amounts per unit surface area remained the same.

Preparation of Blue-Sensitive Emulsion (BB-11a)

Blue-sensitive silver halide emulsion (BB-11a) was prepared similarly to the blue-sensitive silver halide emulsion (BB-1a) of Example 1, except that silver halide emulsion (BB-1) was replaced by silver halide emulsion (BB-11), and taking into account the increase of a silver halide grain surface area per weight of silver along with change of the average silver halide grain size of from 0.48 μm to 0.46 μm, addition amounts of sodium thiosulfate, chloroauric acid, and sensitizing dyes (BS-1) and (BS-2) were each varied so that their addition amounts per unit surface area remained the same.

Preparation of Blue-Sensitive Emulsions (BB-11b) and (BB-12a) to (BB-14a)

Blue-sensitive silver halide emulsions (B-11b) and (B-12a) to (B-14a) were prepared similarly to the blue-sensitive silver halide emulsion (BB-1b) of Example 1, except that silver halide emulsion (BB-1) was replaced by silver halide emulsion (B-11), (BB-12), (BB-13) or (BB-14), and taking into account the increase of a silver halide grain surface area per weight of silver along with change of the average silver halide grain size of from 0.48 μm to 0.46 μm, addition amounts of sodium thiosulfate, chloroauric acid, and sensitizing dyes (BS-1) and (BS-2) were each varied so that their addition amounts per unit surface area remained the same.

Preparation of Blue-Sensitive Emulsion (BB-14b)

Blue-sensitive silver halide emulsion (BB-14b) was prepared similarly to the blue-sensitive silver halide emulsion (BB-8b) of Example 1, except that silver halide emulsion (BB-8) was replaced by silver halide emulsion (BB-14), and taking into account the increase of a silver halide grain surface area per weight of silver along with change of the average silver halide grain size of from 0.48 μm to 0.46 μm, addition amounts of sodium thiosulfate, triphenylphosphine selenide, chloroauric acid, and sensitizing dyes (BS-1) and (BS-2) were each varied so that their addition amounts per unit surface area remained the same.

Preparation of Green-Sensitive Emulsions (G-11a) and (G-12a)

Green-sensitive silver halide emulsions (G-11a) and (G-12a) were prepared similarly to the green-sensitive silver halide emulsion (G-1a) of Example 1, except that silver halide emulsion (G-1) was replaced by silver halide emulsion (G-11) or (G-12), and taking into account the increase of a silver halide grain surface area per weight of silver along with change of the average silver halide grain size of from 0.50 μm to 0.45 μm, addition amounts of sodium thiosulfate, chloroauric acid, and sensitizing dye (GS-1) were each varied so that their addition amounts per unit surface area remained the same.

Preparation of Green-Sensitive Emulsions (G-11b), (G-12b), (G-13a) and (G-14a)

Green-sensitive silver halide emulsions (G-11b), (G-12b), (G-13a) and (G-14a) were prepared similarly to the green-sensitive silver halide emulsion (G-1b) of Example 1, except that silver halide emulsion (G-1) was replaced by silver halide emulsion (G-11), (G-12), (G-13) or (G-14), and taking into account the increase of a silver halide grain surface area per weight of silver along with change of the average silver halide grain size of from 0.50 μm to 0.45 μm, addition amounts of sodium thiosulfate, chloroauric acid, and sensitizing dye (GS-1) were each varied so that their addition amounts per unit surface area remained the same.

Preparation of Green-sensitive Emulsion (G-14b)

Green-sensitive silver halide emulsion (G-14b) was prepared similarly to the green-sensitive silver halide emulsion (G-8b) of Example 1, except that silver halide emulsion (G-8) was replaced by silver halide emulsion (G-14), and taking into account the increase of a silver halide grain surface area per weight of silver along with change of the average silver halide grain size of from 0.50 μm to 0.45 μm, addition amounts of sodium thiosulfate, triphenylphosphine selenide, chloroauric acid, and sensitizing dye (GS-1) were each varied so that their addition amounts per unit surface area remained the same.

Preparation of Green-Sensitive Emulsion (GG-11a)

Green-sensitive silver halide emulsion (GG-11a) was prepared similarly to the green-sensitive silver halide emulsion (GG-1a) of Example 1, except that silver halide emulsion (GG-1) was replaced by silver halide emulsion (GG-11), and taking into account the increase of a silver halide grain surface area per weight of silver along with change of the average silver halide grain size of from 0.42 μm to 0.40 μm, addition amounts of sodium thiosulfate, chloroauric acid, and sensitizing dye (GS-1) were each varied so that their addition amounts per unit surface area remained the same.

Preparation of Green-Sensitive Emulsions (GG-11b), (GG-12a) and (GG-13a)

Green-sensitive silver halide emulsions (GG-11b), (GG-12a) and (GG-13a) were prepared similarly to the green-sensitive silver halide emulsion (GG-1b) of Example 1, except that silver halide emulsion (GG-1) was replaced by silver halide emulsion (GG-11), (GG-12) or (G-13), and taking into account the increase of a silver halide grain surface area per weight of silver along with change of the average silver halide grain size of from 0.42 μm to 0.40 μm, addition amounts of sodium thiosulfate, chloroauric acid, and sensitizing dye (GS-1) were each varied so that their addition amounts per unit surface area remained the same.

Preparation of Green-Sensitive Emulsion (GG-13b)

Green-sensitive silver halide emulsion (GG-13b) was prepared similarly to the green-sensitive silver halide emulsion (GG-8b) of Example 1, except that silver halide emulsion (GG-8) was replaced by silver halide emulsion (GG-13), and taking into account the increase of a silver halide grain surface area per weight of silver along with change of the average silver halide grain size of from 0.42 μm to 0.40 μm, addition amounts of sodium thiosulfate, triphenylphosphine selenide, chloroauric acid, and sensitizing dye (GS-1) were each varied so that their addition amounts per unit surface area remained the same.

Preparation of Red-sensitive Emulsion (R-11a)

Red-sensitive silver halide emulsion (R-11a) was prepared similarly to the red-sensitive silver halide emulsion (R-1a) of Example 1, except that silver halide emulsion (R-1) was replaced by silver halide emulsion (R-11), and taking into account the increase of a silver halide grain surface area per weight of silver along with change of the average silver halide grain size of from 0.45 μm to 0.38 μm, addition amounts of sodium thiosulfate, chloroauric acid, and sensitizing dyes (RS-1) and (RS-2) were each varied so that their addition amounts per unit surface area remained the same.

Preparation of Red-Sensitive Emulsions (R-11b), (R-12a), (R-13a) and (R-14a)

Red-sensitive silver halide emulsions (R-11b), (R-12a), (R-13a) and (R-14a) were prepared similarly to the red-sensitive silver halide emulsion (R-1b) of Example 1, except that silver halide emulsion (R-1) was replaced by silver halide emulsion (R-11), (R-12), (R-13) or (R-14), and taking into account the increase of a silver halide grain surface area per weight of silver along with change of the average silver halide grain size of from 0.45 μm to 0.38 μm, addition amounts of sodium thiosulfate, chloroauric acid, and sensitizing dyes (RS-1) and (RS-2) were each varied so that their addition amounts per unit surface area remained the same.

Preparation of Red-Sensitive Emulsion (R-14b)

Red-sensitive silver halide emulsion (R-14b) was prepared similarly to the Red-sensitive silver halide emulsion (R-8b) of Example 1, except that silver halide emulsion (R-8) was replaced by silver halide emulsion (R-14), and taking into account the increase of a silver halide grain surface area per weight of silver along with change of the average silver halide grain size of from 0.45 μm to 0.38 μm, addition amounts of sodium thiosulfate, triphenylphosphine selenide, chloroauric acid, and sensitizing dye (RS-1) were each varied so that their addition amounts per unit surface remained were the same.

Preparation of Red-Sensitive Emulsions (RR-11a) and (RR-12a)

Red-sensitive silver halide emulsions (RR-11a) and (RR-12a) were prepared similarly to the red-sensitive silver halide emulsion (RR-1a) of Example 1, except that silver halide emulsion (RR-1) was replaced by silver halide emulsion (RR-11) or (RR-12), and taking into account the increase of a silver halide grain surface area per weight of silver along with change of the average silver halide grain size of from 0.38 μm to 0.32 μm, addition amounts of sodium thiosulfate, chloroauric acid, and sensitizing dyes (RS-1) and (RS-2) were each varied so that their addition amounts per unit surface area remained the same.

Preparation of Red-Sensitive Emulsions (RR-11b), (RR-12b) and (RR-13a)

Red-sensitive silver halide emulsions (RR-11b), (RR-12b) and (RR-13a) were prepared similarly to the red-sensitive silver halide emulsion (RR-1b) of Example 1, except that silver halide emulsion (RR-1) was replaced by silver halide emulsion (RR-11), (RR-12) or (RR-13), and taking into account the increase of a silver halide grain surface area per weight of silver along with change of the average silver halide grain size of from 0.38 μm to 0.32 μm, addition amounts of sodium thiosulfate, chloroauric acid, and sensitizing dyes (RS-1) and (RS-2) were each varied so that their addition amounts per unit surface area remained the same.

Preparation of Red-Sensitive Emulsion (RR-13b)

Red-sensitive silver halide emulsion (RR-13b) was prepared similarly to the red-sensitive silver halide emulsion (RR-8b) of Example 1, except that silver halide emulsion (RR-8) was replaced by silver halide emulsion (RR-13), and taking into account the increase of a silver halide grain surface area per weight of silver along with change of the average silver halide grain size of from 0.38 μm to 0.32 μm, addition amounts of sodium thiosulfate, triphenylphosphine selenide, chloroauric acid, and sensitizing dyes (RS-1) and (RS-2) were each varied so that their addition amounts per unit surface area remained the same.

In the preparation of the respective red-sensitive silver halide emulsions, 2.0×10⁻³ mol/mol.AgX of SS-1 was added at the time of completion of the preparation.

Further, in the preparation of the respective light-sensitive silver halide emulsions, the interval of additions sensitizing dyes and chemical sensitizers, the chemical sensitization time were optimally adjusted so that the obtained silver halide color photographic materials each exhibit the values of Δ Log E shown in Table 6.

Preparation of Silver Halide Color Photographic Material Preparation of Samples 201 to 209.

Photographic material samples 201 to 209 were prepared similarly to sample 101 of Example 1, except that silver halide emulsions of the 1st, 3rd and 5th layers were varied as shown in Table 6.

### Evaluation of Characteristics

The thus prepared samples were measured with respect to respect to radiation Δ Log E, and further evaluated with respect to radiation resistance, storage stability and process stability. The radiation resistance of magenta images are shown in Table 6. The radiation resistance was represented by a relative value, based on the radiation resistance of sample 201 being 100.

TABLE 6

| | Silver Halide Emulsion | | | | | | |
|---|---|---|---|---|---|---|---|
| | 1st Layer | 3rd Layer | 5th Layer | | | | |
| | (Blue- | (Green- | (Red- | Evaluation Result | | | |
| Sample | sensitive | sensitive | sensitive | | Radiation | Storage | Process |
| No. | Layer) | Layer) | Layer) | ΔLogE | Resistance | Stability | Stability |
| 201 | B-11a/BB-11a | G-11a/GG-11a | R-11a/RR-11a | 0.19 | 100 | 71 | 72 |
| 202 | B-11a/BB-11b | G-11a/GG-11b | R-11a/RR-11b | 0.13 | 97 | 71 | 74 |
| 203 | B-11a/BB-12a | G-11b/GG-11b | R-11b/RR-11b | 0.13 | 95 | 74 | 76 |
| 204 | B-11a/BB-11b | G-12a/GG-11b | R-12a/RR-11b | 0.12 | 79 | 86 | 85 |
| 205 | B-11b/BB-11a | G-12b/GG-11a | R-11a/RR-12b | 0.09 | 73 | 89 | 88 |
| 206 | B-11b/BB-11b | G-12a/GG-12a | R-12a/RR-12a | 0.06 | 73 | 90 | 90 |
| 207 | B-12a/BB-13a | G-13a/GG-13a | R-13a/RR-13a | 0.05 | 72 | 91 | 92 |
| 208 | B-13a/BB-14a | G-14a/GG-13a | R-14a/RR-13a | 0.05 | 70 | 94 | 94 |
| 209 | B-13b/BB-14b | G-14b/GG-13b | R-14b/RR-13b | 0.05 | 70 | 95 | 94 |

As apparent from the results shown in Table 6, it was proved that samples having constitution of silver halide emulsions relating to the invention and the characteristic value (Δ Log E) as defined in the invention exhibit superior radiation resistance and improved storage stability and process stability with respect to magenta images, as compared to comparative samples. It was further proved that evaluation of the blue-sensitive layer (yellow image) and the red-sensitive layer (cyan image) also provided similar results.

### Example 3

### Preparation of Silver Halide Emulsion

Preparation of Silver Halide Emulsions (B-21) to (B-28)

Silver halide emulsions (B-21) to (B-28) of an average grain size of 0.50 μm were respectively prepared similarly to the silver halide emulsions (B-1) to (B-8) of Example 1, provided that K₄[Fe(CN)₆] of solutions (A2), (A2a) and (A2b) was replaced by an equimolar amount of K₄[Ru(CN)₆], and the contents of K₂[IrCl₆], K₂[IrBr₆], K₂[IrCl₅(H₂O)], K₂[IrCl₅(thiazole)] and K₄[Ru(CN)₆] of solutions (A2), (A2a) and (A2b) were each increased by a factor of 1.6 and the respective addition times of solutions (A1), (A2), (A2a), (A2b), (A3), (B1), (B2) and (B3) were each optimally varied.

Preparation of Silver Halide Emulsions (BB-21) to (BB-28)

Silver halide emulsions (BB-21) to (BB-28) of an average grain size of 0.44 μm were respectively prepared similarly to the silver halide emulsions (BB-1) to (BB-8) of Example 1, provided that K₄[Fe(CN)₆] of solutions (A2) and (A2c) was replaced by an equimolar amount of K₄[Ru(CN)₆], and the contents of K₂[IrCl₆], K₂[IrBr₆], K₂[IrCl₅(H₂O)], K₂[IrCl₅(thiazole)] and K₄[Ru(CN)₆] of solutions (A2) and (A2c) were each increased by a factor of 1.4 and the respective addition times of solutions (A1), (A2), (A2c), (A3), (B1), (B2) and (B3) were each optimally varied.

Preparation of Silver Halide Emulsions (G-21) to (G-28)

Silver halide emulsions (B-21) to (B-28) of an average grain size of 0.42 μm were respectively prepared similarly to the silver halide emulsions (B-1) to (B-8) of Example 1, provided that K₄[Fe(CN)₆] of solutions (A2), (A2a) and (A2b) was replaced by an equimolar amount of K₄[Ru(CN)₆], and the contents of K₂[IrCl₆], K₂[IrBr₆], K₂[IrCl₅(H₂O)], K₂[IrCl₅(thiazole)] and K₄[Ru(CN)₆] of solutions (A2), (A2a) and (A2b) were each increased by a factor of 2.8 and the respective addition times of solutions (A1), (A2), (A2a), (A2b), (A3), (B1), (B2) and (B3) were each optimally varied.

Preparation of Silver Halide Emulsions (GG-21) to (GG-28)

Silver halide emulsions (GG-21) to (GG-28) of an average grain size of 0.36 μm were respectively prepared similarly to the silver halide emulsions (BB-1) to (BB-8) of Example 1, provided that K₄[Fe(CN)₆] of solutions (A2) and (A2c) was replaced by an equimolar amount of K₄[Ru(CN)₆], and the contents of K₂[IrCl₆], K₂[IrBr₆], K₂[IrCl₅(H₂O)], K₂[IrCl₅(thiazole)] and K₄[Ru(CN)₆] of solutions (A2) and (A2c) were each increased by a factor of 2.5 and the respective addition times of solutions (A1), (A2), (A2c), (A3), (B1), (B2) and (B3) were each optimally varied.

Preparation of Silver Halide Emulsions (R-21) to (R-28)

Silver halide emulsions (R-21) to (R-28) of an average grain size of 0.40 μm were respectively prepared similarly to the silver halide emulsions (B-1) to (B-8) of Example 1, provided that K₄[Fe(CN)₆] of solutions (A2), (A2a) and (A2b) was replaced by an equimolar amount of K₄[Ru(CN)₆], and the contents of K₂[IrCl₆], K₂[IrBr₆], K₂[IrCl₅(H₂O)], K₂[IrCl₅(thiazole)] and K₄[Ru(CN)₆] of solutions (A2), (A2a) and (A2b) were each increased by a factor of 3.2 and the respective addition times of solutions (A1), (A2), (A2a), (A2b), (A3), (B1), (B2) and (B3) were each optimally varied.

Preparation of Silver Halide Emulsions (RR-21) to (RR-28)

Silver halide emulsions (RR-21) to (RR-28) of an average grain size of 0.33 μm were respectively prepared similarly to the silver halide emulsions (BB-1) to (BB-8) of Example 1, provided that K₄[Fe(CN)₆] of solutions (A2) and (A2c) was replaced by an equimolar amount of K₄[Ru(CN)₆], and the contents of K₂[IrCl₆], K₂[IrBr₆], K₂[IrCl₅(H₂O)], K₂[IrCl₅(thiazole)] and K₄[Ru(CN)₆] of solutions (A2) and (A2c) were each increased by a factor of 3.3 and the respective addition times of solutions (A1), (A2), (A2c), (A3), (B1), (B2) and (B3) were each optimally varied.

The thus prepared silver halide emulsions (B-21) to (B-28), (BB-21) to (BB-28), (G-21) to (G-28), (GG-21) to (GG-28), (R-21) to (R-28), and (RR-21) to (RR-28) were each composed of cubic silver halide grains, accounting for 99% by number of total silver halide grains. Characteristics of the respective emulsions are shown in Table 7, in which the respective abbreviations are the same as those of Table 1.

TABLE 7

| Silver | Average | C.V.*¹ | | | | | | |
|---|---|---|---|---|---|---|---|---|
| Halide | Grain | of | | | | | | |
| Emulsion | Size | Grain | Halide Composition (mol %) | | | | | |
| No. | (μm) | Size | Chloride | Bromide | Iodide | *A | *B | Characteristic |
| B-21 | 0.50 | 0.05 | 99.70 | 0.30 | 0 | 33 | — | — |
| B-22 | 0.50 | 0.05 | 99.68 | 0.30 | 0.02 | 33 | 18 | — |
| B-23 | 0.50 | 0.05 | 99.66 | 0.30 | 0.04 | 33 | 17 | 1 |
| B-24 | 0.50 | 0.05 | 99.60 | 0.30 | 0.10 | 33 | 16 | 1 |
| B-25 | 0.50 | 0.05 | 99.40 | 0.50 | 0.10 | 33 | 16 | 1 |
| B-26 | 0.50 | 0.05 | 98.40 | 1.50 | 0.10 | 18 | 16 | 2 |
| B-27 | 0.50 | 0.05 | 97.30 | 2.60 | 0.10 | 14 | 16 | 2 |
| B-28 | 0.50 | 0.05 | 97.30 | 2.60 | 0.10 | 14 | 16 | 2 |
| BB-21 | 0.44 | 0.06 | 99.70 | 0.30 | 0 | 34 | — | — |
| BB-22 | 0.44 | 0.06 | 99.65 | 0.30 | 0.05 | 34 | 17 | 1 |
| BB-23 | 0.44 | 0.06 | 99.67 | 0.30 | 0.03 | 34 | 18 | 1 |
| BB-24 | 0.44 | 0.06 | 99.20 | 0.80 | 0 | 28 | — | 3 |
| BB-25 | 0.44 | 0.06 | 99.17 | 0.80 | 0.03 | 28 | 18 | 2 |
| BB-26 | 0.44 | 0.06 | 98.47 | 1.50 | 0.03 | 18 | 18 | 2 |
| BB-27 | 0.44 | 0.06 | 97.47 | 2.50 | 0.03 | 14 | 18 | 2 |
| BB-28 | 0.44 | 0.06 | 97.47 | 2.50 | 0.03 | 14 | 18 | 2 |
| G-21 | 0.42 | 0.06 | 99.70 | 0.30 | 0 | 34 | — | — |
| G-22 | 0.42 | 0.06 | 99.68 | 0.30 | 0.02 | 34 | 18 | — |
| G-23 | 0.42 | 0.06 | 99.66 | 0.30 | 0.04 | 34 | 17 | 1 |
| G-24 | 0.42 | 0.06 | 99.60 | 0.30 | 0.10 | 34 | 15 | 1 |
| G-25 | 0.42 | 0.06 | 99.40 | 0.50 | 0.10 | 34 | 15 | 1 |
| G-26 | 0.42 | 0.06 | 98.40 | 1.50 | 0.10 | 18 | 15 | 2 |
| G-27 | 0.42 | 0.06 | 97.30 | 2.60 | 0.10 | 15 | 15 | 2 |
| G-28 | 0.42 | 0.06 | 97.30 | 2.60 | 0.10 | 15 | 15 | 2 |
| GG-21 | 0.36 | 0.06 | 99.70 | 0.30 | 0 | 35 | — | — |
| GG-22 | 0.36 | 0.06 | 99.65 | 0.30 | 0.05 | 35 | 18 | 1 |
| GG-23 | 0.36 | 0.06 | 99.67 | 0.30 | 0.03 | 35 | 18 | 1 |
| GG-24 | 0.36 | 0.06 | 99.20 | 0.80 | 0 | 27 | — | 3 |
| GG-25 | 0.36 | 0.06 | 99.17 | 0.80 | 0.03 | 27 | 18 | 2 |
| GG-26 | 0.36 | 0.06 | 98.47 | 1.50 | 0.03 | 18 | 18 | 2 |
| GG-27 | 0.36 | 0.06 | 97.47 | 2.50 | 0.03 | 15 | 18 | 2 |
| GG-28 | 0.36 | 0.06 | 97.47 | 2.50 | 0.03 | 15 | 18 | 2 |
| R-21 | 0.40 | 0.06 | 99.70 | 0.30 | 0 | 34 | — | — |
| R-22 | 0.40 | 0.06 | 99.68 | 0.30 | 0.02 | 34 | 18 | — |
| R-23 | 0.40 | 0.06 | 99.66 | 0.30 | 0.04 | 34 | 17 | 1 |
| R-24 | 0.40 | 0.06 | 99.60 | 0.30 | 0.10 | 34 | 16 | 1 |
| R-25 | 0.40 | 0.06 | 99.40 | 0.50 | 0.10 | 34 | 16 | 1 |
| R-26 | 0.40 | 0.06 | 98.40 | 1.50 | 0.10 | 19 | 16 | 2 |
| R-27 | 0.40 | 0.06 | 97.30 | 2.60 | 0.10 | 14 | 16 | 2 |
| R-28 | 0.40 | 0.06 | 97.30 | 2.60 | 0.10 | 14 | 15 | 2 |
| RR-21 | 0.33 | 0.06 | 99.70 | 0.30 | 0 | 34 | — | — |
| RR-22 | 0.33 | 0.06 | 99.65 | 0.30 | 0.05 | 34 | 18 | 1 |
| RR-23 | 0.33 | 0.06 | 99.67 | 0.30 | 0.03 | 34 | 19 | 1 |
| RR-24 | 0.33 | 0.06 | 99.20 | 0.80 | 0 | 26 | — | 3 |
| RR-25 | 0.33 | 0.06 | 99.17 | 0.80 | 0.03 | 26 | 19 | 2 |
| RR-26 | 0.33 | 0.06 | 98.47 | 1.50 | 0.03 | 18 | 19 | 2 |
| PR-27 | 0.33 | 0.06 | 97.47 | 2.50 | 0.03 | 15 | 19 | 2 |
| RR-28 | 0.33 | 0.06 | 97.47 | 2.50 | 0.03 | 15 | 19 | 2 |

*¹coefficient of variation

Preparation of Blue-Sensitive Emulsions (B-21a), (B-21b), (B-22a), (B-23a), (B-24a), (B-25a), (B-26a), (B-27a), (B-28a) and (B-28b)

Blue-sensitive emulsions (B-21a), (B-21b), (B-22a), (B-23a), (B-24a), (B-25a), (B-26a), (B-27a), (B-28a) and (B-28b) were prepared similarly to the blue-sensitive silver halide emulsions (B-1a), (B-1b), (B-2a), (B-3a), (B-4a), (B-5a), (B-6a), (B-7a), (B-8a) and (B-8b) of Example 1, except that the used silver halide emulsions were replaced by silver halide emulsion (B-21), (B-21), (B-22), (B-23), (B-24), (B-25), (B-26), (B-27), (B-28) and (B-28), respectively, and taking into account the increase of the silver halide grain surface area per weight of silver along with change of the average silver halide grain size of from 0.58 μm to 0.50 μm, addition amounts of sodium thiosulfate, triphenylphosphine selenide, chloroauric acid, and sensitizing dyes (BS-1) and (BS-2) were each varied so that their addition amounts per unit surface area remained the same.

Preparation of Blue-Sensitive Emulsions (BB-21a), (BB-21b), (BB-22a), (BB-23a), (BB-24a), (BB-25a), (BB-26a), (BB-27a), (BB-28a) and (BB-28b)

Blue-sensitive emulsions (BB-21a), (BB-21b), (BB-22a), (BB-23a), (BB-24a), (BB-25a), (BB-26a), (BB-27a), (BB-28a) and (BB-28b) were prepared similarly to the blue-sensitive silver halide emulsions (BB-1a), (BB-1b), (BB-2a), (BB-3a), (BB-4a), (BB-5a), (BB-6a), (BB-7a), (BB-8a) and (BB-8b) of Example 1, except that the used silver halide emulsions were each replaced by silver halide emulsion (BB-21), (BB-21), (BB-22), (BB-23), (BB-24), (BB-25), (BB-26), (BB-27), (BB-28) and (BB-28), respectively, and taking into account the increase of the silver halide grain surface area per weight of silver along with change of the average silver halide grain size of from 0.48 μm to 0.44 μm, addition amounts of sodium thiosulfate, triphenylphosphine selenide, chloroauric acid, and sensitizing dyes (BS-1) and (BS-2) were each varied so that their addition amounts per unit surface area remained the same.

Preparation of Green-Sensitive Emulsions (G-21a), (G-21b), (G-22a), (G-23a), (G-24a), (G-25a), (G-26a), (G-27a), (G-28a) and (G-28b)

Green-sensitive emulsions (G-21a), (G-21b), (G-22a), (G-23a), (G-24a), (G-25a), (G-26a), (G-27a), (G-28a) and (G-28b) were prepared similarly to the green-sensitive silver halide emulsions (G-1a), (G-1b), (G-2a), (G-3a), (G-4a), (G-5a), (G-6a), (G-7a), (G-8a) and (G-8b) of Example 1, except that the used silver halide emulsions were replaced by silver halide emulsion (G-21), (G-21), (G-22), (G-23), (G-24), (G-25), (G-26), (G-27), (G-28) and (G-28), respectively, and taking into account the increase of the silver halide grain surface area per weight of silver along with change of the average silver halide grain size of from 0.50 μm to 0.42 μm, addition amounts of sodium thiosulfate, triphenylphosphine selenide, chloroauric acid, and sensitizing dye (GS-1) were each varied so that their addition amounts per unit surface area respectively remained the same.

Preparation of Green-Sensitive Emulsions (GG-21a), (GG-21b), (GG-22a), (GG-23a), (GG-24a), (GG-25a), (GG-26a), (GG-27a), (GG-28a) and (GG-28b)

Green-sensitive emulsions (GG-21a), (GG-21b), (GG-22a), (GG-23a), (GG-24a), (GG-25a), (GG-26a), (GG-27a), (GG-28a) and (GG-28b) were prepared similarly to the green-sensitive silver halide emulsions (GG-1a), (GG-1b), (GG-2a), (GG-3a), (GG-4a), (GG-5a), (GG-6a), (GG-7a), (GG-8a) and (GG-8b) of Example 1, except that the used silver halide emulsions were replaced by silver halide emulsion (GG-21), (GG-21), (GG-22), (GG-23), (GG-24), (GG-25), (GG-26), (GG-27), (GG-28) and (GG-28), respectively, and taking into account the increase of the silver halide grain surface area per weight of silver along with change of the average silver halide grain size of from 0.42 μm to 0.36 μm, addition amounts of sodium thiosulfate, triphenylphosphine selenide, chloroauric acid, and sensitizing dye (GS-1) were each varied so that their addition amounts per unit surface area respectively remained the same.

Preparation of Red-Sensitive Emulsions (R-21a), (R-21b), (R-22a), (R-23a), (R-24a), (R-25a), (R-26a), (R-27a), (R-28a) and (R-28b)

Red-sensitive emulsions (R-21a), (R-21b), (R-22a), (R-23a), (R-24a), (R-25a), (R-26a), (R-27a), (R-28a) and (R-28b) were prepared similarly to the red-sensitive silver halide emulsions (R-1a), (R-1b), (R-2a), (R-3a), (R-4a), (R-5a), (R-6a), (R-7a), (R-8a) and (R-8b) of Example 1, except that the used silver halide emulsions were replaced by silver halide emulsion (R-21), (R-21), (R-22), (R-23), (R-24), (R-25), (R-26), (R-27), (R-28) and (R-28), respectively, and taking into account the increase of the silver halide grain surface area per weight of silver along with change of the average silver halide grain size of from 0.45 μm to 0.40 μm, addition amounts of sodium thiosulfate, triphenylphosphine selenide, chloroauric acid, and sensitizing dyes (RS-1) and (RS-2) were each varied so that their addition amounts per unit surface area respectively remained the same.

Preparation of Red-Sensitive Emulsions (RR-21a), (RR-21b), (RR-22a), (RR-23a), (RR-24a), (RR-25a), (RR-26a), (RR-27a), (RR-28a) and (RR-28b)

Red-sensitive emulsions (RR-21a), (RR-21b), (RR-22a), (RR-23a), (RR-24a), (RR-25a), (RR-26a), (RR-27a), (RR-28a) and (RR-28b) were prepared similarly to the red-sensitive silver halide emulsions (RR-1a), (RR-1b), (RR-2a), (RR-3a), (RR-4a), (RR-5a), (RR-6a), (RR-7a), (RR-8a) and (RR-8b) of Example 1, except that the used silver halide emulsions were replaced by silver halide emulsion (R-21), (R-21), (R-22), (R-23), (R-24), (R-25), (R-26), (R-27), (R-28) and (R-28), respectively, and taking into account the increase of the silver halide grain surface area per weight of silver along with change of the average silver halide grain size of from 0.38 μm to 0.33 μm, addition amounts of sodium thiosulfate, triphenylphosphine selenide, chloroauric acid, and sensitizing dyes (RS-1) and (RS-2) were each varied so that their addition amounts per unit surface area respectively remained the same.

In the foregoing preparation of the respective red-sensitive silver halide emulsions, 2.0×10⁻³ mol/mol.AgX of SS-1 was added at the time of completion of the preparation.

Further, in the preparation of the respective light-sensitive silver halide emulsions, the interval of additions sensitizing dyes and chemical sensitizers, the chemical sensitization time were optimally adjusted so that the obtained silver halide color photographic materials each exhibit the values of the effective tone range (VE) shown in Table 8.

Preparation of Silver Halide Color Photographic Material

Preparation of Samples 301 to 311

Photographic material samples 301 to 311 were prepared similarly to sample 101 of Example 1, except that silver halide emulsions of the 1st, 3rd and 5th layers were varied as shown in Table 8.

### Evaluation of Characteristics

Similarly to Example 1, the thus prepared samples were evaluated with respect to radiation resistance, storage stability and process stability. The samples were further evaluated with respect to the effective tone range, in the following manner. The obtained results of magenta images are shown in Table 6. The radiation resistance was represented by a relative value, based on the radiation resistance of sample 301 being 100.

Determination of Effective Tone Range (VE) and ΔVE

The prepared samples were each evaluated according to the following procedure (Evaluation S) to determine effective tone range (VE).

Evaluation S

The photographic material sample was subjected to scanning exposure using a semiconductor laser (oscillation wavelength of 650 nm), He—Ne gas laser (oscillation wavelength of 544 nm) and Ar gas laser (oscillation wavelength of 458 nm) as a light source. Using a scanning exposure apparatus which was so adjusted that overlap between rasters was 25%, each laser beam was allowed to conduct main-scanning onto the sample, while modulating the light amount by means of AOM, based on image data and allowing the beam to be reflected by a polygon mirror, and the photographic material sample was allowed to transport vertically to the main-scanning direction (sub-scanning). The photographic material was successively exposed so as to obtain 1 cm×1 cm square patches, while the main scanning was conducted with adjusting exposures of respective colors so that gray was stepwise reproduced from the minimum density to the maximum density. At 1 hr after completion of exposure, processing was carried out according to the foregoing process 1. Respective steps of the thus obtained gray patch images were subjected to densitometry using densitometer PDA-65 (produced by Konica Minolta Photo Imaging Inc.) to measure reflection densities. Then, a red light reflection density (D) vs. red laser light exposure (Log E), green light reflection density (D) vs. green laser light exposure (Log E) and blue light reflection density (D) vs. blue laser light exposure (Log E) for every step were plotted to obtain characteristic curves for respective colors. Subsequently, differential values of density (D) vs. exposure (Log E) for respective steps were calculated with respect to each of three colors to determine the exposure region exhibiting a point gamma of 1.0 or more (i.e., effective tone range (VE). Further, the difference (ΔVE) between a VE value of an image forming layer having the maximum of the effective tone range (VE) values and that of an image forming layer having the minimum of the effective tone range (VE) values was determined. Furthermore, an average gradation over the range of reflection densities of 0.8 to 1.8 was also determined.

TABLE 8

| | Silver Halide Emulsion | | | | | | | | | |
|---|---|---|---|---|---|---|---|---|---|---|
| | 1st Layer | 3rd Layer | 5th Layer | Effective Tone | | | | | | |
| | (Blue- | (Green- | (Red- | Range (VE) | | | | Evaluation Result | | |
| Sample | sensitive | sensitive | sensitive | Yellow | Magenta | Cyan | | Radiation | Storage | Process |
| No. | Layer) | Layer) | Layer) | Image | Image | Image | ΔVE | Resistance | Stability | Stability |
| 301 | B-21a/BB-21a | G-21a/GG-21a | R-21a/RR-21a | 0.73 | 0.86 | 0.72 | 0.14 | 100 | 71 | 72 |
| 302 | B-21b/BB-21b | G-21b/GG-21b | R-21b/RR-21b | 0.77 | 0.84 | 0.75 | 0.09 | 97 | 71 | 74 |
| 303 | B-22a/BB-22a | G-22a/GG-22a | R-22a/RR-22a | 0.79 | 0.86 | 0.77 | 0.09 | 92 | 76 | 77 |
| 304 | B-21a/BB-23a | G-21a/GG-23a | R-21a/RR-23a | 0.83 | 0.90 | 0.85 | 0.07 | 92 | 74 | 78 |
| 305 | B-23a/BB-21a | G-23a/GG-21a | R-23a/RR-21a | 0.85 | 0.90 | 0.87 | 0.05 | 75 | 89 | 92 |
| 306 | B-24a/BB-24a | G-24a/GG-24a | R-24a/RR-24a | 0.84 | 0.89 | 0.84 | 0.05 | 73 | 89 | 93 |
| 307 | B-25a/BB-25a | G-25a/GG-25a | R-25a/RR-25a | 0.85 | 0.90 | 0.88 | 0.05 | 72 | 93 | 95 |
| 308 | B-26a/BB-26a | G-26a/GG-26a | R-26a/RR-26a | 0.86 | 0.91 | 0.86 | 0.05 | 70 | 94 | 95 |
| 309 | B-27a/BB-27a | G-27a/GG-27a | R-27a/RR-27a | 0.85 | 0.90 | 0.86 | 0.05 | 70 | 95 | 96 |
| 310 | B-28a/BB-28a | G-28a/GG-28a | R-28a/RR-28a | 0.84 | 0.89 | 0.87 | 0.05 | 69 | 95 | 97 |
| 311 | B-28b/BB-28b | G-28b/GG-28b | R-28b/RR-28b | 0.84 | 0.89 | 0.88 | 0.05 | 69 | 95 | 97 |

As apparent from the results shown in Table 8, it was proved that samples having constitution of silver halide emulsions relating to the invention and the characteristic value (VE) as defined in the invention exhibit superior radiation resistance and improved storage stability and process stability with respect to magenta images, as compared to comparative samples. As a result of evaluation of the blue-sensitive layer (yellow image) and the red-sensitive layer (cyan image), similar results were also obtained.

### Example 4

### Preparation of Silver Halide Emulsion

Preparation of Silver Halide Emulsion (B-31)

To 1.5 liter of an aqueous 2% solution of deionized ossein gelatin (having a calcium content of 10 ppm), maintained at 40° C. were added solutions (A21) and (B21) for 15 min, while controlling the pAg and pH at 7.3 and 5.8, respectively with vigorously stirring using a stirring mixer described in JP-A No. 62-160128. Subsequently, solutions (A22) and (B22) were added for 80 min with controlling the pAg and pH at 8.0 and 5.5, respectively. Then, solutions (A23) and (B23) were added over 20 min. with controlling the pAg and pH at 8.0 and 5.5, respectively. The pAg was controlled in accordance with the method described in JP-A No. 59-45437 and the pH was controlled using aqueous sulfuric acid or sodium hydroxide solution.

Solution (A21)

| | | |
|---|---|---|
| Sodium chloride | 3.43 | g |
| Potassium bromide | 0.021 | g |
| Water to make | 200 | ml |

Solution (A22)

| | | |
|---|---|---|
| Sodium chloride | 72.0 | g |
| K2[IrCl₆] | 2.3 × 10⁻⁸ | mol/mol AgX |
| K2[IrBr₆] | 7.0 × 10⁻⁹ | mol/mol AgX |
| K4[Fe(CN)₆] | 6.6 × 10⁻⁶ | mol/mol AgX |
| Potassium bromide | 1.31 | g |
| Water to make | 420 | ml |

Solution (A23)

| | | |
|---|---|---|
| Sodium chloride | 30.9 | g |
| Potassium bromide | 0.19 | g |
| Water to make | 180 | ml |

Solution (B21)

| | | |
|---|---|---|
| Silver nitrate | 10 | g |
| Water to make | 200 | ml |

Solution (B22)

| | | |
|---|---|---|
| Silver nitrate | 210 | g |
| Water to make | 420 | ml |

Solution (B23)

| | | |
|---|---|---|
| Silver nitrate | 90 | g |
| Water to make | 180 | ml |

After completing addition, an aqueous 15% solution containing 30 g of chemically modified gelatin (modification rate of 95%), in which an amino group of gelatin was phenylcarbamoylated, was added to perform desalting in accordance with the method described in JP-A No. 5-72658, and an aqueous gelatin solution was further added thereto to obtain silver halide emulsion (B-31) comprising monodisperse cubic grains having an average grain size of 0.60 μm.

Preparation of Silver Halide Emulsion (B-32)

Silver halide emulsion (B-32) was prepared similarly to the foregoing silver halide emulsion (B-31), provided that the solution (A22) was replaced by the following solution (A22a) and the following solution (C21) was further added at the time when 30% of the solution (B23) was added.

Solution (A22a)

| | | |
|---|---|---|
| Sodium chloride | 72.0 | g |
| K₂[IrCl₆] | 4.1 × 10⁻⁹ | mol/mol AgX |
| K₂[IrBr₆] | 3.0 × 10⁻⁹ | mol/mol AgX |
| K₂[IrCl₅(H₂O)] | 2.7 × 10⁻⁷ | mol/mol AgX |
| K₂[IrCl₅(thiazole)] | 1.5 × 10⁻⁸ | mol/mol AgX |
| K₄[Fe(CN)₆] | 8.0 × 10⁻⁶ | mol/mol AgX |
| Compound (S-2-5) | 2.0 × 10⁻⁵ | mol/mol AgX |
| Potassium bromide | 1.31 | g |
| Water to make | 420 | ml |

Solution (C21)

| | | |
|---|---|---|
| Potassium bromide | 2.39 | g |
| Water to make | 200 | ml |

Preparation of Silver Halide Emulsion (B-33)

Silver halide emulsion (B-33) was prepared similarly to the foregoing silver halide emulsion (B-32), provided that the following solution (D21) was further added at the time when 60% of the solution (B23) was added.

Solution (D21)

| | |
|---|---|
| Potassium iodide | 0.24 g |
| Water to make | 70 ml |

Preparation of Silver Halide Emulsion (BB-31)

Silver halide emulsion (BB-31) of an average grain size of 0.52 μm was prepared similarly to the foregoing silver halide emulsion (B-31), provided that the contents of K₂[IrCl₆], K₂[IrBr₆] and K₄[Fe(CN)₆] of the solution (A22) were each increased by a factor of 1.6 and the respective addition times of solutions (A21), (A22), (A23), (B21), (B22) and (B23) were optimally varied.

Preparation of Silver Halide Emulsion (BB-32)

Silver halide emulsion (BB-32) of an average grain size of 0.52 μm was prepared similarly to the foregoing silver halide emulsion (BB-31), provided that the solution (C21) was added at the time when 20% of the solution (B23) was added.

Preparation of Silver Halide Emulsion (BB-33)

Silver halide emulsion (BB-33) was prepared similarly to the foregoing silver halide emulsion (BB-31), provided that the solution (A22) was replaced by the following solution (A22b) and the following solution (C22) was further added at the time when 20% of the solution (B23) was added.

Solution (A22b)

| | | |
|---|---|---|
| Sodium chloride | 72.0 | g |
| K₂[IrCl₆] | 6.2 × 10⁻⁹ | mol/mol AgX |
| K₂[IrBr₆] | 4.4 × 10⁻⁹ | mol/mol AgX |
| K₂[IrCl₅(H₂O)] | 4.6 × 10⁻⁷ | mol/mol AgX |
| K₂[IrCl₅(thiazole)] | 2.5 × 10⁻⁸ | mol/mol AgX |
| K₄[Fe(CN)₆] | 1.3 × 10⁻⁵ | mol/mol AgX |
| Compound (S-2-5) | 2.0 × 10⁻⁵ | mol/mol AgX |
| Potassium bromide | 1.31 | g |
| Water to make | 420 | ml |

Solution (C22)

| | | |
|---|---|---|
| Potassium bromide | 3.26 | g |
| Water to make | 260 | ml |

Preparation of Silver Halide Emulsion (BB-34)

Silver halide emulsion (BB-34) was prepared similarly to the foregoing silver halide emulsion (BB-33), provided that the following solution (D22) was further added at the time when 60% of the solution (B23) was added.

Solution (D22)

| | |
|---|---|
| Potassium iodide | 0.15 g |
| Water to make | 80 ml |

Preparation of Silver Halide Emulsion (G-31)

Silver halide emulsion (G-31) of an average grain size of 0.50 μm was prepared similarly to the foregoing silver halide emulsion (B-31), provided that the contents of K₂[IrCl₆], K₂[IrBr₆] and K₄[Fe(CN)₆] of the solution (A32) were each increased by a factor of 1.7 and the respective addition times of solutions (A21), (A22), (A23), (B21), (B22) and (B23) were optimally varied.

Preparation of Silver Halide Emulsion (G-32)

Silver halide emulsion (G-32) was prepared similarly to the foregoing silver halide emulsion (G-31), provided that the following solution (C23) was further added at the time when 20% of the solution (B23) was added.

Solution (C23)

| | |
|---|---|
| Potassium bromide | 4.56 g |
| Water to make | 340 ml |

Preparation of Silver Halide Emulsion (G-33)

Silver halide emulsion (G-33) was prepared similarly to the foregoing silver halide emulsion (G-32), provided that the solution (A22) was replaced by the following solution (A22c).

Solution (A22c)

| | | |
|---|---|---|
| Sodium chloride | 72.0 | g |
| K₂[IrCl₆] | 7.2 × 10⁻⁹ | mol/mol AgX |
| K₂[IrBr₆] | 5.0 × 10⁻⁹ | mol/mol AgX |
| K₂[IrCl₅(H₂O)] | 5.3 × 10⁻⁷ | mol/mol AgX |
| K₂[IrCl₅(thiazole)] | 2.9 × 10⁻⁸ | mol/mol AgX |
| K₄[Fe(CN)₆] | 1.5 × 10⁻⁵ | mol/mol AgX |
| Compound (S-2-5) | 2.0 × 10⁻⁵ | mol/mol AgX |
| Potassium bromide | 1.31 | g |
| Water to make | 420 | ml |

Preparation of Silver Halide Emulsion (G-34)

Silver halide emulsion (G-34) was prepared similarly to the foregoing silver halide emulsion (G-33), provided that the solution (C22) was further added at the time when 60% of the solution (B23) was added.

Preparation of Silver Halide Emulsion (GG-31)

Silver halide emulsion (GG-31) of an average grain size of 0.46 μm was prepared similarly to the foregoing silver halide emulsion (B-31), provided that the contents of K₂[IrCl₆], K₂[IrBr₆] and K₄[Fe(CN)₆] of the solution (A22) were each increased by a factor of 1.3 and the respective addition times of solutions (A21), (A22), (A23), (B21), (B22) and (B23) were optimally varied.

Preparation of Silver Halide Emulsion (GG-32)

Silver halide emulsion (GG-32) was prepared similarly to the foregoing silver halide emulsion (GG-31), provided that the following solution (C24) was further added at the time when 20% of the solution (B23) was added.

Solution (C24)

| | | |
|---|---|---|
| Potassium bromide | 5.43 | g |
| Water to make | 350 | ml |

Preparation of Silver Halide Emulsion (GG-33)

Silver halide emulsion (GG-33) was prepared similarly to the foregoing silver halide emulsion (GG-32), provided that the solution (A22) was replaced by the following solution (A22d).

Solution (A22d)

| | | |
|---|---|---|
| Sodium chloride | 72.0 | g |
| K₂[IrCl₆] | 8.0 × 10⁻⁹ | mol/mol AgX |
| K₂[IrBr₆] | 5.9 × 10⁻⁹ | mol/mol AgX |
| K₂[IrCl₅(H₂O)] | 6.3 × 10⁻⁷ | mol/mol AgX |
| K₂[IrCl₅(thiazole)] | 3.4 × 10⁻⁸ | mol/mol AgX |
| K₄[Fe(CN)₆] | 1.7 × 10⁻⁵ | mol/mol AgX |
| Compound (S-2-5) | 4.0 × 10⁻⁵ | mol/mol AgX |
| Potassium bromide | 1.31 | g |
| Water to make | 420 | ml |

Preparation of Silver Halide Emulsions (R-31) to (R-34)

Silver halide emulsions (R-31) to (R-34) of an average grain size of 0.44 μm prepared similarly to the foregoing silver halide emulsions (G-31) to (G-34), provided that the contents of K₂[IrCl₆], K₂[IrBr₆], K₂[IrCl₅(H₂O)], K₂[IrCl₅(thiazole)] and K₄[Fe(CN)₆] of solutions (A22) and (A22c) were each increased by a factor of 1.5, and the respective addition times of solutions (A21), (A22), (A22c), (A23), (B21), (B22) and (B23) were optimally varied.

Preparation of Silver Halide Emulsions (RR-31)

Silver halide emulsions (RR-31) of an average grain size of 0.36 μm prepared similarly to the foregoing silver halide emulsions (B-31), provided that the contents of K₂[IrCl₆], K₂[IrBr₆] and K₄[Fe(CN)₆] of solutions (A22) were each increased by a factor of 4.7, and the respective addition times of solutions (A21), (A22), (A23), (B21), (B22) and (B23) were optimally varied.

Preparation of Silver Halide Emulsion (RR-32)

Silver halide emulsion (RR-32) was prepared similarly to the foregoing silver halide emulsion (RR-31), provided that the following solution (C25) was further added at the time when 20% of the solution (B23) was added.

Solution (C25)

| | | |
|---|---|---|
| Potassium bromide | 6.30 | g |
| Water to make | 350 | ml |

Preparation of Silver Halide Emulsion (RR-33)

Silver halide emulsion (RR-33) was prepared similarly to the foregoing silver halide emulsion (RR-32), provided that the solution (A22) was replaced by the following solution (A22e).

Solution (A22e)

| | | |
|---|---|---|
| Sodium chloride | 72.0 | g |
| K₂[IrCl₆] | 1.3 × 10⁻⁸ | mol/mol AgX |
| K₂[IrBr₆] | 1.2 × 10⁻⁸ | mol/mol AgX |
| K₂[IrCl₅(H₂O)] | 1.2 × 10⁻⁶ | mol/mol AgX |
| K₂[IrCl₅(thiazole)] | 6.6 × 10⁻⁸ | mol/mol AgX |
| K₄[Fe(CN)₆] | 3.3 × 10⁻⁵ | mol/mol AgX |
| Compound (S-2-5) | 4.0 × 10⁻⁵ | mol/mol AgX |
| Potassium bromide | 1.31 | g |
| Water to make | 420 | ml |

The thus prepared silver halide emulsions (B-31) to (B-33), (BB-31) to (BB-34), (G-31) to (G-34), (GG-31) to (GG-33), (R-31) to (R-34), and (RR-31) to (RR-33) were each composed of cubic silver halide grains, accounting for 99% by number of total silver halide grains. Characteristics of the respective emulsions are shown in Table 9, in which the abbreviations of Table 9 are the same as those of Table 1.

TABLE 9

| Silver | Average | C.V.*¹ | | | | | | |
|---|---|---|---|---|---|---|---|---|
| Halide | Grain | of | | | | | | |
| Emulsion | Size | grain | Halide Composition (mol %) | | | | | |
| No. | (μm) | Size | Chloride | Bromide | Iodide | *A | *B | Characteristic |
| B-31 | 0.60 | 0.05 | 99.30 | 0.70 | 0 | 31 | — | — |
| B-32 | 0.60 | 0.05 | 98.20 | 1.80 | 0 | 18 | — | 3 |
| B-33 | 0.60 | 0.05 | 98.12 | 1.80 | 0.08 | 18 | 17 | 2 |
| BB-31 | 0.52 | 0.05 | 99.30 | 0.70 | 0 | 32 | — | — |
| BB-32 | 0.52 | 0.05 | 98.20 | 1.80 | 0 | 18 | — | 3 |
| BB-33 | 0.52 | 0.05 | 97.80 | 2.20 | 0 | 16 | — | 3 |
| BB-34 | 0.52 | 0.05 | 97.75 | 2.20 | 0.05 | 16 | 18 | 2 |
| G-31 | 0.50 | 0.05 | 99.30 | 0.70 | 0 | 32 | — | — |
| G-32 | 0.50 | 0.05 | 97.20 | 2.80 | 0 | 15 | — | 3 |
| G-33 | 0.50 | 0.05 | 97.20 | 2.80 | 0 | 15 | — | 3 |
| G-34 | 0.50 | 0.05 | 97.15 | 2.80 | 0.05 | 15 | 18 | 2 |
| GG-31 | 0.46 | 0.06 | 99.30 | 0.70 | 0 | 33 | — | — |
| GG-32 | 0.46 | 0.06 | 96.80 | 3.20 | 0 | 14 | — | 3 |
| GG-33 | 0.46 | 0.06 | 96.80 | 3.20 | 0 | 14 | — | 3 |
| R-31 | 0.44 | 0.06 | 99.30 | 0.70 | 0 | 32 | — | — |
| R-32 | 0.44 | 0.06 | 97.20 | 2.80 | 0 | 15 | — | 3 |
| R-33 | 0.44 | 0.06 | 97.20 | 2.80 | 0 | 15 | — | 3 |
| R-34 | 0.44 | 0.06 | 97.15 | 2.80 | 0.05 | 15 | 18 | 2 |
| RR-31 | 0.36 | 0.06 | 99.30 | 0.70 | 0 | 33 | — | — |
| RR-32 | 0.36 | 0.06 | 96.40 | 3.60 | 0 | 14 | — | 3 |
| RR-33 | 0.36 | 0.06 | 96.40 | 3.60 | 0 | 14 | — | 3 |

*¹coefficient of variation

Preparation of Blue-Sensitive Emulsion (B-31a)

Blue-sensitive silver halide emulsion (B-31a) was prepared similarly to the blue-sensitive silver halide emulsion (B-1a) of Example 1, except that silver halide emulsion (B-1) was replaced by silver halide emulsion (B-31), and taking into account the decrease of a silver halide grain surface area per weight of silver along with change of the average silver halide grain size of from 0.58 μm to 0.60 μm, addition amounts of sodium thiosulfate, chloroauric acid, and sensitizing dyes (BS-1) and (BS-2) were each varied so that their addition amounts per unit surface area respectively remained the same.

Preparation of Blue-Sensitive Emulsions (B-31b), (B-32a) and (B-33a)

Blue-sensitive silver halide emulsions (B-31b), (B-32a) and (B-33a) were prepared similarly to the blue-sensitive silver halide emulsion (B-1b) of Example 1, except that silver halide emulsion (B-1) was replaced by silver halide emulsion (B-31), (B-32) or (B-33), and taking into account the decrease of a silver halide grain surface area per weight of silver along with change of the average silver halide grain size of from 0.58 μm to 0.60 μm, addition amounts of sodium thiosulfate, chloroauric acid, and sensitizing dyes (BS-1) and (BS-2) were each varied so that their addition amounts per unit surface area respectively remained the same.

Preparation of Blue-Sensitive Emulsion (B-33b)

Blue-sensitive silver halide emulsion (B-33b) was prepared similarly to the blue-sensitive silver halide emulsion (B-8b) of Example 1, except that silver halide emulsion (B-8) was replaced by silver halide emulsion (B-33), and taking into account the decrease of a silver halide grain surface area per weight of silver along with change of the average silver halide grain size of from 0.58 μm to 0.60 μm, addition amounts of sodium thiosulfate, chloroauric acid, and sensitizing dyes (BS-1) and (BS-2) were each varied so that their addition amounts per unit surface area respectively remained the same.

Preparation of Blue-Sensitive Emulsion (BB-31a)

Blue-sensitive silver halide emulsion (BB-31a) was prepared similarly to the blue-sensitive silver halide emulsion (BB-1a) of Example 1, except that silver halide emulsion (BB-1) was replaced by silver halide emulsion (BB-31), and taking into account the decrease of a silver halide grain surface area per weight of silver along with change of the average silver halide grain size of from 0.48 μm to 0.52 μm, addition amounts of sodium thiosulfate, chloroauric acid, and sensitizing dyes (BS-1) and (BS-2) were each varied so that their addition amounts per unit surface area respectively remained the same.

Preparation of Blue-Sensitive Emulsions (BB-31b), and (BB-32a) to (BB-34a)

Blue-sensitive silver halide emulsions (BB-31b), and (BB-32a) to (BB-34a) were prepared similarly to the blue-sensitive silver halide emulsion (BB-1b) of Example 1, except that silver halide emulsion (BB-1) was replaced by silver halide emulsion (BB-31), (BB-32), (BB-33) or (BB-34), and taking into account the decrease of a silver halide grain surface area per weight of silver along with change of the average silver halide grain size of from 0.48 μm to 0.52 μm, addition amounts of sodium thiosulfate, chloroauric acid, and sensitizing dyes (BS-1) and (BS-2) were each varied so that their addition amounts per unit surface area respectively remained the same.

Preparation of Blue-Sensitive Emulsion (BB-34b)

Blue-sensitive silver halide emulsion (BB-34b) was prepared similarly to the blue-sensitive silver halide emulsion (BB-8b) of Example 1, except that silver halide emulsion (BB-8) was replaced by silver halide emulsion (BB-34), and taking into account the decrease of a silver halide grain surface area per weight of silver along with change of the average silver halide grain size of from 0.48 μm to 0.52 μm, addition amounts of sodium thiosulfate, chloroauric acid, and sensitizing dyes (BS-1) and (BS-2) were each varied so that their addition amounts per unit surface area respectively remained the same.

Preparation of Green-Sensitive Emulsions (G-31a) and (G-32a)

Green-sensitive silver halide emulsions (G-31a) and (G-32a) were prepared similarly to the green-sensitive silver halide emulsion (G-1a) of Example 1, except that silver halide emulsion (G-1) was replaced by silver halide emulsion (G-31) or (G-32)

Preparation of Green-Sensitive Emulsions (G-31b), (G-32b), (G-33a) and (G-34a)

Green-sensitive silver halide emulsions (G-31b), (G-32b), (G-33a) and (G-34a) were prepared similarly to the green-sensitive silver halide emulsion (G-1b) of Example 1, except that silver halide emulsion (G-1) was replaced by each of silver halide emulsions (G-31) to (G-34).

Preparation of Green-Sensitive Emulsion (G-34b)

Green-sensitive silver halide emulsion (G-34b) was prepared similarly to the green-sensitive silver halide emulsion (G-8b) of Example 1, except that silver halide emulsion (G-8) was replaced by silver halide emulsion (G-34) or (G-32).

Preparation of Green-Sensitive Emulsion (GG-31a)

Green-sensitive silver halide emulsion (GG-31a) was prepared similarly to the green-sensitive silver halide emulsion (GG-1a) of Example 1, except that silver halide emulsion (GG-1) was replaced by silver halide emulsion (GG-31), and taking into account the decrease of a silver halide grain surface area per weight of silver along with change of the average silver halide grain size of from 0.42 μm to 0.46 μm, addition amounts of sodium thiosulfate, chloroauric acid, and sensitizing dye (GS-1) were each varied so that their addition amounts per unit surface area respectively remained the same.

Preparation of Green-Sensitive Emulsions (GG-31b), (G-32a) and (GG-33a)

Green-sensitive silver halide emulsions (GG-31b), (G-32a) and (GG-33a) were prepared similarly to the green-sensitive silver halide emulsion (GG-1b) of Example 1, except that silver halide emulsion (GG-1) was replaced by each of silver halide emulsions (GG-31) to (GG-33), and taking into account the decrease of a silver halide grain surface area per weight of silver along with change of the average silver halide grain size of from 0.42 μm to 0.46 μm, addition amounts of sodium thiosulfate, chloroauric acid, and sensitizing dye (GS-1) were each varied so that their addition amounts per unit surface area respectively remained the same.

Preparation of Green-Sensitive Emulsion (GG-33b)

Green-sensitive silver halide emulsion (GG-33b) was prepared similarly to the green-sensitive silver halide emulsion (GG-8b) of Example 1, except that silver halide emulsion (GG-8) was replaced by silver halide emulsion (GG-33), and taking into account the decrease of a silver halide grain surface area per weight of silver along with change of the average silver halide grain size of from 0.42 μm to 0.46 μm, addition amounts of sodium thiosulfate, chloroauric acid, and sensitizing dye (GS-1) were each varied so that their addition amounts per unit surface area respectively remained the same.

Preparation of Red-Sensitive Emulsion (R-31a)

Red-sensitive silver halide emulsion (R-31a) was prepared similarly to the red-sensitive silver halide emulsion (R-1a) of Example 1, except that silver halide emulsion (R-1) was replaced by silver halide emulsion (R-31).

Preparation of Red-Sensitive Emulsions (R-31b), and (R-32a) to (R-34a)

Red-sensitive silver halide emulsions (R-31b), and (R-32a) to (R-34a) were prepared similarly to the red-sensitive silver halide emulsion (R-1b) of Example 1, except that silver halide emulsion (R-1) was replaced by each of silver halide emulsion (R-31) to (R-34).

Preparation of Red-Sensitive Emulsion (R-34b)

Red-sensitive silver halide emulsion (R-34b) was prepared similarly to the red-sensitive silver halide emulsion (R-8b) of Example 1, except that silver halide emulsion (R-8) was replaced by silver halide emulsion (R-34).

Preparation of Red-Sensitive emulsions (RR-31a) and (RR-32a)

Red-sensitive silver halide emulsions (RR-31a) and (RR-32a) were prepared similarly to the red-sensitive silver halide emulsion (RR-1a) of Example 1, except that silver halide emulsion (RR-1) was replaced by silver halide emulsion (RR-31) or (RR-32), and taking into account the increase of a silver halide grain surface area per weight of silver along with change of the average silver halide grain size of from 0.38 μm to 0.36 μm, addition amounts of sodium thiosulfate, chloroauric acid, and sensitizing dyes (RS-1) and (RS-2) were each varied so that their addition amounts per unit surface area respectively remained the same.

Preparation of Red-Sensitive Emulsions (RR-31b), (RR-32b) and (RR-33a)

Red-sensitive silver halide emulsions (RR-31b), (RR-32b) and (RR-33a) were prepared similarly to the red-sensitive silver halide emulsion (RR-1b) of Example 1, except that silver halide emulsion (RR-1) was replaced by each of silver halide emulsions (RR-31) to (RR-33), and taking into account the increase of a silver halide grain surface area per weight of silver along with change of the average silver halide grain size of from 0.38 μm to 0.36 μm, addition amounts of sodium thiosulfate, chloroauric acid, and sensitizing dyes (RS-1) and (RS-2) were each varied so that their addition amounts per unit surface area respectively remained the same.

Preparation of Red-Sensitive Emulsions (RR-33b)

Red-sensitive silver halide emulsion (RR-33b) was prepared similarly to the red-sensitive silver halide emulsion (RR-8b) of Example 1, except that silver halide emulsion (RR-8) was replaced by each of silver halide emulsion (RR-33), and taking into account the increase of a silver halide grain surface area per weight of silver along with change of the average silver halide grain size of from 0.38 μm to 0.36 μm, addition amounts of sodium thiosulfate, triphenylphosphine selenide, chloroauric acid, and sensitizing dyes (RS-1) and (RS-2) were each varied so that their addition amounts per unit surface area respectively remained the same.

In the foregoing preparation of the respective red-sensitive silver halide emulsions, 2.0×10⁻³ mol/mol.AgX of SS-1 was added at the time of completion of the preparation.

Further, in the preparation of the respective light-sensitive silver halide emulsions, the interval of additions sensitizing dyes and chemical sensitizers, the chemical sensitization time were optimally adjusted so that the obtained silver halide color photographic materials each exhibit the values of the effective tone range (VE) shown in Table 10.

Preparation of Silver Halide Color Photographic Material Preparation of Samples 401 to 409

Photographic material samples 401 to 409 were prepared similarly to sample 101 of Example 1, except that silver halide emulsions of the 1st, 3rd and 5th layers were varied as shown in Table 10.

### Evaluation of Characteristics

Similarly to Example 1, the thus prepared samples were evaluated with respect to radiation resistance, storage stability and process stability. Similarly to Example 3, the samples were further evaluated with respect to the effective tone range. The obtained results of magenta images are shown in Table 10. The radiation resistance was represented by a relative value, based on the radiation resistance of sample 401 being 100.

TABLE 10

| | Silver Halide Emulsion | | | | | | | | | |
|---|---|---|---|---|---|---|---|---|---|---|
| | 1st Layer | 3rd Layer | 5th Layer | Effective Tone | | | | | | |
| | (Blue- | (Green- | (Red- | Range (VE) | | | | Evaluation Result | | |
| Sample | sensitive | sensitive | sensitive | Yellow | Magenta | Cyan | | Radiation | Storage | Process |
| No. | Layer) | Layer) | Layer) | Image | Image | Image | ΔVE | Resistance | Stability | Stability |
| 401 | B-31a/BB-31a | G-31a/GG-31a | R-31a/RR-31a | 0.73 | 0.87 | 0.70 | 0.17 | 100 | 71 | 72 |
| 402 | B-31a/BB-31b | G-31a/GG-31b | R-31a/RR-31b | 0.77 | 0.84 | 0.75 | 0.09 | 97 | 71 | 74 |
| 403 | B-31a/BB-32a | G-31b/GG-31b | R-31b/RR-31b | 0.79 | 0.87 | 0.78 | 0.09 | 94 | 73 | 76 |
| 404 | B-31a/BB-31b | G-32a/GG-31b | R-32a/RR-31b | 0.83 | 0.90 | 0.85 | 0.07 | 79 | 86 | 88 |
| 405 | B-31b/BB-31a | G-32b/GG-31a | R-31a/RR-32b | 0.85 | 0.90 | 0.87 | 0.05 | 75 | 89 | 92 |
| 406 | B-31b/BB-31b | G-32a/GG-32a | R-32a/RR-32a | 0.84 | 0.89 | 0.84 | 0.05 | 73 | 89 | 93 |
| 407 | B-32a/BB-33a | G-33a/GG-33a | R-33a/RR-33a | 0.84 | 0.89 | 0.88 | 0.05 | 72 | 93 | 95 |
| 408 | B-33a/BB-34a | G-34a/GG-33a | R-34a/RR-33a | 0.85 | 0.90 | 0.85 | 0.05 | 70 | 95 | 95 |
| 409 | B-33b/BB-34b | G-34b/GG-33b | R-34b/RR-33b | 0.86 | 0.90 | 0.86 | 0.05 | 70 | 96 | 96 |

As apparent from the results shown in Table 10, it was proved that samples having constitution of silver halide emulsions relating to the invention and the characteristic value (VE) as defined in the invention exhibit superior radiation resistance and improved storage stability and process stability with respect to magenta images, as compared to comparative samples. As a result of evaluation of the blue-sensitive layer (yellow image) and the red-sensitive layer (cyan image), similar results were also obtained.

What is claimed is:

1. A silver halide color photographic material comprising on a support a yellow image forming layer, a magenta image forming layer and a cyan image forming layer, each containing a light-sensitive silver halide,
wherein each of the yellow, magenta and cyan image forming layers meets the following requirement:
Δ Log E(=Log Ed−Log Ea)≦0.15
wherein Δ Log E is a difference between a logarithmic exposure amount (Log Ed) giving a maximum point gamma value (γmd) when exposed so that an exposure time is 10⁻⁶ sec per pixel and then processed and a logarithmic exposure amount (Log Ea) giving a maximum point gamma value (γma) when exposed so that an exposure time is 0.5 sec per pixel and then processed,
and wherein at least one of the yellow image forming layer, the magenta image forming layer and the cyan image forming layer contains a first silver halide emulsion having a chloride content of not less than 90 mol %, an iodide content of 0 to 2.0 mol % and a bromide content of 0.1 to 10 mol %, and at least one image forming layer which is different from the layer containing the first silver halide emulsion contains a second silver halide emulsion having a smaller average grain size and a higher bromide content than the first silver halide emulsion.

2. A silver halide color photographic material comprising on a support a yellow image forming layer, a magenta image forming layer and a cyan image forming layer, each containing a light-sensitive silver halide,
wherein when the photographic material is exposed to light so that an exposure time per pixel is 10⁻¹⁰ to 10⁻³ sec., each of the yellow, magenta cyan image forming layers after being processed meets the following requirements:
0.77≦VE≦0.96
0≦ΔVE≦0.10
wherein VE represents an effective tone range and ΔVE represents a difference between the maximum value of effective tone ranges and the minimum value thereof,
and wherein at least one of the yellow image forming layer, the magenta image forming layer and the cyan image forming layer contains a first silver halide emulsion having a chloride content of not less than 90 mol %, an iodide content of 0 to 2.0 mol % and a bromide content of 0.1 to 10 mol %, and at least one image forming layer which is different from the layer containing the first silver halide emulsion contains a second silver halide emulsion having a smaller average grain size and a higher bromide content than the first silver halide emulsion.
